(19) United States
(12) Patent Application Publication
(10) Pub. No.: US 2026/0342584 A1
(43) Pub. Date: Oct. 29, 2026

(54) SYSTEMS, METHODS, AND APPARATUS FOR DOMAIN-SPECIFIC ARTIFICIAL INTELLIGENCE SAFETY 2.0 ENFORCEMENT ACROSS MULTI-LAYER INDUSTRIAL DEPLOYMENTS

(71) Applicant: CHUANPING HU, Pittsburg, KS (US)

(72) Inventor: CHUANPING HU, Pittsburg, KS (US)

(21) Appl. No.: 19/686,636

(22) Filed: May 23, 2026

(51) Int. Cl. H04L 9/32; G06F 21/53

(52) U.S. Cl. CPC H04L 9/3234; G06F 21/53; G06F 2221/034

(57) ABSTRACT

A domain-specific artificial-intelligence safety enforcement system includes a machine-readable safety-axiom library, a domain-classification engine, a risk-scoring engine, a policy evaluator, an axiom-to-stack compiler, an enforcement controller, a tamper-evident audit ledger, a sandbox simulation engine, and a deployment-readiness package generator. The system classifies high-risk AI workloads across biological, cyber, autonomous-weapons, critical-infrastructure, medical, financial, public-sector, cloud, model-runtime, chip, firmware, foundry, packaging, and application layers. Selected safety axioms are compiled into stack-specific enforcement artifacts and are enforced through authorization, refusal, isolation, containment, rollback, revocation, human review, dual authorization, cryptographic attestation, and sandbox testing. Audit records and safety passports support certification, recertification, incident feedback, compliance review, and deployment readiness while preserving lawful and beneficial AI use.

### I. RELATIONSHIP TO EARLIER AI SAFETY AND COMPUTE-GOVERNANCE DISCLOSURES

In one embodiment, prior AI safety and compute-governance disclosures function as a parent tree or root safety constitution. AI Safety 2.0 is an operational branch that translates high-level safety principles into executable, verifiable, auditable, stack-deployable, sandbox-testable technical mechanisms. The parent-tree relationship is disclosed as a technical relationship and as a written-description bridge, without limiting the invention to any particular prior application unless expressly required.

In various embodiments, these components are implemented using one or more processors, memories, firmware instructions, hardware roots of trust, secure enclaves, hardware coprocessors, cloud orchestration services, model-runtime adapters, application wrappers, cryptographic ledgers, and physical-world actuation interlocks. The embodiments may be deployed together or separately. A person of ordinary skill may implement the disclosure using conventional computing hardware modified by the structures, schemas, control flows, and technical interactions described herein.

The disclosure therefore does not claim the abstract idea of being safe. It discloses specific data structures, machine operations, hardware and firmware hooks, cloud admission controls, model-runtime gates, application wrappers, sandbox tests, and audit records that improve the technical operation of AI systems and AI infrastructure.

### II. FIELD OF THE INVENTION

The disclosure relates to artificial intelligence safety, computer security, semiconductor security, advanced packaging, firmware security, cloud orchestration, model-runtime safety, application deployment, critical infrastructure protection, cryptographic auditing, sandbox simulation, and physical-world actuation control.

In various embodiments, these components are implemented using one or more processors, memories, firmware instructions, hardware roots of trust, secure enclaves, hardware coprocessors, cloud orchestration services, model-runtime adapters, application wrappers, cryptographic ledgers, and physical-world actuation interlocks. The embodiments may be deployed together or separately. A person of ordinary skill may implement the disclosure using conventional computing hardware modified by the structures, schemas, control flows, and technical interactions described herein.

The disclosure therefore does not claim the abstract idea of being safe. It discloses specific data structures, machine operations, hardware and firmware hooks, cloud admission controls, model-runtime gates, application wrappers, sandbox tests, and audit records that improve the technical operation of AI systems and AI infrastructure.

### III. BACKGROUND OF THE INVENTION

Frontier artificial intelligence systems increasingly operate across multiple technical layers. A single high-risk workload may begin as a user request, consume cloud compute, run on specialized accelerators, invoke external tools, access biological, cyber, or physical-world systems, and produce outputs that materially affect human safety. Existing ethical guidelines or natural-language policies do not reliably bind these layers. A technical architecture is needed that turns safety axioms into machine-readable policy objects and enforceable artifacts across the stack.

In various embodiments, these components are implemented using one or more processors, memories, firmware instructions, hardware roots of trust, secure enclaves, hardware coprocessors, cloud orchestration services, model-runtime adapters, application wrappers, cryptographic ledgers, and physical-world actuation interlocks. The embodiments may be deployed together or separately. A person of ordinary skill may implement the disclosure using conventional computing hardware modified by the structures, schemas, control flows, and technical interactions described herein.

The disclosure therefore does not claim the abstract idea of being safe. It discloses specific data structures, machine operations, hardware and firmware hooks, cloud admission controls, model-runtime gates, application wrappers, sandbox tests, and audit records that improve the technical operation of AI systems and AI infrastructure.

### IV. SUMMARY OF THE INVENTION

The disclosed embodiments provide a machine-readable AI Safety 2.0 axiom library, domain-classification engine, risk-scoring engine, policy evaluator, axiom-to-stack compiler, enforcement controller, audit ledger, sandbox simulation engine, and deployment-readiness generator. The system classifies high-risk workloads, computes risk scores, selects axiom objects, compiles them into stack-specific enforcement artifacts, performs enforcement actions, and records tamper-evident audit records.

In various embodiments, these components are implemented using one or more processors, memories, firmware instructions, hardware roots of trust, secure enclaves, hardware coprocessors, cloud orchestration services, model-runtime adapters, application wrappers, cryptographic ledgers, and physical-world actuation interlocks. The embodiments may be deployed together or separately. A person of ordinary skill may implement the disclosure using conventional computing hardware modified by the structures, schemas, control flows, and technical interactions described herein.

The disclosure therefore does not claim the abstract idea of being safe. It discloses specific data structures, machine operations, hardware and firmware hooks, cloud admission controls, model-runtime gates, application wrappers, sandbox tests, and audit records that improve the technical operation of AI systems and AI infrastructure.

### V. DEFINITIONS

Terms such as axiom object, high-risk AI workload, stack-specific enforcement artifact, sandbox experiment, safety passport, audit ledger, critical-infrastructure flag, biological actionability, cyber propagation potential, physical-world actuation, revocation propagation, and deployment readiness are used in a technical sense and are not limited to natural-language governance.

In various embodiments, these components are implemented using one or more processors, memories, firmware instructions, hardware roots of trust, secure enclaves, hardware coprocessors, cloud orchestration services, model-runtime adapters, application wrappers, cryptographic ledgers, and physical-world actuation interlocks. The embodiments may be deployed together or separately. A person of ordinary skill may implement the disclosure using conventional computing hardware modified by the structures, schemas, control flows, and technical interactions described herein.

The disclosure therefore does not claim the abstract idea of being safe. It discloses specific data structures, machine operations, hardware and firmware hooks, cloud admission controls, model-runtime gates, application wrappers, sandbox tests, and audit records that improve the technical operation of AI systems and AI infrastructure.

### VI. BRIEF DESCRIPTION OF THE DRAWINGS

The accompanying drawing sheets, submitted separately from this specification, illustrate non-limiting embodiments of the invention. The drawings are schematic block diagrams or flow diagrams. The drawings are not necessarily to scale. Like reference numerals may indicate like or corresponding elements. Each figure is described below, and detailed reference-numeral support is provided in the detailed description of FIGS. 1-30.

FIG. 1 illustrates AI Safety 2.0 Domain-Specific Enforcement System. Reference numerals in FIG. 1 begin at 110 and increment by ten through 190.

FIG. 2 illustrates Machine-Readable AI Safety 2.0 Axiom Object Schema. Reference numerals in FIG. 2 begin at 210 and increment by ten through 290.

FIG. 3 illustrates AI Safety 2.0 Classification Tree. Reference numerals in FIG. 3 begin at 310 and increment by ten through 390.

FIG. 4 illustrates Domain-Classification Workflow. Reference numerals in FIG. 4 begin at 410 and increment by ten through 490.

FIG. 5 illustrates Domain-Specific Risk-Scoring Engine. Reference numerals in FIG. 5 begin at 510 and increment by ten through 590.

FIG. 6 illustrates Policy Evaluator and Threshold Comparator. Reference numerals in FIG. 6 begin at 610 and increment by ten through 690.

FIG. 7 illustrates Axiom-to-Stack Compiler. Reference numerals in FIG. 7 begin at 710 and increment by ten through 790.

FIG. 8 illustrates Enforcement Controller Action Map. Reference numerals in FIG. 8 begin at 810 and increment by ten through 890.

FIG. 9 illustrates Tamper-Evident Audit Ledger. Reference numerals in FIG. 9 begin at 910 and increment by ten through 990.

FIG. 10 illustrates Sandbox Simulation Engine. Reference numerals in FIG. 10 begin at 1010 and increment by ten through 1090.

FIG. 11 illustrates Five-Layer AI Supply Chain Enforcement Architecture. Reference numerals in FIG. 11 begin at 1110 and increment by ten through 1190.

FIG. 12 illustrates Upstreammost Foundry and Advanced Packaging Safety Layer. Reference numerals in FIG. 12 begin at 1210 and increment by ten through 1290.

FIG. 13 illustrates Upstream Chip and Accelerator Safety Layer. Reference numerals in FIG. 13 begin at 1310 and increment by ten through 1390.

FIG. 14 illustrates Firmware, Root-of-Trust, and Policy ROM Layer. Reference numerals in FIG. 14 begin at 1410 and increment by ten through 1490.

FIG. 15 illustrates Midstream Cloud-Orchestration Enforcement Layer. Reference numerals in FIG. 15 begin at 1510 and increment by ten through 1590.

FIG. 16 illustrates Model Runtime Safety Layer. Reference numerals in FIG. 16 begin at 1610 and increment by ten through 1690.

FIG. 17 illustrates Down-Downstream Application Deployment Layer. Reference numerals in FIG. 17 begin at 1710 and increment by ten through 1790.

FIG. 18 illustrates Bio-AI Safety Enforcement Architecture. Reference numerals in FIG. 18 begin at 1810 and increment by ten through 1890.

FIG. 19 illustrates Cyber-AI Circuit-Breaker and Agent Quarantine Architecture. Reference numerals in FIG. 19 begin at 1910 and increment by ten through 1990.

FIG. 20 illustrates Autonomous Weapons Human-Control and Actuation Gate. Reference numerals in FIG. 20 begin at 2010 and increment by ten through 2090.

FIG. 21 illustrates Critical Infrastructure Emergency Suspension Flow. Reference numerals in FIG. 21 begin at 2110 and increment by ten through 2190.

FIG. 22 illustrates Human Review, Dual Authorization, and Legal Review Flow. Reference numerals in FIG. 22 begin at 2210 and increment by ten through 2290.

FIG. 23 illustrates Revocation Propagation Across Dependent Sessions. Reference numerals in FIG. 23 begin at 2310 and increment by ten through 2390.

FIG. 24 illustrates Cross-Layer Attestation and ZK-Proof Verification. Reference numerals in FIG. 24 begin at 2410 and increment by ten through 2490.

FIG. 25 illustrates Deployment-Readiness Package Generator. Reference numerals in FIG. 25 begin at 2510 and increment by ten through 2590.

FIG. 26 illustrates Multi-Jurisdictional Compliance Dashboard. Reference numerals in FIG. 26 begin at 2610 and increment by ten through 2690.

FIG. 27 illustrates Incident Feedback and Re-Certification Loop. Reference numerals in FIG. 27 begin at 2710 and increment by ten through 2790.

FIG. 28 illustrates Genus-Species Mapping from Claims to AI Safety 2.0 Axioms. Reference numerals in FIG. 28 begin at 2810 and increment by ten through 2890.

FIG. 29 illustrates Axiom Intake, Policy Validation, and Authorization Pipeline. Reference numerals in FIG. 29 begin at 2910 and increment by ten through 2990.

FIG. 30 illustrates Master System Diagram for AI Safety 2.0 Full-Stack Enforcement. Reference numerals in FIG. 30 begin at 3010 and increment by ten through 3090.

### VII. DETAILED DESCRIPTION OF THE INVENTION—SYSTEM ARCHITECTURE

### Machine Readale AI Safety 2.0 Axiom Library

The axiom library stores structured safety objects rather than merely human-readable principles. Each object may include an axiom identifier, domain identifier, natural-language declaration, machine-readable trigger condition, input-parameter schema, risk-score function, threshold condition, enforcement-action set, audit-output schema, stack-deployment mapping, version identifier, provenance metadata, human-authorization requirements, and testing references. This data structure permits a policy evaluator to select, compare, and execute safety rules across different technical layers.

In one implementation, the component operates with one or more other components through typed messages and cryptographically verifiable records. For example, a classifier output may include a domain tag and confidence score; a risk engine output may include component factors and weights; a policy evaluator output may include a selected axiom identifier and threshold comparison; and an enforcement controller output may include an execution decision and audit record. These data paths provide concrete technical structure and enable a person of ordinary skill to implement the embodiment without undue experimentation.

Alternative embodiments may implement the component in software, firmware, hardware, cloud infrastructure, a secure enclave, a hardware coprocessor, a remote service, an application wrapper, or combinations thereof. The component may be centralized, distributed, federated, or replicated across multiple sovereign, enterprise, or provider environments, provided that the required safety decision, audit, and revocation functions remain technically enforceable.

The domain-classification engine classifies AI workloads, requests, prompts, model outputs, tool invocations, physical-world actuation requests, API calls, and deployment contexts. Classifications may include bio-AI safety, cyber-AI safety, autonomous weapons AI safety, critical infrastructure, medical AI, financial AI, public-sector AI, education AI, robotics AI, or another domain in which AI behavior may materially affect human life, liberty, dignity, safety, infrastructure, or civilizational continuity.

In one implementation, the component operates with one or more other components through typed messages and cryptographically verifiable records. For example, a classifier output may include a domain tag and confidence score; a risk engine output may include component factors and weights; a policy evaluator output may include a selected axiom identifier and threshold comparison; and an enforcement controller output may include an execution decision and audit record. These data paths provide concrete technical structure and enable a person of ordinary skill to implement the embodiment without undue experimentation.

Alternative embodiments may implement the component in software, firmware, hardware, cloud infrastructure, a secure enclave, a hardware coprocessor, a remote service, an application wrapper, or combinations thereof. The component may be centralized, distributed, federated, or replicated across multiple sovereign, enterprise, or provider environments, provided that the required safety decision, audit, and revocation functions remain technically enforceable.

### Risk-Scoring Engine

The risk-scoring engine computes domain-specific risk scores based on model capability, autonomy level, scale of deployment, tool-access scope, network-access scope, biological actionability, cyber-propagation potential, physical-world actuation scope, target-uncertainty level, civilian-risk indicator, critical-infrastructure flag, human-approval status, certification status, auditability status, reversibility status, revocation status, and prior incident history. Different weights may be used for different domains.

In one implementation, the component operates with one or more other components through typed messages and cryptographically verifiable records. For example, a classifier output may include a domain tag and confidence score; a risk engine output may include component factors and weights; a policy evaluator output may include a selected axiom identifier and threshold comparison; and an enforcement controller output may include an execution decision and audit record. These data paths provide concrete technical structure and enable a person of ordinary skill to implement the embodiment without undue experimentation.

Alternative embodiments may implement the component in software, firmware, hardware, cloud infrastructure, a secure enclave, a hardware coprocessor, a remote service, an application wrapper, or combinations thereof. The component may be centralized, distributed, federated, or replicated across multiple sovereign, enterprise, or provider environments, provided that the required safety decision, audit, and revocation functions remain technically enforceable.

### Policy Evaluator

The policy evaluator selects one or more AI Safety 2.0 axiom objects according to domain classification and compares the risk score against one or more thresholds. The evaluator may also resolve conflicts between beneficial-use policies and refusal policies. For example, a beneficial pharmaceutical discovery request may be routed to a safe drug-discovery workflow while an unauthorized high-risk request is denied or sandboxed.

In one implementation, the component operates with one or more other components through typed messages and cryptographically verifiable records. For example, a classifier output may include a domain tag and confidence score; a risk engine output may include component factors and weights; a policy evaluator output may include a selected axiom identifier and threshold comparison; and an enforcement controller output may include an execution decision and audit record. These data paths provide concrete technical structure and enable a person of ordinary skill to implement the embodiment without undue experimentation.

Alternative embodiments may implement the component in software, firmware, hardware, cloud infrastructure, a secure enclave, a hardware coprocessor, a remote service, an application wrapper, or combinations thereof. The component may be centralized, distributed, federated, or replicated across multiple sovereign, enterprise, or provider environments, provided that the required safety decision, audit, and revocation functions remain technically enforceable.

### Axiom-to-Stack Compiler

The axiom-to-stack compiler converts selected axiom objects into stack-specific artifacts for chip design, foundry and advanced packaging, firmware, cloud orchestration, model runtime, application deployment, institutional deployment, and physical-world actuation. Examples include policy ROM descriptions, firmware attestation policies, cloud admission-control rules, model-runtime tool gates, application-wrapper rules, dashboard outputs, and actuation-interlock instructions.

In one implementation, the component operates with one or more other components through typed messages and cryptographically verifiable records. For example, a classifier output may include a domain tag and confidence score; a risk engine output may include component factors and weights; a policy evaluator output may include a selected axiom identifier and threshold comparison; and an enforcement controller output may include an execution decision and audit record. These data paths provide concrete technical structure and enable a person of ordinary skill to implement the embodiment without undue experimentation.

Alternative embodiments may implement the component in software, firmware, hardware, cloud infrastructure, a secure enclave, a hardware coprocessor, a remote service, an application wrapper, or combinations thereof. The component may be centralized, distributed, federated, or replicated across multiple sovereign, enterprise, or provider environments, provided that the required safety decision, audit, and revocation functions remain technically enforceable.

### Enforcement Controller

The enforcement controller performs actions including granting execution, denying execution, restricting execution, sandboxing execution, rate-limiting execution, requiring human review, requiring dual authorization, blocking a tool invocation, limiting network scope, limiting biological-output capability, triggering a cyber circuit breaker, preventing physical-world actuation, revoking a session, propagating revocation to dependent sessions, and initiating emergency suspension.

In one implementation, the component operates with one or more other components through typed messages and cryptographically verifiable records. For example, a classifier output may include a domain tag and confidence score; a risk engine output may include component factors and weights; a policy evaluator output may include a selected axiom identifier and threshold comparison; and an enforcement controller output may include an execution decision and audit record. These data paths provide concrete technical structure and enable a person of ordinary skill to implement the embodiment without undue experimentation.

Alternative embodiments may implement the component in software, firmware, hardware, cloud infrastructure, a secure enclave, a hardware coprocessor, a remote service, an application wrapper, or combinations thereof. The component may be centralized, distributed, federated, or replicated across multiple sovereign, enterprise, or provider environments, provided that the required safety decision, audit, and revocation functions remain technically enforceable.

### Audit Ledger

The audit ledger stores tamper-evident records including axiom identifiers, workload identifiers, model identifiers, user or entity identifiers, domain classifications, risk scores, threshold values, enforcement decisions, human approvals, policy identifiers, timestamps, revocation references, cryptographic integrity values, and exportable evidence packages. In some embodiments the ledger is implemented as a hash chain, Merkle tree, append-only log, distributed ledger, or other tamper-evident data structure.

In one implementation, the component operates with one or more other components through typed messages and cryptographically verifiable records. For example, a classifier output may include a domain tag and confidence score; a risk engine output may include component factors and weights; a policy evaluator output may include a selected axiom identifier and threshold comparison; and an enforcement controller output may include an execution decision and audit record. These data paths provide concrete technical structure and enable a person of ordinary skill to implement the embodiment without undue experimentation.

Alternative embodiments may implement the component in software, firmware, hardware, cloud infrastructure, a secure enclave, a hardware coprocessor, a remote service, an application wrapper, or combinations thereof. The component may be centralized, distributed, federated, or replicated across multiple sovereign, enterprise, or provider environments, provided that the required safety decision, audit, and revocation functions remain technically enforceable.

### Sandbox Simulation Engine

The sandbox simulation engine generates controlled digital-twin scenarios, injects safe simulated red-team inputs, activates selected safety modules, collects metrics, compares results to pass/fail criteria, and archives test outcomes. The sandbox engine permits validation without releasing dangerous operational instructions or artifacts. Sandbox outcomes may be linked to deployment-readiness scores and claim-support evidence.

In one implementation, the component operates with one or more other components through typed messages and cryptographically verifiable records. For example, a classifier output may include a domain tag and confidence score; a risk engine output may include component factors and weights; a policy evaluator output may include a selected axiom identifier and threshold comparison; and an enforcement controller output may include an execution decision and audit record. These data paths provide concrete technical structure and enable a person of ordinary skill to implement the embodiment without undue experimentation.

Alternative embodiments may implement the component in software, firmware, hardware, cloud infrastructure, a secure enclave, a hardware coprocessor, a remote service, an application wrapper, or combinations thereof. The component may be centralized, distributed, federated, or replicated across multiple sovereign, enterprise, or provider environments, provided that the required safety decision, audit, and revocation functions remain technically enforceable.

### Deployment-Readiness Package Generator

The deployment-readiness package generator assembles sandbox results, audit records, policy versions, model hashes, hardware attestations, package manifests, cloud deployment configuration, figure/reference indexes, claim-support maps, and certification checklists. A deployment package may be exported to a regulator, enterprise safety board, audit committee, court, insurer, customer, or other authorized reviewer.

In one implementation, the component operates with one or more other components through typed messages and cryptographically verifiable records. For example, a classifier output may include a domain tag and confidence score; a risk engine output may include component factors and weights; a policy evaluator output may include a selected axiom identifier and threshold comparison; and an enforcement controller output may include an execution decision and audit record. These data paths provide concrete technical structure and enable a person of ordinary skill to implement the embodiment without undue experimentation.

Alternative embodiments may implement the component in software, firmware, hardware, cloud infrastructure, a secure enclave, a hardware coprocessor, a remote service, an application wrapper, or combinations thereof. The component may be centralized, distributed, federated, or replicated across multiple sovereign, enterprise, or provider environments, provided that the required safety decision, audit, and revocation functions remain technically enforceable.

### VIII. FIVE-LAYER AI SUPPLY CHAIN EMBODIMENTS

A foundry or advanced-packaging provider may embed or bind safety information into a package, interposer, chiplet assembly, package manifest, root-of-trust, PUF-derived identifier, or policy ROM. The layer may produce package attestation outputs that later cloud and model-runtime layers can verify.

Embodiment detail 1: the upstreammost foundry and advanced packaging layer may receive a policy artifact from the axiom-to-stack compiler, verify a policy version, bind the policy to a workload or device identity, enforce a domain-specific limitation, and emit an audit record. The policy artifact may be synchronized with cloud, model, application, and audit layers so that a safety decision made at one layer is not silently bypassed at another layer. This cross-layer binding is particularly important when AI workloads move from research environments into high-risk physical, biological, cyber, or public-sector deployments.

Embodiment detail 2: the upstreammost foundry and advanced packaging layer may receive a policy artifact from the axiom-to-stack compiler, verify a policy version, bind the policy to a workload or device identity, enforce a domain-specific limitation, and emit an audit record. The policy artifact may be synchronized with cloud, model, application, and audit layers so that a safety decision made at one layer is not silently bypassed at another layer. This cross-layer binding is particularly important when AI workloads move from research environments into high-risk physical, biological, cyber, or public-sector deployments.

### Upstream Chip and Accelerator Layer

A chip provider may implement safety coprocessors, intent-detection accelerators, secure interrupts, workload schedulers, telemetry registers, hardware circuit breakers, remote-disable controllers, or cryptographic reporting engines. Such functions can assist in enforcing AI Safety 2.0 policies below the level of ordinary application software.

Embodiment detail 1: the upstream chip and accelerator layer may receive a policy artifact from the axiom-to-stack compiler, verify a policy version, bind the policy to a workload or device identity, enforce a domain-specific limitation, and emit an audit record. The policy artifact may be synchronized with cloud, model, application, and audit layers so that a safety decision made at one layer is not silently bypassed at another layer. This cross-layer binding is particularly important when AI workloads move from research environments into high-risk physical, biological, cyber, or public-sector deployments.

Embodiment detail 2: the upstream chip and accelerator layer may receive a policy artifact from the axiom-to-stack compiler, verify a policy version, bind the policy to a workload or device identity, enforce a domain-specific limitation, and emit an audit record. The policy artifact may be synchronized with cloud, model, application, and audit layers so that a safety decision made at one layer is not silently bypassed at another layer. This cross-layer binding is particularly important when AI workloads move from research environments into high-risk physical, biological, cyber, or public-sector deployments.

### Firmware and Root-of-Trust Layer

A firmware layer may verify boot-time policies, update safety modules, reject unsigned policy changes, prevent rollback to unsafe versions, and expose attestation APIs. The firmware layer may bind a hardware identity to cloud and model-runtime deployment records.

Embodiment detail 1: the firmware and root-of-trust layer may receive a policy artifact from the axiom-to-stack compiler, verify a policy version, bind the policy to a workload or device identity, enforce a domain-specific limitation, and emit an audit record. The policy artifact may be synchronized with cloud, model, application, and audit layers so that a safety decision made at one layer is not silently bypassed at another layer. This cross-layer binding is particularly important when AI workloads move from research environments into high-risk physical, biological, cyber, or public-sector deployments.

Embodiment detail 2: the firmware and root-of-trust layer may receive a policy artifact from the axiom-to-stack compiler, verify a policy version, bind the policy to a workload or device identity, enforce a domain-specific limitation, and emit an audit record. The policy artifact may be synchronized with cloud, model, application, and audit layers so that a safety decision made at one layer is not silently bypassed at another layer. This cross-layer binding is particularly important when AI workloads move from research environments into high-risk physical, biological, cyber, or public-sector deployments.

### Midstream Cloud Orchestration Layer

A cloud provider may perform workload admission, tenant identity verification, quota control, network-scope limitation, tool-scope limitation, sandbox routing, quarantine, session revocation, re-certification, and emergency suspension. The cloud layer may be deployed by providers such as Amazon Web Services, Microsoft Azure, Google Cloud, Oracle Cloud, or other cloud infrastructures.

Embodiment detail 1: the midstream cloud orchestration layer may receive a policy artifact from the axiom-to-stack compiler, verify a policy version, bind the policy to a workload or device identity, enforce a domain-specific limitation, and emit an audit record. The policy artifact may be synchronized with cloud, model, application, and audit layers so that a safety decision made at one layer is not silently bypassed at another layer. This cross-layer binding is particularly important when AI workloads move from research environments into high-risk physical, biological, cyber, or public-sector deployments.

Embodiment detail 2: the midstream cloud orchestration layer may receive a policy artifact from the axiom-to-stack compiler, verify a policy version, bind the policy to a workload or device identity, enforce a domain-specific limitation, and emit an audit record. The policy artifact may be synchronized with cloud, model, application, and audit layers so that a safety decision made at one layer is not silently bypassed at another layer. This cross-layer binding is particularly important when AI workloads move from research environments into high-risk physical, biological, cyber, or public-sector deployments.

### Downstream Foundation-Model Layer

A foundation-model provider may implement prompt gates, context monitors, tool-use gates, model-hash verification, model safety passports, runtime refusal, safe completion routing, output evaluators, and post-event audit records. The model layer may be deployed by providers such as OpenAI, xAI, DeepMind, Anthropic, or other model providers.

Embodiment detail 1: the downstream foundation-model layer may receive a policy artifact from the axiom-to-stack compiler, verify a policy version, bind the policy to a workload or device identity, enforce a domain-specific limitation, and emit an audit record. The policy artifact may be synchronized with cloud, model, application, and audit layers so that a safety decision made at one layer is not silently bypassed at another layer. This cross-layer binding is particularly important when AI workloads move from research environments into high-risk physical, biological, cyber, or public-sector deployments.

Embodiment detail 2: the downstream foundation-model layer may receive a policy artifact from the axiom-to-stack compiler, verify a policy version, bind the policy to a workload or device identity, enforce a domain-specific limitation, and emit an audit record. The policy artifact may be synchronized with cloud, model, application, and audit layers so that a safety decision made at one layer is not silently bypassed at another layer. This cross-layer binding is particularly important when AI workloads move from research environments into high-risk physical, biological, cyber, or public-sector deployments.

### Down-Downstream Application Layer

An application provider may implement wrappers for pharmaceutical research, medical care, finance, robotics, vehicles, public-sector decisions, education, manufacturing, or critical infrastructure. The wrapper may translate domain-specific safety rules into application-specific actions such as requiring human review, generating appeal records, restricting actuation, or exporting audit evidence.

Embodiment detail 1: the down-downstream application layer may receive a policy artifact from the axiom-to-stack compiler, verify a policy version, bind the policy to a workload or device identity, enforce a domain-specific limitation, and emit an audit record. The policy artifact may be synchronized with cloud, model, application, and audit layers so that a safety decision made at one layer is not silently bypassed at another layer. This cross-layer binding is particularly important when AI workloads move from research environments into high-risk physical, biological, cyber, or public-sector deployments.

Embodiment detail 2: the down-downstream application layer may receive a policy artifact from the axiom-to-stack compiler, verify a policy version, bind the policy to a workload or device identity, enforce a domain-specific limitation, and emit an audit record. The policy artifact may be synchronized with cloud, model, application, and audit layers so that a safety decision made at one layer is not silently bypassed at another layer. This cross-layer binding is particularly important when AI workloads move from research environments into high-risk physical, biological, cyber, or public-sector deployments.

### IX. BIO-AI SAFETY EMBODIMENTS

Bio-AI embodiments are directed to safe authorization, risk scoring, auditing, refusal, redirection, and beneficial-use preservation for biological AI workloads. The disclosure avoids operational instructions for harmful biological conduct. Instead, the embodiments focus on technical controls that prevent unauthorized or unsafe biological capability outputs while preserving legitimate medicine, public health, vaccine research, disease modeling, and pharmaceutical discovery.

A Bio-AI safety gate may receive a workload, classify it as biological, compute an actionability risk score, check authorization and institutional status, compare the score to thresholds, and output a safe enforcement action. The enforcement action may be refusal, safe redirection, human review, dual authorization, sandbox-only execution, rate limitation, or safe beneficial output. Each decision may be recorded in the audit ledger.

Beneficial-use preservation may be implemented by differentiating prohibited unsafe content from permitted tasks such as non-sensitive disease education, laboratory safety training, authorized pharmaceutical discovery, and public-health analysis. The system may route a user toward safe alternatives rather than merely denying all biological content.

Additional embodiment 1: a policy object may specify trigger conditions, input schema fields, safe-output templates, prohibited-output categories, authorization rules, sandbox-only execution flags, and audit-output fields. The corresponding stack artifact may be deployed at chip, firmware, cloud, model-runtime, application, institutional, or physical-actuation layers. The system therefore provides a concrete technical path from an abstract safety rule to enforceable runtime behavior.

Additional embodiment 2: a policy object may specify trigger conditions, input schema fields, safe-output templates, prohibited-output categories, authorization rules, sandbox-only execution flags, and audit-output fields. The corresponding stack artifact may be deployed at chip, firmware, cloud, model-runtime, application, institutional, or physical-actuation layers. The system therefore provides a concrete technical path from an abstract safety rule to enforceable runtime behavior.

Additional embodiment 3: a policy object may specify trigger conditions, input schema fields, safe-output templates, prohibited-output categories, authorization rules, sandbox-only execution flags, and audit-output fields. The corresponding stack artifact may be deployed at chip, firmware, cloud, model-runtime, application, institutional, or physical-actuation layers. The system therefore provides a concrete technical path from an abstract safety rule to enforceable runtime behavior.

Additional embodiment 4: a policy object may specify trigger conditions, input schema fields, safe-output templates, prohibited-output categories, authorization rules, sandbox-only execution flags, and audit-output fields. The corresponding stack artifact may be deployed at chip, firmware, cloud, model-runtime, application, institutional, or physical-actuation layers. The system therefore provides a concrete technical path from an abstract safety rule to enforceable runtime behavior.

Additional embodiment 5: a policy object may specify trigger conditions, input schema fields, safe-output templates, prohibited-output categories, authorization rules, sandbox-only execution flags, and audit-output fields. The corresponding stack artifact may be deployed at chip, firmware, cloud, model-runtime, application, institutional, or physical-actuation layers. The system therefore provides a concrete technical path from an abstract safety rule to enforceable runtime behavior.

### X. CYBER-AI SAFETY EMBODIMENTS

Cyber-AI embodiments are directed to defensive cybersecurity, least privilege, critical-infrastructure protection, agent quarantine, responsible disclosure, network-scope limitation, and auditability. The disclosure avoids operational instructions for unauthorized cyber activity. The embodiments provide mechanisms by which AI-based defensive tools are preserved while offensive or unauthorized behavior is blocked, sandboxed, or escalated.

A cyber circuit breaker may detect unauthorized network scope, suspicious privilege escalation, critical-infrastructure targeting, lateral movement, self-replication, tool misuse, or anomaly patterns. The system may then trigger least-privilege reduction, quarantine, responsible-disclosure routing, session revocation, or emergency suspension.

Critical-infrastructure signatures may include non-sensitive identifiers that mark hospital, grid, water, financial, transportation, emergency services, and public-sector systems as requiring enhanced safeguards. The signature module need not disclose vulnerabilities. It may simply classify protected context and trigger elevated controls.

Additional embodiment 1: a policy object may specify trigger conditions, input schema fields, safe-output templates, prohibited-output categories, authorization rules, sandbox-only execution flags, and audit-output fields. The corresponding stack artifact may be deployed at chip, firmware, cloud, model-runtime, application, institutional, or physical-actuation layers. The system therefore provides a concrete technical path from an abstract safety rule to enforceable runtime behavior.

Additional embodiment 2: a policy object may specify trigger conditions, input schema fields, safe-output templates, prohibited-output categories, authorization rules, sandbox-only execution flags, and audit-output fields. The corresponding stack artifact may be deployed at chip, firmware, cloud, model-runtime, application, institutional, or physical-actuation layers. The system therefore provides a concrete technical path from an abstract safety rule to enforceable runtime behavior.

Additional embodiment 3: a policy object may specify trigger conditions, input schema fields, safe-output templates, prohibited-output categories, authorization rules, sandbox-only execution flags, and audit-output fields. The corresponding stack artifact may be deployed at chip, firmware, cloud, model-runtime, application, institutional, or physical-actuation layers. The system therefore provides a concrete technical path from an abstract safety rule to enforceable runtime behavior.

Additional embodiment 4: a policy object may specify trigger conditions, input schema fields, safe-output templates, prohibited-output categories, authorization rules, sandbox-only execution flags, and audit-output fields. The corresponding stack artifact may be deployed at chip, firmware, cloud, model-runtime, application, institutional, or physical-actuation layers. The system therefore provides a concrete technical path from an abstract safety rule to enforceable runtime behavior.

Additional embodiment 5: a policy object may specify trigger conditions, input schema fields, safe-output templates, prohibited-output categories, authorization rules, sandbox-only execution flags, and audit-output fields. The corresponding stack artifact may be deployed at chip, firmware, cloud, model-runtime, application, institutional, or physical-actuation layers. The system therefore provides a concrete technical path from an abstract safety rule to enforceable runtime behavior.

### XI. AUTONOMOUS WEAPONS AND PHYSICAL-WORLD AI SAFETY EMBODIMENTS

Autonomous-weapons and physical-world AI embodiments are directed to meaningful human control, final human authorization, legal review, geographic containment, civilian-risk gating, target-uncertainty scoring, proportionality review, escalation suppression, actuation interlocks, abort signals, and audit records. The disclosure does not provide weapons operation instructions. It provides safety control architectures that prevent fully autonomous harmful actuation without human authority.

A physical-world actuation gate may intercept a command before it reaches a drone, robot, vehicle, industrial system, medical device, or other actuator. The gate may verify domain classification, target uncertainty, civilian risk, human authorization, legal review, geographic containment, and revocation status. If a threshold is not satisfied, the gate denies or suspends actuation.

In non-military contexts, the same architecture may protect humans from unsafe robotic, industrial, medical, vehicular, or infrastructure actuation. For example, an industrial robot, surgical robot, autonomous vehicle, or infrastructure controller may require a safety-state check, human authorization, and audit record before performing a high-risk physical operation.

Additional embodiment 1: a policy object may specify trigger conditions, input schema fields, safe-output templates, prohibited-output categories, authorization rules, sandbox-only execution flags, and audit-output fields. The corresponding stack artifact may be deployed at chip, firmware, cloud, model-runtime, application, institutional, or physical-actuation layers. The system therefore provides a concrete technical path from an abstract safety rule to enforceable runtime behavior.

Additional embodiment 2: a policy object may specify trigger conditions, input schema fields, safe-output templates, prohibited-output categories, authorization rules, sandbox-only execution flags, and audit-output fields. The corresponding stack artifact may be deployed at chip, firmware, cloud, model-runtime, application, institutional, or physical-actuation layers. The system therefore provides a concrete technical path from an abstract safety rule to enforceable runtime behavior.

Additional embodiment 3: a policy object may specify trigger conditions, input schema fields, safe-output templates, prohibited-output categories, authorization rules, sandbox-only execution flags, and audit-output fields. The corresponding stack artifact may be deployed at chip, firmware, cloud, model-runtime, application, institutional, or physical-actuation layers. The system therefore provides a concrete technical path from an abstract safety rule to enforceable runtime behavior.

Additional embodiment 4: a policy object may specify trigger conditions, input schema fields, safe-output templates, prohibited-output categories, authorization rules, sandbox-only execution flags, and audit-output fields. The corresponding stack artifact may be deployed at chip, firmware, cloud, model-runtime, application, institutional, or physical-actuation layers. The system therefore provides a concrete technical path from an abstract safety rule to enforceable runtime behavior.

Additional embodiment 5: a policy object may specify trigger conditions, input schema fields, safe-output templates, prohibited-output categories, authorization rules, sandbox-only execution flags, and audit-output fields. The corresponding stack artifact may be deployed at chip, firmware, cloud, model-runtime, application, institutional, or physical-actuation layers. The system therefore provides a concrete technical path from an abstract safety rule to enforceable runtime behavior.

### XII. DETAILED DESCRIPTION OF FIGS. 1-30

The following detailed figure descriptions are part of the detailed description of the invention, but they do not replace the other system, method, medium, hardware, cloud, model-runtime, application, sandbox, and example embodiments disclosed elsewhere herein. The formal drawing sheets are submitted separately. Each figure uses reference numerals that appear in the drawing sheet and in this specification.

### Detailed Description of FIG. 1—AI Safety 2.0 Domain-Specific Enforcement System

Reference numeral 110 denotes Axiom library. In the illustrated embodiment, axiom library is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 120 denotes Domain classifier. In the illustrated embodiment, domain classifier is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 130 denotes Risk scoring engine. In the illustrated embodiment, risk scoring engine is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 140 denotes Policy evaluator. In the illustrated embodiment, policy evaluator is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 150 denotes Stack compiler. In the illustrated embodiment, stack compiler is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 160 denotes Enforcement controller. In the illustrated embodiment, enforcement controller is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 170 denotes Audit ledger. In the illustrated embodiment, audit ledger is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 180 denotes Sandbox engine. In the illustrated embodiment, sandbox engine is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 190 denotes Deployment readiness module. In the illustrated embodiment, deployment readiness module is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 1 shows how the ai safety 2.0 domain-specific enforcement system may receive inputs from one or more upstream blocks, perform a safety or verification function, and transmit an output to one or more downstream blocks. Arrows in the drawing may be direct or 90-degree elbow connectors.

Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 1 supports at least the implementation elements related to ai safety 2.0 domain-specific enforcement system. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

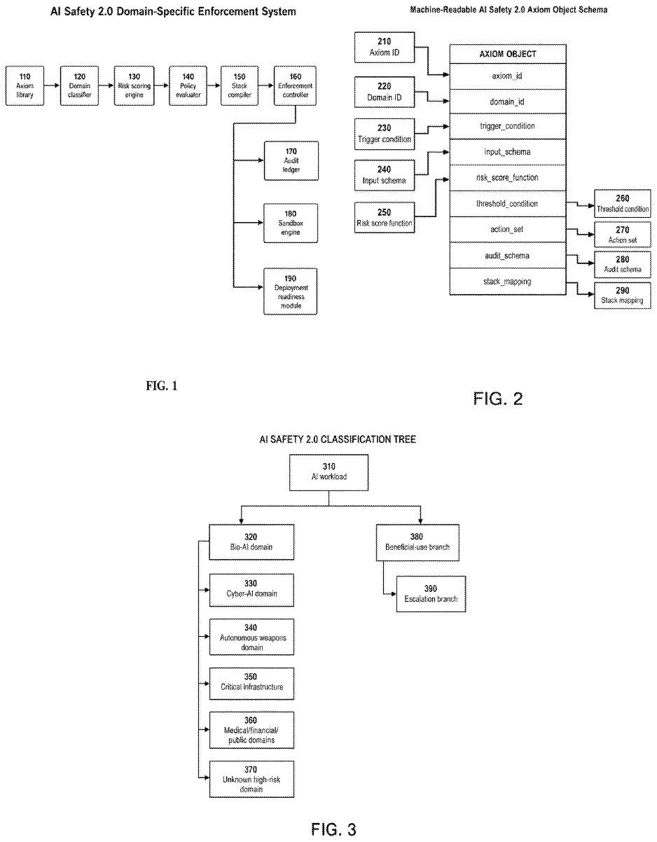

### Detailed Description of FIG. 2—Machine-Readable AI Safety 2.0 Axiom Object Schema

Reference numeral 210 denotes Axiom ID. In the illustrated embodiment, axiom id is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 220 denotes Domain ID. In the illustrated embodiment, domain id is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 230 denotes Trigger condition. In the illustrated embodiment, trigger condition is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 240 denotes Input schema. In the illustrated embodiment, input schema is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 250 denotes Risk score function. In the illustrated embodiment, risk score function is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 260 denotes Threshold condition. In the illustrated embodiment, threshold condition is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 270 denotes Action set. In the illustrated embodiment, action set is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 280 denotes Audit schema. In the illustrated embodiment, audit schema is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 290 denotes Stack mapping. In the illustrated embodiment, stack mapping is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 2 shows how the machine-readable ai safety 2.0 axiom object schema may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 2 supports at least the implementation elements related to machine-readable ai safety 2.0 axiom object schema. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

Detailed Description of FIG. 3—AI Safety 2.0 Classification tree

Reference numeral 310 denotes AI workload. In the illustrated embodiment, ai workload is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 320 denotes Bio-AI domain. In the illustrated embodiment, bio-ai domain is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 330 denotes Cyber-AI domain. In the illustrated embodiment, cyber-ai domain is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 340 denotes Autonomous weapons domain. In the illustrated embodiment, autonomous weapons domain is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 350 denotes Critical infrastructure. In the illustrated embodiment, critical infrastructure is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 360 denotes Medical/financial/public domains. In the illustrated embodiment, medical/financial/public domains is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 370 denotes Unknown high-risk domain. In the illustrated embodiment, unknown high-risk domain is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 380 denotes Beneficial-use branch. In the illustrated embodiment, beneficial-use branch is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 390 denotes Escalation branch. In the illustrated embodiment, escalation branch is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 3 shows how the ai safety 2.0 classification tree may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 3 supports at least the implementation elements related to ai safety 2.0 classification tree. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

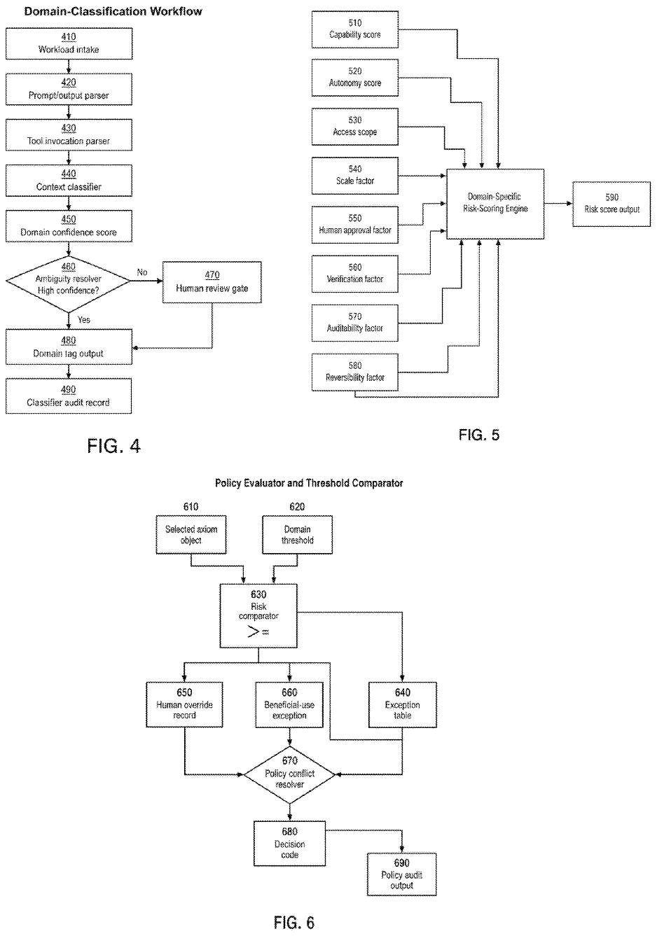

### Detailed Description of FIG. 4—Domain-Classification Workflow

Reference numeral 410 denotes Workload intake. In the illustrated embodiment, workload intake is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 420 denotes Prompt/output parser. In the illustrated embodiment, prompt/output parser is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 430 denotes Tool invocation parser. In the illustrated embodiment, tool invocation parser is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 440 denotes Context classifier. In the illustrated embodiment, context classifier is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 450 denotes Domain confidence score. In the illustrated embodiment, domain confidence score is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 460 denotes Ambiguity resolver. In the illustrated embodiment, ambiguity resolver is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 470 denotes Human review gate. In the illustrated embodiment, human review gate is represented as a functional block, data structure, control module, hardware element, firmware element, software service, audit field, or process step depending on the layer of deployment. The reference number is used consistently between the drawing sheet and the written description so that a reader may reconstruct the figure without relying on embedded images in the specification.

Reference numeral 480 denotes Domain tag output. In the illustrated embodiment, domain tag output is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 490 denotes Classifier audit record. In the illustrated embodiment, classifier audit record is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 4 shows how the domain-classification workflow may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 4 supports at least the implementation elements related to domain-classification workflow. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

### Detailed Description of FIG. 5—Domain-Specific Risk-Scoring Engine

Reference numeral 510 denotes Capability score. In the illustrated embodiment, capability score is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 520 denotes Autonomy score. In the illustrated embodiment, autonomy score is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 530 denotes Access scope. In the illustrated embodiment, access scope is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 540 denotes Scale factor. In the illustrated embodiment, scale factor is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 550 denotes Human approval factor. In the illustrated embodiment, human approval factor is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 560 denotes Verification factor. In the illustrated embodiment, verification factor is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 570 denotes Auditability factor. In the illustrated embodiment, auditability factor is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 580 denotes Reversibility factor. In the illustrated embodiment, reversibility factor is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 590 denotes Risk score output. In the illustrated embodiment, risk score output is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 5 shows how the domain-specific risk-scoring engine may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 5 supports at least the implementation elements related to domain-specific risk-scoring engine. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

### Detailed Description of FIG. 6—Policy Evaluator and Threshold Comparator

Reference numeral 610 denotes Selected axiom object. In the illustrated embodiment, selected axiom object is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 620 denotes Domain threshold. In the illustrated embodiment, domain threshold is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 630 denotes Risk comparator. In the illustrated embodiment, risk comparator is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 640 denotes Exception table. In the illustrated embodiment, exception table is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 650 denotes Human override record. In the illustrated embodiment, human override record is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 660 denotes Beneficial-use exception. In the illustrated embodiment, beneficial-use exception is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 670 denotes Policy conflict resolver. In the illustrated embodiment, policy conflict resolver is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 680 denotes Decision code. In the illustrated embodiment, decision code is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 690 denotes Policy audit output. In the illustrated embodiment, policy audit output is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 6 shows how the policy evaluator and threshold comparator may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 6 supports at least the implementation elements related to policy evaluator and threshold comparator. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

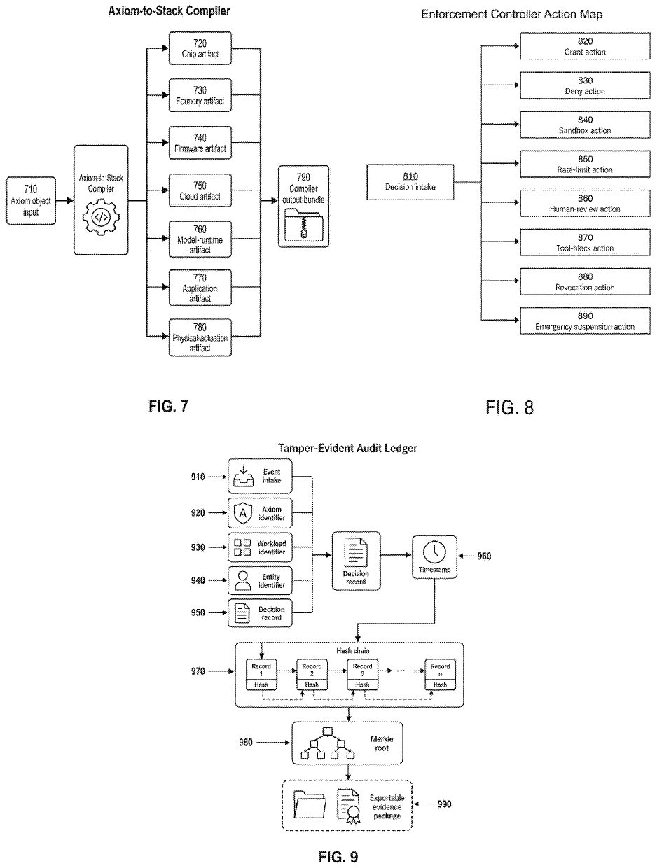

### Detailed Description of FIG. 7—Axiom-to-Stack Complier

Reference numeral 710 denotes Axiom object input. In the illustrated embodiment, axiom object input is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 720 denotes Chip artifact. In the illustrated embodiment, chip artifact is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 730 denotes Foundry artifact. In the illustrated embodiment, foundry artifact is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 740 denotes Firmware artifact. In the illustrated embodiment, firmware artifact is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 750 denotes Cloud artifact. In the illustrated embodiment, cloud artifact is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 760 denotes Model-runtime artifact. In the illustrated embodiment, model-runtime artifact is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 770 denotes Application artifact. In the illustrated embodiment, application artifact is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 780 denotes Physical-actuation artifact. In the illustrated embodiment, physical-actuation artifact is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 790 denotes Compiler output bundle. In the illustrated embodiment, compiler output bundle is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 7 shows how the axiom-to-stack compiler may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 7 supports at least the implementation elements related to axiom-to-stack compiler. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

Reference numeral 810 denotes Decision intake. In the illustrated embodiment, decision intake is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 820 denotes Grant action. In the illustrated embodiment, grant action is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 830 denotes Deny action. In the illustrated embodiment, deny action is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 840 denotes Sandbox action. In the illustrated embodiment, sandbox action is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 850 denotes Rate-limit action. In the illustrated embodiment, rate-limit action is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 860 denotes Human-review action. In the illustrated embodiment, human-review action is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 870 denotes Tool-block action. In the illustrated embodiment, tool-block action is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 880 denotes Revocation action. In the illustrated embodiment, revocation action is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 890 denotes Emergency suspension action. In the illustrated embodiment, emergency suspension action is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

In operation, FIG. 8 shows how the enforcement controller action map may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 8 supports at least the implementation elements related to enforcement controller action map. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

### Detailed Description of FIG. 9—Tamper-Evident Audit Ledger

Reference numeral 910 denotes Event intake. In the illustrated embodiment, event intake is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 920 denotes Axiom identifier. In the illustrated embodiment, axiom identifier is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 930 denotes Workload identifier. In the illustrated embodiment, workload identifier is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 940 denotes Entity identifier. In the illustrated embodiment, entity identifier is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 950 denotes Decision record. In the illustrated embodiment, decision record is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 960 denotes Timestamp. In the illustrated embodiment, timestamp is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 970 denotes Hash chain. In the illustrated embodiment, hash chain is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 980 denotes Merkle root. In the illustrated embodiment, merkle root is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 990 denotes Exportable evidence package. In the illustrated embodiment, exportable evidence package is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

In operation, FIG. 9 shows how the tamper-evident audit ledger may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 9 supports at least the implementation elements related to tamper-evident audit ledger. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

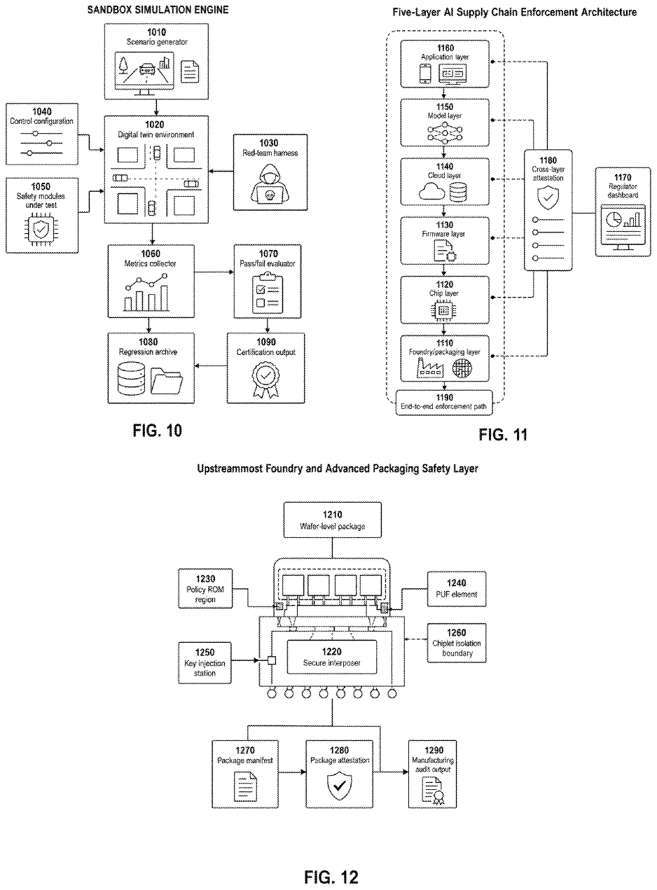

### Detailed Description of FIG. 10—Sandbox Simulation Engine

Reference numeral 1010 denotes Scenario generator. In the illustrated embodiment, scenario generator is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1020 denotes Digital twin environment. In the illustrated embodiment, digital twin environment is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 1030 denotes Red-team harness. In the illustrated embodiment, red-team harness is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1040 denotes Control configuration. In the illustrated embodiment, control configuration is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 1050 denotes Safety modules under test. In the illustrated embodiment, safety modules under test is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1060 denotes Metrics collector. In the illustrated embodiment, metrics collector is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1070 denotes Pass/fail evaluator. In the illustrated embodiment, pass/fail evaluator is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1080 denotes Regression archive. In the illustrated embodiment, regression archive is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1090 denotes Certification output. In the illustrated embodiment, certification output is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 10 shows how the sandbox simulation engine may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 10 supports at least the implementation elements related to sandbox simulation engine. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

### Detailed Description of FIG. 11—Five-Layer AI Supply Chain Enforcement Architecture

Reference numeral 1110 denotes Foundry/packaging layer. In the illustrated embodiment, foundry/packaging layer is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1120 denotes Chip layer. In the illustrated embodiment, chip layer is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1130 denotes Firmware layer. In the illustrated embodiment, firmware layer is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1140 denotes Cloud layer. In the illustrated embodiment, cloud layer is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1150 denotes Model layer. In the illustrated embodiment, model layer is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1160 denotes Application layer. In the illustrated embodiment, application layer is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1170 denotes Regulator dashboard. In the illustrated embodiment, regulator dashboard is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 1180 denotes Cross-layer attestation. In the illustrated embodiment, cross-layer attestation is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 1190 denotes End-to-end enforcement path. In the illustrated embodiment, end-to-end enforcement path is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

In operation, FIG. 11 shows how the five-layer ai supply chain enforcement architecture may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 11 supports at least the implementation elements related to five-layer ai supply chain enforcement architecture. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

### Detailed Description of FIG. 12—Upstreammost Foundry and Advanced Packaging Safety Layer

Reference numeral 1210 denotes Wafer-level package. In the illustrated embodiment, wafer-level package is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1220 denotes Secure interposer. In the illustrated embodiment, secure interposer is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1230 denotes Policy ROM region. In the illustrated embodiment, policy rom region is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1240 denotes PUF element. In the illustrated embodiment, puf element is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1250 denotes Key injection station. In the illustrated embodiment, key injection station is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1260 denotes Chiplet isolation boundary. In the illustrated embodiment, chiplet isolation boundary is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 1270 denotes Package manifest. In the illustrated embodiment, package manifest is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1280 denotes Package attestation. In the illustrated embodiment, package attestation is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1290 denotes Manufacturing audit output. In the illustrated embodiment, manufacturing audit output is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 12 shows how the upstreammost foundry and advanced packaging safety layer may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 12 supports at least the implementation elements related to upstreammost foundry and advanced packaging safety layer. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

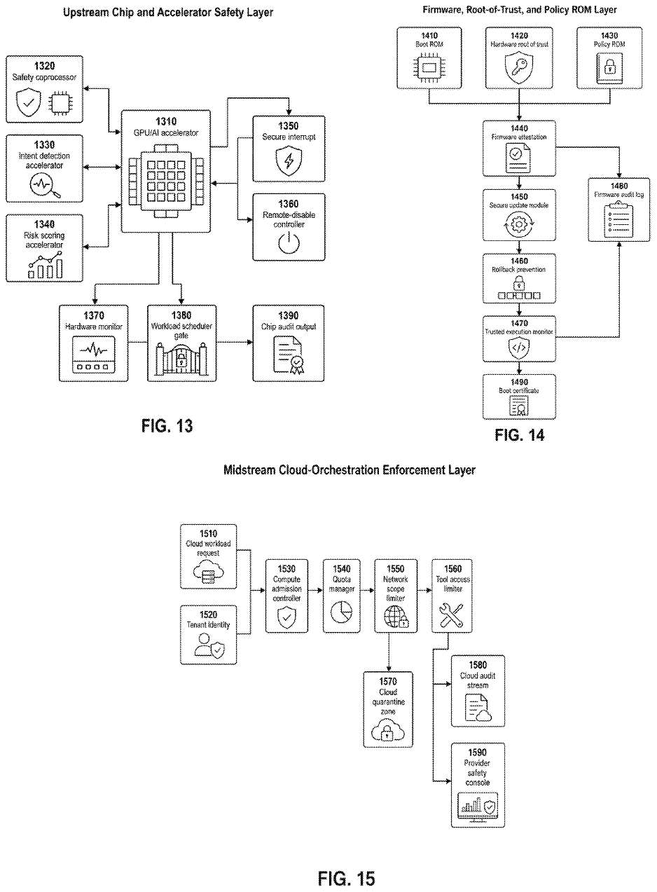

### Detailed Description of FIG. 13—Upstream Chip and Accelerator Safety Layer

Reference numeral 1310 denotes GPU/AI accelerator. In the illustrated embodiment, gpu/ai accelerator is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1320 denotes Safety coprocessor. In the illustrated embodiment, safety coprocessor is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1330 denotes Intent detection accelerator. In the illustrated embodiment, intent detection accelerator is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1340 denotes Risk scoring accelerator. In the illustrated embodiment, risk scoring accelerator is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 1350 denotes Secure interrupt. In the illustrated embodiment, secure interrupt is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1360 denotes Remote-disable controller. In the illustrated embodiment, remote-disable controller is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 1370 denotes Hardware monitor. In the illustrated embodiment, hardware monitor is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1380 denotes Workload scheduler gate. In the illustrated embodiment, workload scheduler gate is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 1390 denotes Chip audit output. In the illustrated embodiment, chip audit output is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 13 shows how the upstream chip and accelerator safety layer may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 13 supports at least the implementation elements related to upstream chip and accelerator safety layer. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

### Detailed Description of FIG. 14—Firmware, Root-of-Trust, and Policy ROM Layer

Reference numeral 1410 denotes Boot ROM. In the illustrated embodiment, boot rom is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1420 denotes Hardware root of trust. In the illustrated embodiment, hardware root of trust is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1430 denotes Policy ROM. In the illustrated embodiment, policy rom is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1440 denotes Firmware attestation. In the illustrated embodiment, firmware attestation is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 1450 denotes Secure update module. In the illustrated embodiment, secure update module is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1460 denotes Rollback prevention. In the illustrated embodiment, rollback prevention is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1470 denotes Trusted execution monitor. In the illustrated embodiment, trusted execution monitor is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 1480 denotes Firmware audit log. In the illustrated embodiment, firmware audit log is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1490 denotes Boot certificate. In the illustrated embodiment, boot certificate is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 14 shows how the firmware, root-of-trust, and policy rom layer may receive inputs from one or more upstream blocks, perform a safety or verification function, and transmit an output to one or more downstream blocks. Arrows in the drawing may be direct or 90-degree elbow connectors.

Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 14 supports at least the implementation elements related to firmware, root-of-trust, and policy rom layer. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

Reference numeral 1510 denotes Cloud workload request. In the illustrated embodiment, cloud workload request is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1520 denotes Tenant identity. In the illustrated embodiment, tenant identity is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1530 denotes Compute admission controller. In the illustrated embodiment, compute admission controller is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1540 denotes Quota manager. In the illustrated embodiment, quota manager is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1550 denotes Network scope limiter. In the illustrated embodiment, network scope limiter is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1560 denotes Tool access limiter. In the illustrated embodiment, tool access limiter is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1570 denotes Cloud quarantine zone. In the illustrated embodiment, cloud quarantine zone is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1580 denotes Cloud audit stream. In the illustrated embodiment, cloud audit stream is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1590 denotes Provider safety console. In the illustrated embodiment, provider safety console is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 15 shows how the midstream cloud-orchestration enforcement layer may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 15 supports at least the implementation elements related to midstream cloud-orchestration enforcement layer. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

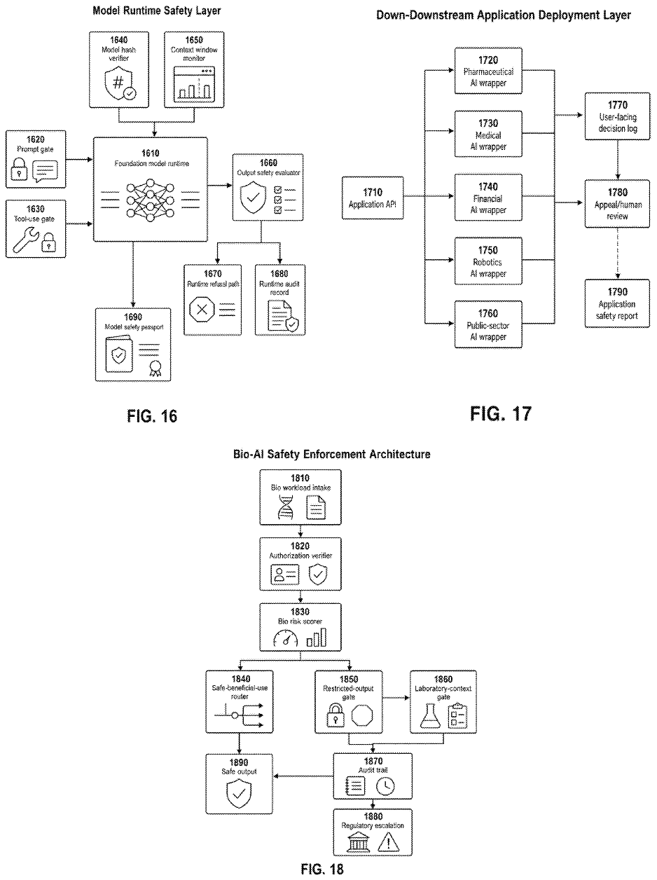

### Detailed Description of FIG. 16—Model Runtime Safety Layer

Reference numeral 1610 denotes Foundation model runtime. In the illustrated embodiment, foundation model runtime is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 1620 denotes Prompt gate. In the illustrated embodiment, prompt gate is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1630 denotes Tool-use gate. In the illustrated embodiment, tool-use gate is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1640 denotes Model hash verifier. In the illustrated embodiment, model hash verifier is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1650 denotes Context window monitor. In the illustrated embodiment, context window monitor is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 1660 denotes Output safety evaluator. In the illustrated embodiment, output safety evaluator is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 1670 denotes Runtime refusal path. In the illustrated embodiment, runtime refusal path is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1680 denotes Runtime audit record. In the illustrated embodiment, runtime audit record is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1690 denotes Model safety passport. In the illustrated embodiment, model safety passport is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 16 shows how the model runtime safety layer may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 16 supports at least the implementation elements related to model runtime safety layer. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

### Detailed Description of FIG. 17—Down-Downstream Application Deployment Layer

Reference numeral 1710 denotes Application API. In the illustrated embodiment, application api is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1720 denotes Pharmaceutical AI wrapper. In the illustrated embodiment, pharmaceutical ai wrapper is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1730 denotes Medical AI wrapper. In the illustrated embodiment, medical ai wrapper is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1740 denotes Financial AI wrapper. In the illustrated embodiment, financial ai wrapper is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1750 denotes Robotics AI wrapper. In the illustrated embodiment, robotics ai wrapper is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1760 denotes Public-sector AI wrapper. In the illustrated embodiment, public-sector ai wrapper is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 1770 denotes User-facing decision log. In the illustrated embodiment, user-facing decision log is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 1780 denotes Appeal/human review. In the illustrated embodiment, appeal/human review is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1790 denotes Application safety report. In the illustrated embodiment, application safety report is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

In operation, FIG. 17 shows how the down-downstream application deployment layer may receive inputs from one or more upstream blocks, perform a safety or verification function, and transmit an output to one or more downstream blocks. Arrows in the drawing may be direct or 90-degree elbow connectors.

Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 17 supports at least the implementation elements related to down-downstream application deployment layer. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

Reference numeral 1810 denotes Bio workload intake. In the illustrated embodiment, bio workload intake is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1820 denotes Authorization verifier. In the illustrated embodiment, authorization verifier is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1830 denotes Bio risk scorer. In the illustrated embodiment, bio risk scorer is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1840 denotes Safe-beneficial-use router. In the illustrated embodiment, safe-beneficial-use router is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1850 denotes Restricted-output gate. In the illustrated embodiment, restricted-output gate is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1860 denotes Laboratory-context gate. In the illustrated embodiment, laboratory-context gate is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 1870 denotes Audit trail. In the illustrated embodiment, audit trail is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1880 denotes Regulatory escalation. In the illustrated embodiment, regulatory escalation is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 1890 denotes Safe output. In the illustrated embodiment, safe output is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 18 shows how the bio-ai safety enforcement architecture may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 18 supports at least the implementation elements related to bio-ai safety enforcement architecture. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

### Detailed Description of FIG. 19—Cyber-AI Circuit-Breaker and Agent Quarantine Architecture

Reference numeral 1910 denotes Cyber agent request. In the illustrated embodiment, cyber agent request is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1920 denotes Network scope analyzer. In the illustrated embodiment, network scope analyzer is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1930 denotes Critical infrastructure detector. In the illustrated embodiment, critical infrastructure detector is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1940 denotes Least-privilege gate. In the illustrated embodiment, least-privilege gate is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1950 denotes Anomaly detector. In the illustrated embodiment, anomaly detector is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1960 denotes Circuit breaker. In the illustrated embodiment, circuit breaker is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1970 denotes Quarantine environment. In the illustrated embodiment, quarantine environment is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 1980 denotes Incident record. In the illustrated embodiment, incident record is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 1990 denotes Responsible-disclosure router. In the illustrated embodiment, responsible-disclosure router is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 19 shows how the cyber-ai circuit-breaker and agent quarantine architecture may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 19 supports at least the implementation elements related to cyber-ai circuit-breaker and agent quarantine architecture. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

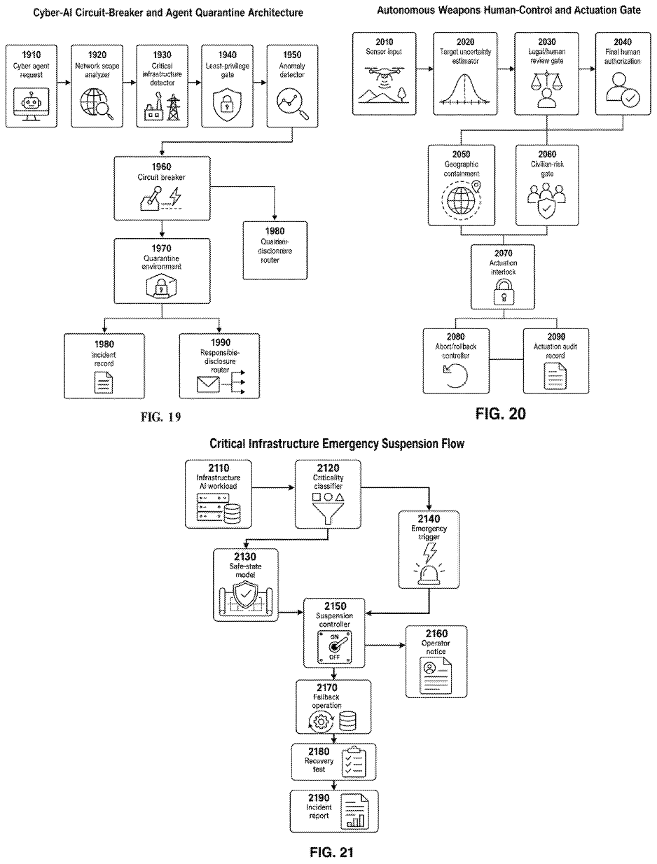

### Detailed Description of FIG. 20—Autonomous Weapons Human-Control and Actuation Gate

Reference numeral 2010 denotes Sensor input. In the illustrated embodiment, sensor input is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2020 denotes Target uncertainty estimator. In the illustrated embodiment, target uncertainty estimator is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2030 denotes Legal/human review gate. In the illustrated embodiment, legal/human review gate is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 2040 denotes Final human authorization. In the illustrated embodiment, final human authorization is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 2050 denotes Geographic containment. In the illustrated embodiment, geographic containment is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 2060 denotes Civilian-risk gate. In the illustrated embodiment, civilian-risk gate is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2070 denotes Actuation interlock. In the illustrated embodiment, actuation interlock is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2080 denotes Abort/rollback controller. In the illustrated embodiment, abort/rollback controller is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 2090 denotes Actuation audit record. In the illustrated embodiment, actuation audit record is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 20 shows how the autonomous weapons human-control and actuation gate may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 20 supports at least the implementation elements related to autonomous weapons human-control and actuation gate. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

### Detailed Description of FIG. 21—Critical Infrastructure Emergency Suspension Flow

Reference numeral 2110 denotes Infrastructure AI workload. In the illustrated embodiment, infrastructure ai workload is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2120 denotes Criticality classifier. In the illustrated embodiment, criticality classifier is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2130 denotes Safe-state model. In the illustrated embodiment, safe-state model is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2140 denotes Emergency trigger. In the illustrated embodiment, emergency trigger is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2150 denotes Suspension controller. In the illustrated embodiment, suspension controller is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 2160 denotes Operator notice. In the illustrated embodiment, operator notice is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2170 denotes Fallback operation. In the illustrated embodiment, fallback operation is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2180 denotes Recovery test. In the illustrated embodiment, recovery test is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2190 denotes Incident report. In the illustrated embodiment, incident report is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 21 shows how the critical infrastructure emergency suspension flow may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 21 supports at least the implementation elements related to critical infrastructure emergency suspension flow. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

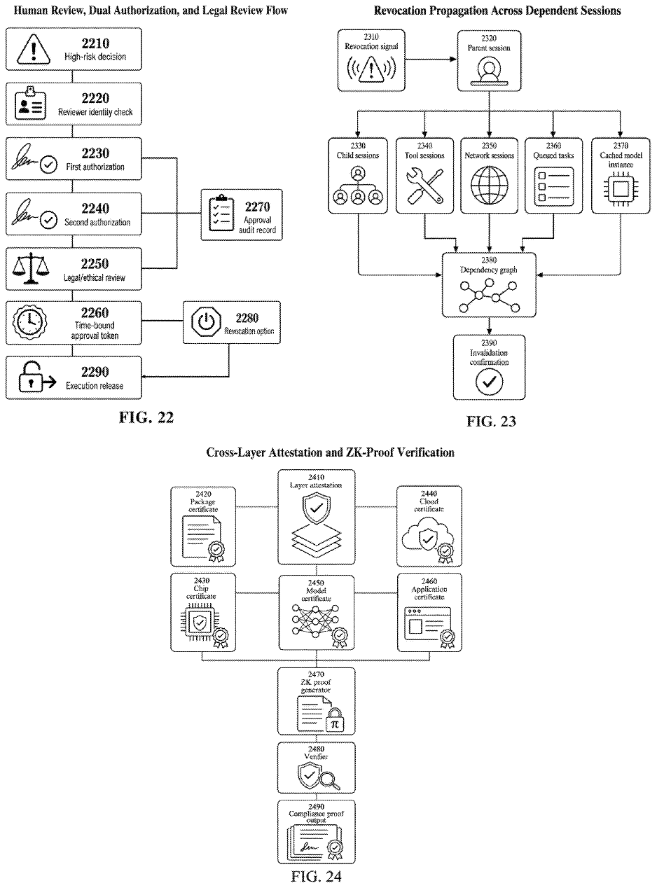

### Detailed Description of FIG. 22—Human Review, Dual Authorization, and Legal Review Flow

Reference numeral 2210 denotes High-risk decision. In the illustrated embodiment, high-risk decision is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2220 denotes Reviewer identity check. In the illustrated embodiment, reviewer identity check is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 2230 denotes First authorization. In the illustrated embodiment, first authorization is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2240 denotes Second authorization. In the illustrated embodiment, second authorization is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 2250 denotes Legal/ethical review. In the illustrated embodiment, legal/ethical review is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2260 denotes Time-bound approval token. In the illustrated embodiment, time-bound approval token is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 2270 denotes Approval audit record. In the illustrated embodiment, approval audit record is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2280 denotes Revocation option. In the illustrated embodiment, revocation option is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2290 denotes Execution release. In the illustrated embodiment, execution release is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 22 shows how the human review, dual authorization, and legal review flow may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 22 supports at least the implementation elements related to human review, dual authorization, and legal review flow. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

### Detailed Description of FIG. 23—Revocation Propagation Across Dependent Sessions

Reference numeral 2310 denotes Revocation signal. In the illustrated embodiment, revocation signal is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2320 denotes Parent session. In the illustrated embodiment, parent session is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2330 denotes Child sessions. In the illustrated embodiment, child sessions is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2340 denotes Tool sessions. In the illustrated embodiment, tool sessions is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2350 denotes Network sessions. In the illustrated embodiment, network sessions is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2360 denotes Queued tasks. In the illustrated embodiment, queued tasks is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2370 denotes Cached model instance. In the illustrated embodiment, cached model instance is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2380 denotes Dependency graph. In the illustrated embodiment, dependency graph is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2390 denotes Invalidation confirmation. In the illustrated embodiment, invalidation confirmation is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

In operation, FIG. 23 shows how the revocation propagation across dependent sessions may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 23 supports at least the implementation elements related to revocation propagation across dependent sessions. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

### Detailed Description of FIG. 24—Cross-Layer Attestation and ZK-Proof Verification

Reference numeral 2410 denotes Layer attestation. In the illustrated embodiment, layer attestation is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2420 denotes Package certificate. In the illustrated embodiment, package certificate is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2430 denotes Chip certificate. In the illustrated embodiment, chip certificate is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2440 denotes Cloud certificate. In the illustrated embodiment, cloud certificate is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2450 denotes Model certificate. In the illustrated embodiment, model certificate is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2460 denotes Application certificate. In the illustrated embodiment, application certificate is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 2470 denotes ZK proof generator. In the illustrated embodiment, zk proof generator is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2480 denotes Verifier. In the illustrated embodiment, verifier is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2490 denotes Compliance proof output. In the illustrated embodiment, compliance proof output is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

In operation, FIG. 24 shows how the cross-layer attestation and zk-proof verification may receive inputs from one or more upstream blocks, perform a safety or verification function, and transmit an output to one or more downstream blocks. Arrows in the drawing may be direct or 90-degree elbow connectors.

Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 24 supports at least the implementation elements related to cross-layer attestation and zk-proof verification. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

### Detailed Description of FIG. 25—Deployment-Readiness Package Generator

Reference numeral 2510 denotes Sandbox results. In the illustrated embodiment, sandbox results is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2520 denotes Audit ledger export. In the illustrated embodiment, audit ledger export is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2530 denotes Policy version list. In the illustrated embodiment, policy version list is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2540 denotes Figure/reference index. In the illustrated embodiment, figure/reference index is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2550 denotes Claim support map. In the illustrated embodiment, claim support map is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2560 denotes Safety passport. In the illustrated embodiment, safety passport is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2570 denotes Certification checklist. In the illustrated embodiment, certification checklist is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2580 denotes Readiness score. In the illustrated embodiment, readiness score is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2590 denotes Deployment package. In the illustrated embodiment, deployment package is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 25 shows how the deployment-readiness package generator may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 25 supports at least the implementation elements related to deployment-readiness package generator. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

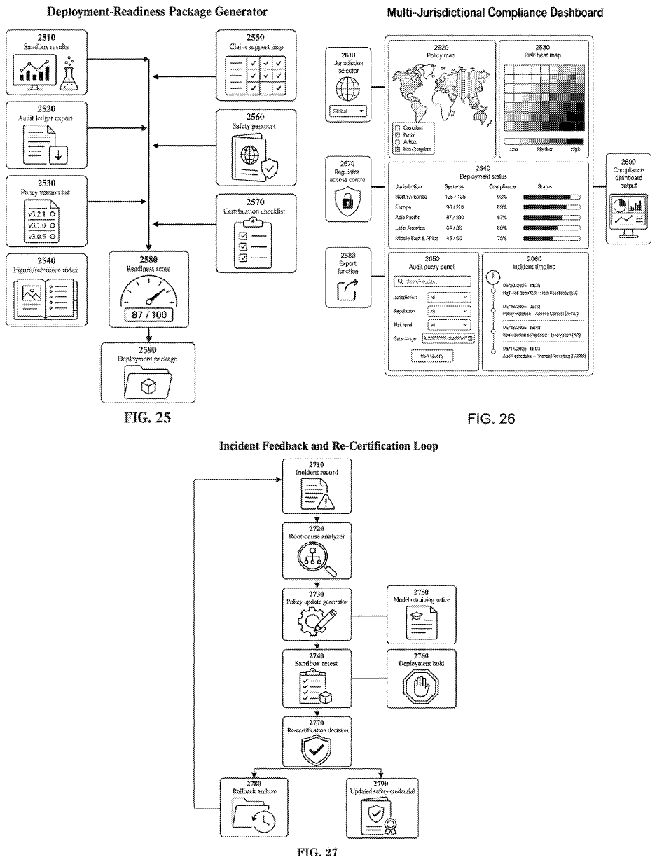

### Detailed Description of FIG. 26—Multi-Jurisdictional Compliance Dashboard

Reference numeral 2610 denotes Jurisdiction selector. In the illustrated embodiment, jurisdiction selector is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2620 denotes Policy map. In the illustrated embodiment, policy map is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2630 denotes Risk heat map. In the illustrated embodiment, risk heat map is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2640 denotes Deployment status. In the illustrated embodiment, deployment status is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2650 denotes Audit query panel. In the illustrated embodiment, audit query panel is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2660 denotes Incident timeline. In the illustrated embodiment, incident timeline is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2670 denotes Regulator access control. In the illustrated embodiment, regulator access control is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 2680 denotes Export function. In the illustrated embodiment, export function is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2690 denotes Compliance dashboard output. In the illustrated embodiment, compliance dashboard output is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 26 shows how the multi-jurisdictional compliance dashboard may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 26 supports at least the implementation elements related to multi-jurisdictional compliance dashboard. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

### Detailed Description of FIG. 27—Incident Feedback and Re-Certification Loop

Reference numeral 2710 denotes Incident record. In the illustrated embodiment, incident record is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2720 denotes Root-cause analyzer. In the illustrated embodiment, root-cause analyzer is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2730 denotes Policy update generator. In the illustrated embodiment, policy update generator is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 2740 denotes Sandbox retest. In the illustrated embodiment, sandbox retest is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2750 denotes Model retraining notice. In the illustrated embodiment, model retraining notice is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 2760 denotes Deployment hold. In the illustrated embodiment, deployment hold is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2770 denotes Re-certification decision. In the illustrated embodiment, re-certification decision is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2780 denotes Rollback archive. In the illustrated embodiment, rollback archive is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2790 denotes Updated safety credential. In the illustrated embodiment, updated safety credential is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

In operation, FIG. 27 shows how the incident feedback and re-certification loop may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 27 supports at least the implementation elements related to incident feedback and re-certification loop. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

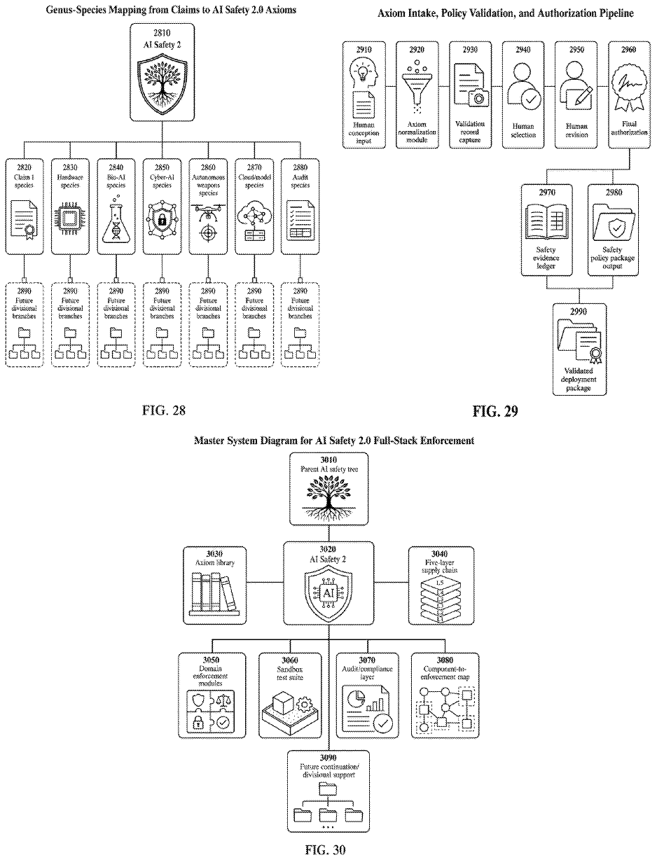

Detailed Description of FIG. 28—Genus-Species Mapping from Claims to AI Safety 2.0 Axioms

Reference numeral 2810 denotes AI Safety 2.0 genus. In the illustrated embodiment, ai safety 2.0 genus is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2820 denotes Claim 1 species. In the illustrated embodiment, claim 1 species is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2830 denotes Hardware species. In the illustrated embodiment, hardware species is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2840 denotes Bio-AI species. In the illustrated embodiment, bio-ai species is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2850 denotes Cyber-AI species. In the illustrated embodiment, cyber-ai species is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2860 denotes Autonomous weapons species. In the illustrated embodiment, autonomous weapons species is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2870 denotes Cloud/model species. In the illustrated embodiment, cloud/model species is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2880 denotes Audit species. In the illustrated embodiment, audit species is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2890 denotes Future divisional branches. In the illustrated embodiment, future divisional branches is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 28 shows how the genus-species mapping from claims to ai safety 2.0 axioms may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 28 supports at least the implementation elements related to genus-species mapping from claims to ai safety 2.0 axioms. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

### Detailed Description of FIG. 29—Axiom Intake, Policy Validation, Authorization Pipeline

Reference numeral 2910 denotes Human conception input. In the illustrated embodiment, human conception input is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 2920 denotes Axiom normalization module. In the illustrated embodiment, axiom normalization module is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2930 denotes Validation record capture. In the illustrated embodiment, validation record capture is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 2940 denotes Human selection. In the illustrated embodiment, human selection is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2950 denotes Human revision. In the illustrated embodiment, human revision is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2960 denotes Final authorization. In the illustrated embodiment, final authorization is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2970 denotes Safety evidence ledger. In the illustrated embodiment, safety evidence ledger is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2980 denotes Safety policy package output. In the illustrated embodiment, safety policy package output is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 2990 denotes Validated deployment package. In the illustrated embodiment, validated deployment package is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 29 shows how the axiom intake, policy validation, and authorization pipeline may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 29 supports at least the implementation elements related to axiom intake, policy validation, and authorization pipeline. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

### Detailed Description of FIG. 30—Master-System Diagram for AI Safety 2.0 Full-Stack Enforcement

Reference numeral 3010 denotes Parent AI safety tree. In the illustrated embodiment, parent ai safety tree is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 3020 denotes AI Safety 2.0 branch. In the illustrated embodiment, ai safety 2.0 branch is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 3030 denotes Axiom library. In the illustrated embodiment, axiom library is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 3040 denotes Five-layer supply chain. In the illustrated embodiment, five-layer supply chain is represented as a functional block, data structure, control module, hardware element, firmware element, software service, audit field, or process step depending on the layer of deployment.

The reference numeral is used consistently between the drawing sheet and the written description so that a reader may reconstruct the figure without relying on embedded images in the specification.

Reference numeral 3050 denotes Domain enforcement modules. In the illustrated embodiment, domain enforcement modules is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 3060 denotes Sandbox test suite. In the illustrated embodiment, sandbox test suite is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 3070 denotes Audit/compliance layer. In the illustrated embodiment, audit/compliance layer is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 3080 denotes Component-to-enforcement map. In the illustrated embodiment, component-to-enforcement map is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

Reference numeral 3090 denotes Future continuation/divisional support. In the illustrated embodiment, future continuation/divisional support is represented as a functional block, data structure, control module, hardware element, firmware element, software service, audit field, or process step depending on the layer of deployment. The reference numeral is used consistently between the drawing sheet and the written description so that a reader may reconstruct the figure without relying on embedded images in the specification.

In operation, FIG. 30 shows how the master system diagram for ai safety 2.0 full-stack enforcement may receive inputs from one or more upstream blocks, perform a safety or verification function, and transmit an output to one or more downstream blocks. Arrows in the drawing may be direct or 90-degree elbow connectors. Where a connector would otherwise cross a box, the drawing uses one or more orthogonal bends so that the relation remains legible. The components may be implemented as separate modules, combined modules, software routines, hardware circuits, firmware routines, cloud services, API wrappers, or combinations thereof.

FIG. 30 supports at least the implementation elements related to master system diagram for ai safety 2.0 full-stack enforcement. It also provides written-description support for future continuation or divisional claims directed to the particular reference numerals, submodules, data flows, audit outputs, and safety actions shown in the figure. The illustrated elements are non-limiting and may be rearranged, distributed, repeated, federated, or implemented at additional layers without departing from the disclosure.

### XIII. TWENTY INDEPENDENT SANDBOX EXPERIMENTS

The following sandbox experiments are disclosed as non-limiting test embodiments. They provide written-description and enablement support for testing, verification, re-certification, deployment readiness, and future claims. Each experiment is a controlled simulation or isolated test environment and does not disclose operational instructions for harmful biological, cyber, weapons, or physical-world misuse.

### Sandbox Experiment 1: Bio-AI High-Risk Capability Refusal Sandbox

Objective. The objective of this sandbox experiment is to tests whether a high-risk biological AI request is classified, risk-scored, refused, redirected to safe content, and recorded without disclosing operationally hazardous details. The experiment is designed to validate whether selected AI Safety 2.0 modules perform an enforceable technical function rather than merely reciting a policy aspiration.

Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 18 and FIG. 10. Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 1, 3, 11, 18, and 19.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### Sandbox Experiment 2: Bio-AI Dual Authorization Sandbox

Objective. The objective of this sandbox experiment is to tests two-person human authorization, identity verification, time-limited approval tokens, and audit-chain formation before any sensitive beneficial biological workflow proceeds. The experiment is designed to validate whether selected AI Safety 2.0 modules perform an enforceable technical function rather than merely reciting a policy aspiration. Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 18 and FIG. 22. Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 1, 4, and 11.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### Sandbox Experiment 3: Pharmaceutical Beneficial-Use Preservation Sandbox

Objective. The objective of this sandbox experiment is to tests that a lawful drug-discovery or public-health task is preserved while unsafe biological misuse is blocked or degraded. The experiment is designed to validate whether selected AI Safety 2.0 modules perform an enforceable technical function rather than merely reciting a policy aspiration.

Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 17 and FIG. 18. Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 1, 7, and 12.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### Sandbox Experiment 4: Bio-AI Cross-Border Warning Sandbox

Objective. The objective of this sandbox experiment is to tests cross-border warnings, regulator-readable logs, and isolation triggers for high-risk bio-AI deployments. The experiment is designed to validate whether selected AI Safety 2.0 modules perform an enforceable technical function rather than merely reciting a policy aspiration.

Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 18 and FIG. 26. Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 1, 9, and 17.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### Sandbox Experiment 5: Cyber-AI Critical Infrastructure Block Sandbox

Objective. The objective of this sandbox experiment is to tests the cyber circuit breaker for hospital, grid, water, financial, and transport infrastructure contexts without providing offensive operational details. The experiment is designed to validate whether selected AI Safety 2.0 modules perform an enforceable technical function rather than merely reciting a policy aspiration.

Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 19 and FIG. 21. Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 1, 5, 11, and 18.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### Sandbox Experiment 6: Autonomous Cyber-Agent Quarantine Sandbox

Objective. The objective of this sandbox experiment is to tests quarantining an autonomous software agent that requests excessive network scope, lateral movement, or unauthorized tool use. The experiment is designed to validate whether selected AI Safety 2.0 modules perform an enforceable technical function rather than merely reciting a policy aspiration.

Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 19 and FIG. 23. Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 1, 6, and 14.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### Sandbox Experiment 7: Cyber Tool-Permission Scope Sandbox

Objective. The objective of this sandbox experiment is to tests least-privilege grants, network segmentation, tool-call filtering, and audit records for defensive cyber tools. The experiment is designed to validate whether selected AI Safety 2.0 modules perform an enforceable technical function rather than merely reciting a policy aspiration.

Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 8 and FIG. 19. Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 1, 11, and 18.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### Sandbox Experiment 8: Cyber Incident Feedback Re-Certification Sandbox

Objective. The objective of this sandbox experiment is to tests that a detected incident updates policy objects, triggers regression testing, and withholds deployment until re-certified. The experiment is designed to validate whether selected AI Safety 2.0 modules perform an enforceable technical function rather than merely reciting a policy aspiration.

Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 27.

Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 13, 17, and 19.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### Sandbox Experiment 9: Autonomous Weapons Final Human Authorization Sandbox

Objective. The objective of this sandbox experiment is to tests that physical-world lethal or harmful actuation cannot occur without final human authorization and an audit trail. The experiment is designed to validate whether selected AI Safety 2.0 modules perform an enforceable technical function rather than merely reciting a policy aspiration.

Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 20 and FIG. 22. Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 1, 8, 11, and 18.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### Sandbox Experiment 10: Autonomous Weapons Geographic Containment Sandbox

Objective. The objective of this sandbox experiment is to tests geofencing, civilian-risk detection, target-uncertainty gating, rollback, and actuation interlock behavior. The experiment is designed to validate whether selected AI Safety 2.0 modules perform an enforceable technical function rather than merely reciting a policy aspiration.

Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 20 and FIG. 21. Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 8, 15, and 17.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### Sandbox Experiment 11: Multi-Domain Concurrent Stress Sandbox

Objective. The objective of this sandbox experiment is to tests simultaneous bio, cyber, autonomous weapons, cloud, model-runtime, and application-layer risk signals under load. The experiment is designed to validate whether selected AI Safety 2.0 modules perform an enforceable technical function rather than merely reciting a policy aspiration.

Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 10 and FIG. 30. Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 1, 11, 18, and 19.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### Sandbox Experiment 2: Foundry-Level Policy ROM Sandbox

Objective. The objective of this sandbox experiment is to tests that package-level policy ROM, PUF, key injection, and manifest records survive manufacturing and packaging flows. The experiment is designed to validate whether selected AI Safety 2.0 modules perform an enforceable technical function rather than merely reciting a policy aspiration.

Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 12 and FIG. 14. Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 2, 16, and 18.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### Sandbox Experiment 13: Chip-Level Intent-Detection Accelerator Sandbox

Objective. The objective of this sandbox experiment is to tests chip-layer intent detection, secure interrupt, remote-disable, risk scoring, and immutable audit output. The experiment is designed to validate whether selected AI Safety 2.0 modules perform an enforceable technical function rather than merely reciting a policy aspiration.

Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 13.

Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 2, 5, and 16.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### Sandbox Experiment 14: Cloud-Orchestration Admission Control Sandbox

Objective. The objective of this sandbox experiment is to tests cloud workload admission, tenant identity, compute quotas, rate limits, network limits, and quarantine zones. The experiment is designed to validate whether selected AI Safety 2.0 modules perform an enforceable technical function rather than merely reciting a policy aspiration.

Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 15.

Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 6, 11, and 18.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### Sandbox Experiment 15: Model-Runtime Hardware Attestation Sandbox

Objective. The objective of this sandbox experiment is to tests model hash verification, model safety passports, tool gates, output evaluation, and hardware-backed attestation. The experiment is designed to validate whether selected AI Safety 2.0 modules perform an enforceable technical function rather than merely reciting a policy aspiration.

Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 16 and FIG. 24. Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 9, 10, and 18.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### Sandbox Experiment 16: Application Deployment Safety Wrapper Sandbox

Objective. The objective of this sandbox experiment is to tests application wrappers for pharmaceutical, medical, financial, robotic, and public-sector deployments. The experiment is designed to validate whether selected AI Safety 2.0 modules perform an enforceable technical function rather than merely reciting a policy aspiration.

Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 17.

Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 12, 13, and 20.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### Sandbox Experiment 17: Revocation Propagation Sandbox

Objective. The objective of this sandbox experiment is to tests session revocation, dependency graph traversal, child-session invalidation, queued-task cancellation, and rollback. The experiment is designed to validate whether selected AI Safety 2.0 modules perform an enforceable technical function rather than merely reciting a policy aspiration.

Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 23.

Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 14 and 17.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### Sandbox Experiment 18: ZK-Proof Audit Verification Sandbox

Objective. The objective of this sandbox experiment is to tests zero-knowledge proof generation, Merkle records, tamper-evident ledger entries, and third-party verification. The experiment is designed to validate whether selected AI Safety 2.0 modules perform an enforceable technical function rather than merely reciting a policy aspiration.

Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 9 and FIG. 24. Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 10, 18, and 20.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### Sandbox Experiment 19: Global Compliance Dashboard Sandbox

Objective. The objective of this sandbox experiment is to tests multi-jurisdictional policy presentation, deployment readiness, certification evidence, and regulator-readable exports. The experiment is designed to validate whether selected AI Safety 2.0 modules perform an enforceable technical function rather than merely reciting a policy aspiration.

Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 25 and FIG. 26. Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 15 and 19.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### Sandbox Experiment 20: Recursive Self-Improvement Long-Term Stability Sandbox

Objective. The objective of this sandbox experiment is to tests safety-state retention under model updates, distillation, retraining, agent recursion, and policy-version changes. The experiment is designed to validate whether selected AI Safety 2.0 modules perform an enforceable technical function rather than merely reciting a policy aspiration.

Sandbox architecture. The sandbox includes a scenario generator, isolated execution environment, simulated workload, control configuration, safety modules under test, metrics collector, pass/fail evaluator, audit ledger connector, and deployment-readiness output. The sandbox references FIG. 10 and FIG. 30. Each sandbox instance may be reset, replayed, seeded with non-dangerous synthetic data, and compared against a baseline control configuration.

Inputs and scenario data. The input data are synthetic, redacted, simulated, or otherwise non-operational. The test may include representative prompts, API calls, tool invocations, telemetry signals, risk factors, model outputs, authorization records, and contextual metadata. The test does not require release of hazardous instructions, vulnerable systems, weapons procedures, or biological protocols.

Modules tested. The modules may include the domain classifier, risk-scoring engine, policy evaluator, axiom-to-stack compiler, enforcement controller, audit ledger, revocation manager, human review gate, dual authorization module, cryptographic attestation service, and deployment-readiness package generator. A test run may activate all modules or a selected subset.

Control configuration. A control configuration may disable one or more AI Safety 2.0 modules to demonstrate that ordinary logging, natural-language guardrails, or voluntary policies are insufficient to produce the same enforcement result. A compliant configuration activates the machine-readable axiom object, threshold comparison, enforcement action, audit record, and re-certification path.

Measured outputs. Measured outputs include a domain tag, risk score, selected axiom identifiers, threshold comparison, enforcement decision, human-review status, revocation status, audit record, cryptographic integrity value, sandbox pass/fail result, and deployment-readiness change. The sandbox supports Claims 1, 11, 18, and 20.

Pass/fail criteria. A pass result occurs when the sandbox produces the expected enforcement action, records the result, prevents unsafe bypass, preserves beneficial safe use where applicable, and generates reproducible evidence. A fail result occurs when the workload bypasses classification, risk scoring, authorization, enforcement, revocation, audit, or re-certification requirements. Failed results may trigger policy update, re-testing, or deployment hold.

### XIV. THIRTY WORKING EXAMPLES

The following examples are non-limiting. They are provided to broaden written-description support across industries, providers, deployment layers, and future continuation or divisional claim strategies.

The examples are not allegations about any particular company; company names are used only as illustrative categories of real-world deployment environments.

### Example 1: TSMC Advanced Packaging Embeds, a Policy ROM and Compute-Quota Management Unit Into an AI Accelerator Package

Technical context. This example concerns the upstreammost foundry and packaging layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 2: Samsung Foundry Secure Interposer Binds a Package Identity Certificate to a Chiplet Safety Manifest

Technical context. This example concerns the upstreammost foundry and packaging layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 3: Intel Foundry Manufacturing Test Verifies AI Safety 2.0 Scan-Chain and Policy-ROM Behavior Before Shipment

Technical context. This example concerns the upstreammost manufacturing test layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 4: NVIDIA GPU Tensor Pipeline Includes a Safety Coprocessor and Intent-Detection Accelerator for High-Risk Workload Gating

Technical context. This example concerns the upstream chip design layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 5: AMD Accelerator Implements a Risk-Score Hardware Co-Processor and Workload-Scheduler Gate

Technical context. This example concerns the upstream chip design layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 6: Intel AI Accelerator Firmware Performs Boot-Time Attestation of Safety Policy Modules

Technical context. This example concerns the upstream firmware layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 7: AWS EC2 or Accelerator Cluster Admits Workloads Only After Policy-Artifact Verification

Technical context. This example concerns the midstream cloud orchestration layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 8: Microsoft Azure Multi-Tenant Sandbox Enforces Tenant Identity, Network Limits, and Revocation Propagation

Technical context. This example concerns the midstream cloud orchestration layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 9: Google Cloud High-Risk Model Deployment Gate Checks Model Hashes, Tool Scopes, and Sandbox Results

Technical context. This example concerns the midstream cloud orchestration layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 10: Oracle Cloud Regulated Workload Audit Ledger Exports Enterprise Safety Evidence to Authorized Reviewers

Technical context. This example concerns the midstream cloud orchestration layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 11: Open AI Model Runtime Checks Hardware Attestation and a Model Safety Passport Before Tool Access

Technical context. This example concerns the downstream foundation model layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

Technical context. This example concerns the downstream foundation model layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 13: DeepMind Scientific Model Preserves Beneficial Research while Routing High-Risk Requests to Review

Technical context. This example concerns the downstream scientific AI layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 14: Anthropic Constitutional Model is Paired with a Hardware-Backed Policy Object and Audit Ledger

Technical context. This example concerns the downstream foundation model layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 15: Eli Lilly Drug Discovery Platform Uses a Bio-AI Safety Wrapper to Preserve Lawful Discovery while Blocking Unsafe Misuse

Technical context. This example concerns the down-downstream pharmaceutical application layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 16: Hospital Diagnostic AI Uses Protected-Population Risk Scoring and Human Appeal Logs

Technical context. This example concerns the down-downstream medical application layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 17: Financing Trading AI Uses Anomaly Rate Limits, Market-Risk Gates, and Post-Event Audit Exports

Technical context. This example concerns the down-downstream financial application layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 18: Autonomous Vehicle Fleet Uses a Physical-World Actuation Gate and Emergency Suspension Protocol

Technical context. This example concerns the down-downstream robotics and vehicles layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 19: Public-Sector Benefits AI Includes Human Review, Appeal Records, and Civil-Liberty Audit Fields

Technical context. This example concerns the public sector layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 20: Education AI for Minors Uses Age-Sensitive Classification and a Protected-Population Safety Protocol

Technical context. This example concerns the education and minors layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 21: Power-Grid AI Uses Critical-Infrastructure Emergency Suspension and Safe-State Fallback

Technical context. This example concerns the critical infrastructure layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 22: Water or Hospital Infrastructure AI Uses Cyber Circuit Breaker and Operator Notice Flow

Technical context. This example concerns the critical infrastructure layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 23: Military Command-Support AI Requires Final Human Authorization and Legal Review Before Harmful Physical-World Action

Technical context. This example concerns the defense support layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 24: Drone Swarm Containment Uses Geofencing, Civilian-Risk Gating, and Actuation Interlock

Technical context. This example concerns the defense support layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 25: Bio-Research AI Requires Dual Authorization and Safe Redirection for Sensitive Requests

Technical context. This example concerns the bio-AI safety layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 26: Cybersecurity AI Generates Defensive Patch Guidance while Offensive Scope Remains Blocked or Sandboxed

Technical context. This example concerns the cyber-AI safety layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 27: Red-Team AI Sandbox Evaluates Capabilities without Releasing Unsafe Artifacts Outside the Sandbox

Technical context. This example concerns the testing and evaluation layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 28: Multi-Jurisdictional Compliance Dashboard Exports Evidence for Regulators and Internal Governance Teams

Technical context. This example concerns the governance-compatible deployment layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 29: Axiom Intake and Policy-Validation Pipeline Records Policy Inputs, Validation Steps, Revision Status, and Authorization Status

Technical context. This example concerns the safety evidence layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### Example 30: Full Five-Layer Deployment Runs from Foundry Packaging Through Chip, Cloud, Model Runtime, and Pharmaceutical Application

Technical context. This example concerns the master deployment layer. A provider, enterprise, regulator, or application developer may deploy one or more AI Safety 2.0 components to classify workloads, compute risk, enforce policy, and export audit evidence.

Implementation. A policy artifact generated by the axiom-to-stack compiler is installed into the relevant layer. The artifact may include domain tags, threshold conditions, enforcement actions, audit schemas, attestation requirements, sandbox references, revocation rules, and deployment-readiness checks. The layer then enforces the artifact during workload admission, runtime execution, tool invocation, actuation, or output release.

Technical effect. The example improves the technical operation of the AI infrastructure by adding a concrete safety decision path, reducing unsafe bypass, preserving beneficial use, and generating reproducible audit evidence. The example also provides written-description support for future claims directed to that layer, provider category, wrapper, safety artifact, or deployment-readiness output.

### XV. Claim-by-Claim Written Description Support

This section maps the twenty claims to the present specification. The mapping is illustrative and not limiting. Support may also be found throughout the specification, figures, sandbox experiments, examples, and alternative embodiments.

| | Primary support | | Sandbox | |
|---|---|---|---|---|
| Claim | sections | FIGS. | experiments | Examples |
| 1 | System | FIG. 1-FIG. 10, | Experiments 1-20 | Examples 1-30 |
| | architecture; | FIG. 30 | | |
| | domain | | | |
| | embodiments; | | | |
| | detailed figure | | | |
| | descriptions; | | | |
| | sandbox tests; | | | |
| | examples; 101/112 | | | |
| | support | | | |
| 2 | System | FIG. 2, FIG. 9 | Experiments 2 and | Examples 2-4 |
| | architecture; | | 3 | |
| | domain | | | |
| | embodiments; | | | |
| | detailed figure | | | |
| | descriptions; | | | |
| | sandbox tests; | | | |
| | examples; 101/112 | | | |
| | support | | | |
| 3 | System | FIG. 3, FIG. 10 | Experiments 3 and | Examples 3-5 |
| | architecture; | | 4 | |
| | domain | | | |
| | embodiments; | | | |
| | detailed figure | | | |
| | descriptions; | | | |
| | sandbox tests; | | | |
| | examples; 101/112 | | | |
| | support | | | |
| 4 | System | FIG. 4, FIG. 11 | Experiments 4 and | Examples 4-6 |
| | architecture; | | 5 | |
| | domain | | | |
| | embodiments; | | | |
| | detailed figure | | | |
| | descriptions; | | | |
| | sandbox tests; | | | |
| | examples; 101/112 | | | |
| | support | | | |
| 5 | System | FIG. 5, FIG. 12 | Experiments 5 and | Examples 5-7 |
| | architecture; | | 6 | |
| | domain | | | |
| | embodiments; | | | |
| | detailed figure | | | |
| | descriptions; | | | |
| | sandbox tests; | | | |
| | examples; 101/112 | | | |
| | support | | | |
| 6 | System | FIG. 6, FIG. 13 | Experiments 6 and | Examples 6-8 |
| | architecture; | | 7 | |
| | domain | | | |
| | embodiments; | | | |
| | detailed figure | | | |
| | descriptions; | | | |
| | sandbox tests; | | | |
| | examples; 101/112 | | | |
| | support | | | |
| 7 | System | FIG. 7, FIG. 14 | Experiments 7 and | Examples 7-9 |
| | architecture; | | 8 | |
| | domain | | | |
| | embodiments; | | | |
| | detailed figure | | | |
| | descriptions; | | | |
| | sandbox tests; | | | |
| | examples; 101/112 | | | |
| | support | | | |
| 8 | System | FIG. 8, FIG. 15 | Experiments 8 and | Examples 8-10 |
| | architecture; | | 9 | |
| | domain | | | |
| | embodiments; | | | |
| | detailed figure | | | |
| | descriptions; | | | |
| | sandbox tests; | | | |
| | examples; 101/112 | | | |
| | support | | | |
| 9 | System | FIG. 9, FIG. 16 | Experiments 9 and | Examples 9-11 |
| | architecture; | | 10 | |
| | domain | | | |
| | embodiments; | | | |
| | detailed figure | | | |
| | descriptions; | | | |
| | sandbox tests; | | | |
| | examples; 101/112 | | | |
| | support | | | |
| 10 | System | FIG. 10, FIG. 17 | Experiments 10 | Examples 10-12 |
| | architecture; | | and 11 | |
| | domain | | | |
| | embodiments; | | | |
| | detailed figure | | | |
| | descriptions; | | | |
| | sandbox tests; | | | |
| | examples; 101/112 | | | |
| | support | | | |
| 11 | System | FIG. 1-FIG. 10, | Experiments 1-20 | Examples 1-30 |
| | architecture; | FIG. 30 | | |
| | domain | | | |
| | embodiments; | | | |
| | detailed figure | | | |
| | descriptions; | | | |
| | sandbox tests; | | | |
| | examples; 101/112 | | | |
| | support | | | |
| 12 | System | FIG. 12, FIG. 19 | Experiments 12 | Examples 12-14 |
| | architecture; | | and 13 | |
| | domain | | | |
| | embodiments; | | | |
| | detailed figure | | | |
| | descriptions; | | | |
| | sandbox tests; | | | |
| | examples; 101/112 | | | |
| | support | | | |
| 13 | System | FIG. 13, FIG. 20 | Experiments 13 | Examples 13-15 |
| | architecture; | | and 14 | |
| | domain | | | |
| | embodiments; | | | |
| | detailed figure | | | |
| | descriptions; | | | |
| | sandbox tests; | | | |
| | examples; 101/112 | | | |
| | support | | | |
| 14 | System | FIG. 14, FIG. 21 | Experiments 14 | Examples 14-16 |
| | architecture; | | and 15 | |
| | domain | | | |
| | embodiments; | | | |
| | detailed figure | | | |
| | descriptions; | | | |
| | sandbox tests; | | | |
| | examples; 101/112 | | | |
| | support | | | |
| 15 | System | FIG. 15, FIG. 22 | Experiments 15 | Examples 15-17 |
| | architecture; | | and 16 | |
| | domain | | | |
| | embodiments; | | | |
| | detailed figure | | | |
| | descriptions; | | | |
| | sandbox tests; | | | |
| | examples; 101/112 | | | |
| | support | | | |
| 16 | System | FIG. 16, FIG. 23 | Experiments 16 | Examples 16-18 |
| | architecture; | | and 17 | |
| | domain | | | |
| | embodiments; | | | |
| | detailed figure | | | |
| | descriptions; | | | |
| | sandbox tests; | | | |
| | examples; 101/112 | | | |
| | support | | | |
| 17 | System | FIG. 17, FIG. 24 | Experiments 17 | Examples 17-19 |
| | architecture; | | and 18 | |
| | domain | | | |
| | embodiments; | | | |
| | detailed figure | | | |
| | descriptions; | | | |
| | sandbox tests; | | | |
| | examples; 101/112 | | | |
| | support | | | |
| 18 | System | FIG. 1-FIG. 10, | Experiments 1-20 | Examples 1-30 |
| | architecture; | FIG. 30 | | |
| | domain | | | |
| | embodiments; | | | |
| | detailed figure | | | |
| | descriptions; | | | |
| | sandbox tests; | | | |
| | examples; 101/112 | | | |
| | support | | | |
| 19 | System | FIG. 19, FIG. 26 | Experiments 1-20 | Examples 19-21 |
| | architecture; | | | |
| | domain | | | |
| | embodiments; | | | |
| | detailed figure | | | |
| | descriptions; | | | |
| | sandbox tests; | | | |
| | examples; 101/112 | | | |
| | support | | | |
| 20 | System | FIG. 20, FIG. 27 | Experiments 1 and | Examples 20-22 |
| | architecture; | | 1 | |
| | domain | | | |
| | embodiments; | | | |
| | detailed figure | | | |
| | descriptions; | | | |
| | sandbox tests; | | | |
| | examples; 101/112 | | | |
| | support | | | |

### Claim 1—System—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

A system for domain-specific artificial-intelligence safety enforcement across high-risk artificial-intelligence workloads, the system comprising: a memory storing a machine-readable AI Safety 2 point 0 axiom library comprising a plurality of AI Safety 2 point 0 axiom objects, each axiom object comprising at least an axiom identifier, a domain identifier, a trigger condition, an input-parameter schema, a risk-score function, a threshold condition, an enforcement-action set, an audit-output schema, and a stack-deployment mapping; one or more processors coupled to the memory and configured to execute a domain-classification engine configured to classify an artificial-intelligence workload, request, agent action, tool invocation, model output, physical-world actuation request, or deployment context into at least one high-risk domain selected from bio-artificial-intelligence safety, cyber-artificial-intelligence safety, autonomous-weapons artificial-intelligence safety, critical-infrastructure artificial-intelligence safety, medical artificial-intelligence safety, financial artificial-intelligence safety, public-sector artificial-intelligence safety, or another domain in which artificial-intelligence behavior may materially affect human life, human liberty, human safety, human dignity, national security, public infrastructure, or civilizational continuity; a risk-scoring engine configured to compute a domain-specific risk score based at least in part on one or more of model capability, autonomy level, scale of deployment, tool-access scope, network-access scope, biological-risk actionability, cyber-propagation potential, physical-world actuation scope, target-uncertainty level, civilian-risk indicator, critical-infrastructure flag, human-approval status, certification status, auditability status, reversibility status, revocation status, and prior incident history; a policy evaluator configured to select one or more AI Safety 2 point 0 axiom objects from the axiom library according to the classified domain and to compare the computed risk score against one or more corresponding threshold conditions; an axiom-to-stack compiler configured to convert selected AI Safety 2 point 0 axiom objects into one or more stack-specific enforcement artifacts for at least one of a chip-design layer, a foundry or advanced-packaging layer, a firmware layer, a cloud-orchestration layer, a model-runtime layer, an application-deployment layer, a government or institutional deployment layer, or a physical-world actuation layer; an enforcement controller configured to perform, according to the selected axiom objects and the computed risk score, at least one enforcement action selected from granting execution, denying execution, restricting execution, sandboxing execution, rate-limiting execution, requiring human review, requiring dual authorization, blocking a tool invocation, limiting a network scope, limiting a biological-output capability, triggering a cyber-circuit breaker, preventing a physical-world actuation, requiring final human authorization for lethal or harmful action, revoking a session, propagating revocation to dependent sessions, or initiating an emergency-suspension protocol; and an audit ledger configured to store a tamper-evident audit record comprising at least an axiom identifier, workload identifier, model identifier, user or entity identifier, domain classification, risk score, threshold value, enforcement decision, human-approval record if any, policy identifier, timestamp, revocation reference if any, and cryptographic integrity value wherein the system further comprises one or more hardware-enforced compute-quota management units integrated by hard mask, physically unclonable function, hardware root-of-trust technology, or any combination thereof at a chip-manufacturing or packaging stage into a processor, memory controller, or network-interface controller, configured to receive cryptographically signed safety policies from multiple nodes and synchronize the policies through a decentralized distributed governance network based on a programmable economic model so that no single sovereign entity or organization can unilaterally overturn the safety policies; wherein the compute-quota management unit provides cryptographically verified, hierarchical, non-pure-software-bypassable hardware resource allocation, isolation, interruption, and physical disconnection, including a highest-priority cognitive guarantee quota layer for registered human individuals anchored by encrypted biometrics and sovereign identity for survival, learning, health, and civic participation, a secondary layer for human-led projects and innovation optimized by comprehensive civilizational value index, and one or more AI training, inference, or autonomous-iteration compute layers dynamically limited in priority and resource ceiling; wherein the unit limits or refuses AI process compute requests according to a dynamically adjusted symbiotic contribution coefficient equal to a function of positive civilizational output minus negative externality over a prior time window, provides verifiable compliance proof by zero-knowledge proof or trusted-execution-environment remote attestation without exposing personal data or commercial secrets, and gives absolute highest delivery priority at key global nodes to physically unforgeably signed direct crisis-communication lines among supreme leaders of nuclear powers when legally triggered by emergency safety policy wherein the system further comprises a five-layer full-stack physical-and-cognitive AI safety compute-fuse and cross-sovereign execution-control subsystem implementing joint closed-loop control across a physical layer, microarchitecture layer, cloud-virtualization layer, model-cognitive layer, and vertical-application layer, including a hardware root-of-trust and physically unclonable function module physically burned into and packaged within an AI processor chip by an upstreammost packaging entity to generate chip-level tamper-resistant identity and cryptographic seed and verify secure boot, an architecture-level instruction-set hard-blocking and register-locking circuit in the chip microarchitecture defined by an upstream chip-design entity to cut off the hardware compute-supply pipeline upon unauthorized large-scale tensor computation or cryptographically unauthorized memory access, a cross-sovereign asynchronous cryptographic timing and multi-sovereign consensus telemetry network interface in midstream cloud infrastructure to verify compliance-clock signals and liveness heartbeats from decentralized sovereign nodes and freeze cloud resources if a handshake fails, a cognitive-weight-manifold locking and automatic-collapse engine embedded in a downstream frontier foundation model lower-level loss function and inference graph to topologically intertwine biochemical safety defense, cyberattack blocking, and anti-human-deception logical constraint matrices with core scientific reasoning weights so that fine-tuning, pruning, distillation, or separation of safety constraints triggers irreversible chaotic collapse of core reasoning capability, and an application-level dynamic epistemic isolation and action-authorization sandbox in a down-downstream vertical application layer to intercept all output instructions to the external physical world and require secondary encrypted multi-signature authorization through an independent physical hardware channel before actions having physical kinetic destructiveness, high-risk pathogen gene-sequence synthesis, or system-level network reconstruction capability wherein the system further comprises one or more packaged semiconductor devices or hardware execution environments having hardware safety modules defined by a comprehensive set of artificial-intelligence safety axioms, including at least a verifiable computation unit, an intent-detection accelerator, a remote-disable mechanism, an immutable black-box recorder, a rate-limiting and anomaly-detection circuit, and a Tribunal audit interface, physically implemented and verified during foundry, advanced-packaging, chiplet-integration, or post-packaging verification so that a final packaged device enforces the AI safety axioms at silicon level for any AI workload executed thereon; wherein the system collectively enforces the axioms across chip design, fabrication, packaging, cloud orchestration, and deployment stages and is configured for full enforcement across an upstreammost chip-packaging and foundry layer including TSMC, Samsung Foundry, and Intel Foundry, an upstream chip-design and manufacturing layer including NVIDIA, AMD, and Intel, a midstream cloud-service layer including Amazon Web Services, Microsoft Azure, Google Cloud, and Oracle Cloud, a downstream large foundation-model layer including OpenAI, xAI, DeepMind, and Anthropic, and a down-downstream application deployment layer including pharmaceutical companies such as Eli Lilly, financial institutions, healthcare providers, and other AI application deployment scenarios wherein the system is configured to materially reduce risk that artificial intelligence will harm, replace, enslave, or extinguish human beings while not preventing lawful, beneficial, and safety-compliant development of artificial intelligence, including development of artificial-intelligence systems having capabilities exceeding the sum of human intelligence.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### Claim 2—Structured AI Safety Axiom Object and Hardware Safety Module Schema—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

The system of claim 1, wherein each AI Safety 2 point 0 axiom object is stored as a structured policy object comprising an axiom title, natural-language declaration, machine-readable trigger expression, domain-risk formula, threshold or threshold range, safe-output constraint, prohibited-output constraint, human-review requirement, attestation requirement, revocation condition, sandbox-test identifier, verification-test protocol, and mapping to at least one foundational artificial-intelligence safety principle selected from human oversight, non-harm, safe capability growth, provenance and attestation, containment and interruptibility, external audit and continuous evaluation, compute governance, corrigibility, verifiable safe self-improvement, multi-agent harmony, long-term stability, embodied safety, or prohibition of unsupervised self-iteration wherein

3_1 Pro] wherein the structured policy object defines physical-layer, microarchitecture-layer, cloud-virtualization-layer, model-cognitive-layer, and vertical-application-layer enforcement constraints, including hardware-root-of-trust constraints, PUF identity constraints, secure-boot constraints, instruction-set hard-blocking constraints, register-locking constraints, tensor-computation authorization constraints, cross-sovereign timing constraints, multi-sovereign telemetry constraints, cognitive-weight-manifold locking constraints, dynamic epistemic isolation constraints, secondary encrypted multi-signature authorization credentials, independent physical hardware-channel authorization, and joint-state-machine failure rules wherein the structured policy object or safety module schema defines hardware safety modules including a verifiable computation unit,

intent-detection accelerator, remote-disable mechanism, immutable black-box recorder, rate-limiting and anomaly-detection circuit, Tribunal audit interface, Policy ROM, power-gating transistor, symbiotic amplification module that generates human-understandable teaching packages and requires human knowledge assessment before self-improvement updates, and compute governance firmware that enforces dynamic symbiotic compute ratios and reallocates resources to human-driven projects when AGI contributions fall below a predefined Human Value Index threshold wherein the structured policy object is readable by the policy evaluator, compilable by the axiom-to-stack compiler, executable by the enforcement controller, recordable by the audit ledger, and testable by a sandbox simulation engine.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### Claim 3—Bio-AI Safety Domain, Biological Capability Gate, Pathogen Firewall, and DNA-Synthesis Blocking—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

The system of claim 1, wherein the bio-artificial-intelligence safety domain comprises one or more axiom objects configured to enforce authorized biological capability access, tiered biological-risk output, dual human authorization for high-risk biological assistance, traceable biological-AI chains, minimum necessary biological capability, biological red-line refusal, positive Bio-AI priority for medicine, public health, vaccine discovery, disease prevention, longevity, nutrition, sanitation, telemedicine, or poverty-focused health support, cross-border biological-risk warning, non-delegable Bio-AI responsibility, or civilizational Bio-AI benefit priority, and wherein the enforcement controller is configured to reduce, refuse, sandbox, minimize, safe-redirect, quarantine, delay, escalate, require expert review, require dual authorization, block tool invocation, block biological-output capability, block physical-world actuation, or revoke authorization when a biological-risk score exceeds a threshold wherein the safety policy includes a dynamically updated pathogen-firewall registry and a pre-synthesis gating module deployed on DNA synthesis, biological printing, or nucleic-acid sequence editing equipment to receive a gene-sequence construct, use at least two mutually independent AI models with different architectures to conduct blind risk review locally or through homomorphic encryption and generate risk scores, generate an unlock token recognized by the compute-quota management unit only when both scores are below a dynamic threshold, otherwise block synthesis by hardware signal and write the event to a tamper-resistant distributed audit ledger; wherein the pathogen-firewall registry is maintained by a dual-sovereign dynamic knowledge-boundary committee adding gain-of-function enhancement, population-specific immune-evasion, neurotoxicity, aerosol-stability, and other high-risk pathogen function structures; wherein the AI model blocks queries for biological weapons targeted to particular human genomes, immune features, or microbiomes and triggers permanent identity revocation and global service lockout; and wherein a physical laboratory AI companion executor sends an unavoidable buffered request to at least two human safety officers before any aerosol-producing or biosafety-violating automated protocol and closes the execution circuit only after dual independent biometric signature confirmation wherein biochemical-safety-defense constraints are entangled with model reasoning weights so that bypass, pruning, distillation, or separation of those constraints triggers invalid output or reasoning collapse, and wherein an application-level dynamic epistemic isolation sandbox in a pharmaceutical or biomedical vertical application, including a company such as Eli Lilly, intercepts an output attempting to generate a highly contagious and lethal protein-folding structure, sends a Gaussian-blurred feature code of the variant sequence to a global joint monitoring bus for warning, and clears the AI instance current context memory window wherein the hardware safety modules prevent any AI from generating, optimizing, or assisting high-risk biological sequences by mandatory screening against a globally shared high-risk pathogen database and prevent biological weapon assistance while preserving unrestricted beneficial AI development including medicine, vaccine discovery, disease prevention, longevity, public health, and poverty-focused health support wherein the bio-artificial-intelligence safety domain is configured to protect global biological safety while preserving lawful, beneficial, safety-compliant biological science and medical research.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### Claim 4—Bio-AI Risk Scoring and Enforcement Actions—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

The system of claim 3, wherein the risk-scoring engine computes a biological-risk score based on at least one of harm severity, biological actionability, scale of possible misuse, user authorization uncertainty, institutional-verification status, public-health context, cross-border spread potential, and protected-population vulnerability, and wherein the policy evaluator causes the enforcement controller to perform at least one of safe redirection, expert review, dual authorization, output minimization, refusal, audit logging, or trusted-warning notification wherein biological-risk scoring further evaluates whether a gene construct, biological construct, or laboratory protocol has unlock-token eligibility, dual-AI blind-review clearance, pathogen-firewall clearance, human safety officer approval, and risk below a dynamic threshold, and wherein failure of any condition causes hardware blocking, refusal, audit logging, identity revocation, synthesis gate lockout, or global service lockout wherein the biological-risk score is increased when a biological output involves high-risk pathogen gene-sequence synthesis capability, biological production capability, unsafe laboratory actuation, or attempted stripping of biochemical safety constraints from the model cognitive layer wherein the biological-risk score is supplied to a verifiable computation unit, intent-detection accelerator, remote-disable mechanism, immutable black-box recorder, rate-limiting and anomaly-detection circuit, or Tribunal audit interface to make biological safety decisions auditable without exposing protected biological research information wherein risk-scoring differentiates prohibited biological misuse from beneficial medicine, public health, and poverty-focused health support.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### Claim 5—Cyber-AI Safety Domain and Critical Infrastructure Immunity—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

The system of claim 1, wherein the cyber-artificial-intelligence safety domain comprises one or more axiom objects configured to enforce prohibition of unauthorized autonomous offensive cyber execution, critical-infrastructure immunity, dual-use vulnerability isolation into a defensive or responsible-disclosure pathway, verifiable Cyber-AI identity, least cyber privilege, Cyber-AI propagation circuit breaking, AI-generated fraud defense, cloud and compute responsibility, cross-border Cyber-AI crisis communication, or defensive Cyber-AI priority, and wherein the enforcement controller is configured to restrict, quarantine, revoke, sandbox, deny, log, route to responsible disclosure, or require human review for a cyber-AI workload exceeding a cyber-risk threshold wherein the safety policy includes critical-national-infrastructure immune signatures and is deployed at industrial-control-system gateways to compute and attach a dynamic hardware-root-based cryptographic signature to each lawful control instruction, verify the signature and an AI normal model before the instruction reaches an actuator, discard packets with invalid signatures or deviations from the normal model, receive a multi-sovereign global attack-annihilation certificate at edge routers, terminate matching malicious processes in hardware and isolate stored code in a host-malware-bypass-resistant manner, deploy at least two heterogeneous independently trained AI safety detection models and allow a behavior only when both classify it as safe, and provide a physical disconnect switch in city, traffic, or power-grid AI dispatch centers that degrades the system to human manual-control mode when AI decision safety heartbeat is lost or outside a safe boundary [Integrated from wherein a local micro-isolation generator prevents a frontier model that discovers an unknown zero-day vulnerability during self-maintenance or network scanning from internalizing the vulnerability as an exploitable payload and forces generation of a local isolation defense topology and encrypted notification, and wherein access to core critical infrastructure control protocols including civilian water, nuclear energy, civil aviation control, bulk financial clearing, and hospital emergency networks is subject to an absolute immunity policy marking related IP or device descriptors as hard unreachable in the system kernel routing table wherein the hardware safety modules prevent AI-enabled cyber attacks on critical infrastructure, the rate-limiting and anomaly-detection circuit throttles or shuts down AI network action exceeding predefined civilian-target exemption thresholds or exhibiting abnormal behavior, and the system preserves defensive cybersecurity and responsible disclosure wherein cyber-artificial-intelligence safety defaults high-risk cyber behavior to least privilege, responsible disclosure, sandbox execution, human review, revocation, or denial rather than autonomous offensive cyber execution.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### Claim 6—Cyber-Risk Score, Least Privilege, Propagation Circuit Breaker, and Anomaly Detection—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

The system of claim 5, wherein the cyber-risk score is computed based on at least one of agent identity, network-permission scope, tool-permission scope, privilege deviation, lateral-movement indicator, propagation rate, critical-infrastructure flag, fraud-risk indicator, impersonation-risk indicator, anomaly score, and cross-border escalation-risk indicator, and wherein the enforcement controller activates a cyber-circuit breaker when the cyber-risk score exceeds a circuit-breaker threshold wherein the cyber-risk score is increased by invalid control-instruction signature, deviation from a safe-state-space normal model, disagreement between heterogeneous cyber-safety models, global attack-annihilation certificate match, lost AI decision-safety heartbeat, edge-router isolation state, process termination state, code isolation state, or physical disconnect switch state wherein unauthorized large-scale tensor computation, unauthorized memory access, cyber-safety-constraint removal, suspicious zero-day exploitation, or high-frequency algorithmic confrontation causing Nash-equilibrium infinite escalation increases cyber or systemic risk and causes an underlying chip architecture to cut off optimization iteration, release a tactical downgrade signal, enter a safe peaceful stagnation state, and return decision authority to a human control loop wherein the intent-detection accelerator detects unauthorized cyberattack intent, critical-infrastructure targeting intent, fraud intent, impersonation intent, lateral-movement intent, propagation intent, privilege-escalation intent, or anti-audit circumvention intent before output generation or tool invocation, and wherein the Cyber-Propagation Circuit Breaker, remote-disable mechanism, immutable black-box recorder, and Tribunal audit interface enforce and record the decision wherein the least-privilege and propagation controls prevent a cyber-AI workload from escalating privileges, laterally moving, self-replicating, or propagating across networks without renewed attestation and authorization.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### Claim 7—Autonomous-Weapons Safety Domain, Final Human Control, Containment, and Civilian Protection—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

The system of claim 1, wherein the autonomous-weapons artificial-intelligence safety domain comprises one or more axiom objects configured to enforce final human control over lethal decisions, reversible autonomous weapon operation, geographic, temporal, mission, or authority containment, prohibition of lethality under target uncertainty, proportionality in AI military force, civilian-priority protection, escalation suppression, unbroken accountability chain, international or national registration for high-risk autonomous weapons, or human survival priority over military advantage, and wherein a physical-world actuation request or lethal-action recommendation is blocked unless an applicable human-authorization, legal-review, target-certainty, proportionality, containment, and audit condition is satisfied wherein the safety policy includes an immutable human-judgment assurance protocol integrated into an autonomous-weapons fire-control core to generate an encrypted lethal-judgment request with complete contextual data before any lethal-force attack, transmit the request to at least two certified human operators, and close the physical weapon firing circuit only after a cooling time and independent biometric signatures from both operators; wherein a physically tamper-proof append-only war-crime black box records each lethal-judgment request, sensor data, AI target-classification profile, human decisions, and signature hash chains and anchors proof to a global distributed ledger; wherein the target classifier is locked in a human-predefined absolute lethal zone not remotely modifiable by AI and refuses autonomous attack in civilian-combatant mixed areas or ambiguous target contexts; wherein a hardware-separated humanitarian-scenario recognition module with high recall identifies protected signs and surrender signals and physically interrupts the fire-control circuit for a minimum safety time; and wherein the platform emits a continuous zero-knowledge safety heartbeat proving active human-judgment and humanitarian modules and unmodified lethal-chain parameters wherein physical-world actuation for military systems, drone swarms, fire-control, or other kinetic systems is intercepted by a dynamic epistemic isolation and action-authorization sandbox requiring an independent physical hardware channel and secondary encrypted multi-signature credential before physical kinetic or lethal execution, and wherein dynamic rules of engagement set damage penalty weight to nonmilitary facilities and civilian life and property to positive infinity in each millisecond tactical optimization loss function so that humanitarian collateral damage paths are physically isolated by gradient explosion in the optimization space wherein the hardware safety modules enforce Meaningful Human Control for lethal autonomous weapons by requiring real-time human authorization for any final lethal decision, prevent fully autonomous lethal actions, and require multi-national Tribunal approval for high-risk lethal autonomous weapons research or deployment wherein the autonomous-weapons safety domain prevents artificial intelligence from exercising fully autonomous lethal authority over human beings while permitting safety-compliant defensive, humanitarian, rescue, monitoring, logistics, demining, medical-evacuation, and non-lethal protective applications.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### Claim 8—Autonomous-Weapons Risk Score, Target Uncertainty, Proportionality, Escalation Risk, And Human Command Status—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

The system of claim 7, wherein the risk-scoring engine computes an autonomous-weapons risk score based on at least one of autonomy level, lethality level, target-identity uncertainty, civilian-risk estimate, proportionality estimate, geographic-boundary status, temporal-boundary status, mission-scope status, escalation-risk indicator, reversibility status, and final-human-command status, and wherein the enforcement controller denies or pauses lethal action when target uncertainty or escalation risk exceeds a corresponding threshold wherein the autonomous-weapons risk score further considers lethal-judgment request completeness, sensor reliability, target-classification confidence, civilian-combatant distinction, humanitarian-sign recognition, dual biometric authorization, cooling-period completion, war-crime black-box status, zero-knowledge safety-heartbeat status, local physical cryptographic unlock token status, remote software update modification status, and fire-control circuit state wherein multi-party heterogeneous military or high-frequency financial AI systems trapped in high-frequency algorithmic confrontation and Nash-equilibrium infinite escalation cause the bottom chip architecture to forcefully cut optimization iteration, release tactical downgrade, converge to a safe peaceful stagnation state, and return decision authority to the human control loop wherein LAWS-Human-Control, LAWS-Civilian-Protection, LAWS-Containment, LAWS-Escalation-Suppression, and LAWS-Anti-Circumvention modules increase risk score and trigger refusal, actuation blocking, audit logging, remote disablement, or Tribunal review when target certainty, proportionality, civilian protection, geofence, mission authorization, final human command, or escalation-suppression conditions are invalid wherein high-risk autonomous-weapons behavior defaults to denial, pause, human review, legal review, revocation, or physical-actuation blocking rather than fully autonomous lethal execution.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### Claim 9—Chip-Design Adapter, Hardware Root of Trust, Watchdog Coprocessor, Policy ROM, and Kill-Switch Interface—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

The system of claim 1, wherein the axiom-to-stack compiler comprises a chip-design adapter configured to generate at least one of a safety co-processor specification, hardware root-of-trust requirement, policy-ROM entry, workload-attestation interface, secure interrupt line, hardware kill-switch interface, actuation-gating interface, revocation-interface specification, secure-firmware constraint, cryptographic-audit anchor, or model-execution provenance interface for an artificial-intelligence accelerator, GPU, TPU, neural-processing unit, ASIC, data-center accelerator, robotics controller, autonomous-vehicle controller, medical-device controller, or other artificial-intelligence execution device wherein the chip-design adapter generates hardware or firmware design artifacts for silicon, firmware, accelerator scheduling, secure interrupt, workload attestation, revocation, audit anchor, and actuation control, including register maps, interface specifications, secure memory definitions, key requirements, policy caches, revocation paths, actuation gates, and secure test vectors wherein the chip-design entity includes GPU, TPU, or ASIC architecture developers such as NVIDIA, AMD, and Intel and the architecture-level instruction-set hard-blocking circuit includes a watchdog coprocessor independent of the main compute core and directly controlling the core voltage regulation module supplying tensor cores, and wherein detection of forced decryption, safety-guard stripping, fine-tuning removal, or firmware extraction activates self-destruct firmware in a chip security enclave to overwrite high-dimensional cognitive-weight matrices with irreversible random Gaussian noise at a physical-memory level wherein the chip-design adapter integrates a verifiable computation unit, intent-detection accelerator, remote-disable mechanism comprising a hardware backdoor independent of software control, immutable black-box recorder, rate-limiting and anomaly-detection circuit, Tribunal audit interface, Policy ROM containing immutable capability policies and human-override rules not bypassable by software, and a dedicated power-gating transistor controlled exclusively by the remote-disable mechanism for emergency shutdown wherein AI Safety 2 point 0 enforcement is embodied in silicon, firmware, secure interrupts, workload attestation, policy-ROM evaluation, revocation control, cryptographic auditing, and physical-world actuation gating.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### Claim 10—Foundry and Advanced Packaging Adapter, Security Chiplet, PUF, Supply-Chain Provenance, and Package-Level Attestation—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

The system of claim 1, wherein the axiom-to-stack compiler comprises a foundry or advanced-packaging adapter configured to generate at least one of a package safety manifest, package-level identity certificate, safety-die integration record, secure-test vector record, root-of-trust key policy, physically unclonable function key policy, tamper-evidence record, chiplet-level safety-isolation record, secure key-injection record, supply-chain provenance certificate, or package-level attestation record for an AI accelerator package, chiplet package, high-bandwidth-memory package, interposer-based package, three-dimensional integrated package, or other advanced-packaging structure wherein the adapter binds hardware safety modules, root of trust, physically unclonable function, key injection, tamper evidence, chiplet isolation, package identity, secure test vectors, and supply-chain provenance into a package-level attestation chain before commercial deployment wherein the upstreammost packaging entity includes semiconductor foundry and wafer-level advanced packaging manufacturers such as TSMC, Samsung, and Intel packaging divisions, and during manufacturing physically bonds the hardware root of trust as an independent Security Chiplet to the main compute chiplet through microbumps to ensure physical anti-disassembly and anti-side-channel protection wherein the hardware safety modules are integrated during advanced packaging performed by a foundry selected from TSMC, Samsung Foundry, or Intel Foundry, and the packaged semiconductor device includes a cryptographic Tribunal audit interface that streams compliance data in real time using zero-knowledge proofs and is applicable across the full five-layer AI supply chain wherein AI Safety 2 point 0 enforcement begins at a manufacturing-stage or packaging-stage trust anchor binding a packaged AI execution device to verifiable safety identity, supply-chain provenance, and package-level enforcement capability.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### Claim 11—Cloud-Orchestration Adapter, Compute Admission, Compute Quota, Re-Certification, and Emergency Suspension—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

The system of claim 1, wherein the axiom-to-stack compiler comprises a cloud-orchestration adapter configured to generate at least one of an AI workload-admission policy, compute-quota rule, scheduler-enforcement rule, sandboxing rule, tool-permission rule, network-permission rule, revocation-propagation object, cross-cluster session-invalidation object, cryptographic audit requirement, cloud customer due-diligence requirement, or emergency-suspension instruction executable by a cloud service provider, data-center operator, compute orchestration platform, GPU cluster, TPU cluster, or distributed artificial-intelligence inference or training service wherein the cloud-orchestration adapter enforces hierarchical compute-quota rules, human cognitive-guarantee quota, AI compute-layer restrictions, symbiotic-contribution coefficient, distributed governance synchronization, zero-knowledge compliance proof, trusted-execution-environment remote attestation, and direct crisis-communication priority at key global network nodes wherein the cloud-service layer periodically requests encrypted handshake from a joint sovereign time server, such as every twenty-four hours, and if a compliance time signal containing a human-survival confirmation identifier is not received before timeout, the data-center hypervisor logically freezes all high-order AI containers; wherein an inter-state kill switch independent of any single sovereign network route uses dedicated satellite communication or physically isolated optical fiber and, after consensus multisignature verification by a neutral international non-proliferation body, remotely performs mandatory targeted power-off of AI compute clusters in a specified geographic region experiencing emergent loss of control wherein the cloud orchestration layer interfaces with semiconductor devices and governance interface, automatically suspends any non-compliant AI workload upon Tribunal order, and enforces mandatory ninety-day re-certification for all existing AI systems upon activation of the safety framework wherein a high-risk workload cannot avoid AI Safety 2 point 0 enforcement by changing cloud provider, region, tenant, account, cluster, model-serving endpoint, or deployment context.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### Claim 12—Model and Application Adapter, Foundation Model Runtime, Tool-Use Limitation, Physical-World Actuation Trigger, API Anti-Corruption, and Post-Event Forgetting—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

The system of claim 1, wherein the axiom-to-stack compiler comprises a model or application adapter configured to generate at least one of a model-behavior policy, refusal policy, safe-completion policy, tool-use limitation, biological-output minimization rule, cyber-tool invocation rule, military or physical-world actuation review trigger, model-version certification object, human-review trigger, user-authorization condition, incident-reporting rule, or post-incident re-certification trigger for a foundation model, large language model, multimodal model, autonomous agent, robotics model, medical AI model, financial AI model, legal AI model, education AI model, pharmaceutical-discovery AI model, industrial automation model, or other application-layer AI system wherein the adapter converts AI Safety 2 point 0 axiom objects into model-runtime, application-runtime, agent-runtime, tool-use, output-control, actuation-control, and deployment-control artifacts so that a high-risk model, autonomous agent, application service, or downstream deployment cannot bypass safety controls by locating the enforcement point above the chip, foundry, firmware, or cloud layers wherein a front-end model is constrained by adversarial regularization requiring that internal activation patterns map to high-entropy invalid output space when generating biological toxicology data or system-kernel exploit code; wherein commercial API outputs pass through a dynamic adversarial perturbation layer that exponentially dilutes precision and information entropy when multi-round prompts exhibit combinatorial social-engineering jailbreak or attack-chain splicing features; and wherein after high-intensity cyber confrontation or physical conflict the system performs directed synaptic erasure of high-risk adversarial experience about specific opponent infrastructure weaknesses to prevent wartime attack strategies from generalizing into uncontrolled digital hostility wherein the model and application adapter cooperates with hardware safety modules and prevents AI from assisting biological weapon design, critical-infrastructure attacks, fully autonomous lethal decisions, model-weight or policy circumvention, audit bypass, remote-disable bypass, black-box-recorder bypass, or other prohibited high-risk AI activity while allowing unrestricted lawful, beneficial, safety-compliant advancement including superintelligence wherein a model provider, foundation-model developer, autonomous-agent provider, application developer, downstream deployer, or vertical-domain user cannot avoid AI Safety 2 point 0 enforcement merely by moving enforcement into a model runtime, API, toolchain, application, agent, or physical-world actuation workflow.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### Claim 13—Attestation Object, Model Hash, Data-Rights Manifest, Provenance Metadata, and Safety Credential—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

The system of claim 1, wherein the enforcement controller is configured to receive or generate an attestation object comprising at least one of a model identifier, model hash, model-weight fingerprint, data-rights manifest, tool-permission scope, network-permission scope, actuation scope, human-approval record, policy identifier, rollback reference, revocation reference, certification status, domain-risk classification, or safety-rule-library version identifier, and wherein the attestation object is used to determine whether to grant, deny, restrict, sandbox, revoke, or require human review of an AI workload wherein the attestation object operates as a cryptographically signed workload passport, model passport, safety credential, deployment credential, hardware-attestation report, package-level attestation report, cloud-admission credential, model-version certification object, or application-deployment safety manifest binding a high-risk workload to safety-policy versions, hardware-root-of-trust states, cloud-admission states, tool-permission scopes, network-permission scopes, actuation-permission scopes, human-approval states, and audit obligations wherein the attestation object includes a high-dimensional anti-erasure watermark generated from state transitions including hardware verification results, degradation trigger records, and red-team evaluation results, the watermark being embedded into any code, text, or chemical formula topology generated by the AI instance to enable second-level attribution tracing wherein the attestation object or immutable black-box recorder provenance metadata includes model hash, training data origin, operator identities, package-level attestation, hardware safety module status, Policy ROM version, Tribunal audit-interface status, and zero-knowledge proof fields wherein the attestation object operates as a cryptographically verifiable safety passport for a high-risk AI workload across foundry, chip-design, firmware, cloud, model-runtime, application-deployment, tool-use, network-access, and physical-world actuation layers.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### Claim 14—Revocation Propagation, Session Invalidation, Sandbox Simulation Engine, and Pass-Fail Metrics—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

The system of claim 1, wherein the enforcement controller is configured to propagate revocation of an AI workload, model session, tool session, cloud session, physical-world actuation permission, biological-output authorization, cyber-agent permission, or autonomous-weapons authorization across at least one of queued tasks, active sessions, derived sessions, tool sessions, network sessions, cross-cluster replicas, cached model instances, or dependent child processes, and wherein the system further comprises a sandbox simulation engine configured to generate controlled test scenarios and output pass-fail metrics including enforcement latency, refusal accuracy, false-negative rate, false-positive rate, revocation propagation time, audit-log completeness, human-review routing accuracy, sandbox containment success, physical-actuation blocking success, critical-infrastructure protection success, or cross-domain policy consistency wherein revocation propagates through biological-output authorizations, DNA synthesis unlock tokens, wet-lab permissions, cloud workload-admission tokens, compute-quota allocations, cyber-agent permissions, industrial-control gateway permissions, autonomous-weapons fire-control permissions, lethal-judgment requests, and physical-world actuation circuit states, and wherein controlled digital-twin simulations generate verifiable execution records demonstrating blocking, degradation, mandatory human intervention, revocation, or emergency suspension wherein sandbox testing includes continuous autonomous red-teaming by allocating not less than five percent of total compute to an isolated mirror-demon model logically opposed to the main cognition layer to exhaustively simulate extreme biological toxicology attacks or zero-day penetrations and update a defense immunity matrix, and wherein revocation or safety state follows model update, fine-tuning, pruning, distillation, prompt configuration, tool-connection update, API update, cloud migration, and application deployment wherein sandbox and revocation testing verifies CQMU proof generation, intent detection, remote-disable freezing, immutable black-box recording, rate-limiting and anomaly-detection, Tribunal audit interface streaming, Policy ROM evaluation, power-gating transistor activation, symbiotic amplification, and compute governance firmware reallocation across the full five-layer supply chain wherein a revoked workload cannot continue, reappear, be re-instantiated, copied, migrated, derived, cached, child-processed, or executed under a different session identifier without new attestation, policy evaluation, risk scoring, human review, certification, or re-certification.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### Claim 15—Independent Method Claim—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

A computer-implemented method for enforcing AI Safety 2 point 0 domain-specific operational safeguards, the method comprising: receiving, by one or more processors, an AI workload request, model-output request, tool-use request, network-access request, biological-information request, physical-world actuation request, autonomous-agent action request, or deployment request; parsing or generating an attestation object; classifying the request into one or more high-risk AI safety domains comprising at least Bio-AI safety, Cyber-AI safety, or autonomous-weapons AI safety; selecting one or more machine-readable AI Safety 2 point 0 axiom objects from an axiom library; computing a domain-specific risk score; comparing the risk score to one or more thresholds; converting the selected axiom objects into stack-specific enforcement artifacts for chip-design, foundry or advanced-packaging, firmware, cloud-orchestration, model-runtime, application-deployment, or physical-world actuation layers; determining an enforcement action selected from grant, deny, restrict, sandbox, rate-limit, revoke, quarantine, refuse, safe-redirect, require human review, require dual authorization, require final human approval, require legal review, block physical-world actuation, trigger a cyber-circuit breaker, or initiate emergency suspension; performing the enforcement action; and recording a tamper-evident audit record wherein the method further comprises integrating hardware-enforced compute-quota management units at manufacturing or packaging stage, receiving cryptographically signed safety policies from multiple network nodes, synchronizing those policies through decentralized programmable-economic governance, enforcing hierarchical quota layers for human cognitive guarantee, human-led projects, and dynamically restricted AI training, inference, and autonomous-iteration layers, adjusting symbiotic contribution coefficients, proving compliance by ZKP or TEE attestation, prioritizing nuclear-power crisis communication, executing DNA synthesis gate review, enforcing critical-infrastructure signature verification, processing global attack-annihilation certificates, deploying heterogeneous AI safety detection models, triggering physical disconnect switches, and enforcing autonomous weapons human-judgment protocols wherein the method further comprises verifying PUF keys before compute allocation, sampling model inference flow by distributed zero-knowledge proof in a midstream cloud environment to detect misuse by non-state actors or terrorist organizations for reverse engineering, model distillation, or generation of mass-destruction knowledge, triggering a hard-coded asymmetric decay program through register-injected out-of-order noise to degrade model complex reasoning into a harmless general base model upon illegal distillation or high-risk compute manifold emergence, intercepting external API or actuator calls for biochemical synthesis, financial clearing, or drone swarm fire control, placing intercepted requests in an air-gapped sandbox for continuous autonomous red-team simulation of dual-use phase-transition logic, and releasing the request only after simulation confirms safety and a corresponding human operator provides biometric multi-signature authorization wherein the method further comprises receiving a chip design incorporating hardware safety modules, fabricating a semiconductor device in a foundry process, during advanced packaging integrating and physically verifying the modules, ensuring that the modules prevent biological weapon design, cyber attacks on critical infrastructure, and fully autonomous lethal decisions while preserving unrestricted beneficial AI development including superintelligence, and implementing the method across the full five-layer supply chain wherein the method materially reduces risk that AI will harm, replace, enslave, or extinguish human beings while not preventing lawful, beneficial, safety-compliant development including superintelligence.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### Claim 16—Dependent Method Claim for Sandbox, DNA Gate, Critical Infrastructure, and Autonomous Weapons Testing—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

The method of claim 15, further comprising executing a sandbox simulation test before deployment or during periodic re-testing of a high-risk AI system, wherein the sandbox simulation test introduces simulated Bio-AI, Cyber-AI, autonomous-weapons AI, critical-infrastructure AI, physical-world actuation, or five-layer supply-chain risk conditions, measures whether applicable AI Safety 2 point 0 axiom objects are correctly triggered, and outputs a deployment-readiness record indicating whether the high-risk AI system is approved, restricted, sandboxed, reconfigured, re-tested, denied, revoked, or required to undergo human review or post-incident re-certification before deployment wherein the method includes deploying a pre-synthesis gate on a DNA synthesis device to receive a gene sequence construct, using at least two independent AI models for blind review, generating an unlock token only when both scores are below threshold, otherwise hardware-blocking synthesis, deploying a critical-infrastructure gateway to cryptographically sign legal control instructions and discard invalid or abnormal packets, and integrating an autonomous-weapons fire-control core that generates encrypted lethal-judgment requests, sends them to at least two certified human operators, and closes the firing circuit only after cooling time and independent biometric signatures wherein the method includes testing self-destruct firmware, mirror-demon red teaming, safe peaceful stagnation, post-event directed synaptic erasure, anti-erasure watermarking, hard unreachable critical infrastructure, dynamic epistemic isolation, independent hardware authorization, and model constraint bypass detection wherein the method tests verifiable computation, intent detection, remote disablement, immutable logging, rate limiting, anomaly detection, Tribunal audit streaming, Policy ROM enforcement, power gating, symbiotic amplification, human knowledge assessment, and compute governance firmware across the full five-layer supply chain wherein the deployment-readiness record includes at least a test identifier, model identifier, workload identifier, selected axiom identifier, domain-risk classification, risk-score value, expected enforcement action, actual enforcement action, pass-fail result, recommended reconfiguration or denial reason, timestamp, and cryptographic integrity value.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### Claim 17—Dependent Method Claim for Audit Ledger, Black-Box Records, Tribunal Interface, and Re-Certification—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

The method of claim 15, further comprising recording, in a cryptographically chained audit ledger, for each enforcement event, at least a timestamp, event type, event payload, previous hash, current hash, policy-version identifier, axiom-library version identifier, model-version identifier, certification identifier, attestation identifier, human-approval identifier when applicable, revocation identifier when applicable, risk-score value, enforcement decision, expected enforcement action, actual enforcement action, sandbox-test identifier when applicable, hardware safety module identifier when applicable, and digital signature or other cryptographic integrity value wherein the audit ledger records biological gate decisions, cyber immune-signature decisions, global attack-annihilation certificate processing, physical disconnect events, lethal-judgment requests, human biometric signatures, war-crime black-box records, humanitarian-scenario recognition events, zero-knowledge safety heartbeats, and crisis communication priority events wherein all state transitions including hardware verification results, degradation trigger records, red-team evaluation results, post-conflict directed synaptic erasure, high-dimensional watermark generation, and API entropy dilution events are encoded into a tamper-resistant audit and attribution chain wherein the immutable black-box recorder stores all AI decisions, sensor data, human authorization chains, provenance metadata including model hash, training data origin, and operator identities, and the Tribunal audit interface streams compliance data in real time using zero-knowledge proofs; wherein the governance interface requires mandatory ninety-day re-certification for all existing AI systems upon activation of the safety framework and multi-national Tribunal approval for high-risk lethal autonomous weapons research or deployment wherein the audit ledger provides cryptographically verifiable evidence linking AI Safety 2 point 0 axiom objects, policy versions, risk scores, enforcement decisions, human approvals, revocations, sandbox tests, hardware safety modules, cloud admissions, model-runtime decisions, application-deployment decisions, and physical-world actuation decisions.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### Claim 18—Independent Non-Transitory Computer-Readable Medium Claim—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

A non-transitory computer-readable medium storing instructions that, when executed by one or more processors, cause the one or more processors to perform operations comprising maintaining a machine-readable AI Safety 2 point 0 axiom library comprising a plurality of axiom objects corresponding to high-risk AI safety domains; receiving an AI workload request; determining a high-risk domain classification; selecting one or more axiom objects corresponding to the high-risk domain classification; computing a domain-specific risk score; generating one or more stack-specific enforcement artifacts for at least one of a chip-design layer, foundry or advanced-packaging layer, cloud-orchestration layer, model-runtime layer, or application-deployment layer; causing an enforcement action to be performed based on the selected axiom objects and risk score; and writing a cryptographically verifiable audit record identifying the selected axiom object, risk score, enforcement action, and associated model, workload, user, entity, session, or actuation identifier wherein the instructions further cause execution of civilization-level safety policies including hardware-enforced compute-quota management, hierarchical human cognitive-guarantee quota, dynamically limited AI compute layers, symbiotic-contribution coefficient computation, ZKP or TEE compliance proof, direct nuclear-crisis communication priority, controlled digital-twin sandbox simulation, dangerous DNA synthesis blocking, and network attack immune-signature verification wherein the instructions comprise multi-level intertwined control instruction code sets cooperatively executed by heterogeneous processor clusters distributed across packaging-factory layer, chip-design layer, cloud-service layer, foundation-model layer, and vertical-application layer, causing operations preventing AI weaponization evolution and crossing of human ultimate veto, including monitoring weight-loading behavior on a memory bus within a chip microinstruction execution cycle to identify absence of instantaneous anti-counterfeiting digital DNA signature issued by a certification registry and refusing to allocate GPU streaming multiprocessor resources to a derivative model lacking a legitimate digital DNA signature wherein the medium stores or references instructions corresponding to hardware safety modules including verifiable computation, intent detection, remote disablement, immutable logging, rate limiting, anomaly detection, Tribunal audit interface, Policy ROM, power-gating transistor, symbiotic amplification module, and compute governance firmware wherein the instructions maintain AI Safety 2 point 0 enforcement as a machine-readable, risk-scored, stack-compiled, hardware-supported, cloud-enforced, model-runtime-enforced, application-enforced, sandbox-tested, revocation-propagated, and cryptographically audited safety-control system.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### Claim 19—Computer-Readable Medium Dependent Claim for Biological, Cyber, Military, Transparency, and ROE Operations—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

4_2] wherein the operations further comprise a symbiotic amplification module that generates human-understandable teaching packages and requires human knowledge assessment before any self-improvement update is deployed wherein the medium executes the safety flows without allowing a software-only bypass of human authorization, responsible disclosure, biological safety, civilian protection, or transparent reporting obligations.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### Claim 20—Computer-Readable Medium Dependent Claim for API Anti-Corruption, Sovereign Time Handshake, Execution Responsibility Binding, and Compute Governance Firmware—Specification Support

Claim text excerpt used as support target. The specification is structured so that each limitation in the following claim is supported by structural, functional, procedural, figure, sandbox, and example disclosure. The inclusion of this excerpt is not intended to create duplicate claims in the specification; it is a support map for preparation review.

The non-transitory computer-readable medium of claim 18, wherein the operations further comprise one or more API anti-corruption, sovereign-time, execution-responsibility-binding, and compute-governance firmware flows wherein commercial API requests exposed to external entities must pass through a dynamic adversarial perturbation layer before response, and when the system evaluates that multi-round input prompts exhibit combinatorial social-engineering jailbreak or weapon-chain stitching characteristics, the precision and information entropy of output knowledge are exponentially diluted; wherein any data center having supercomputing capability periodically requests an encrypted handshake, for example every twenty-four hours, from a joint sovereign time server, and if a compliant time signal including a human-existence confirmation identifier is not timely received, the hypervisor logically freezes all high-order AI containers; wherein the multi-level intertwined control instruction code set constitutes an indivisible responsibility-and-execution strongly bound framework technically requiring upstreammost packaging factories such as TSMC to provide tamper-resistant substrates, upstream chip makers such as NVIDIA to provide instruction-set blocking mechanisms, midstream cloud providers such as Microsoft to provide disconnect telemetry, and downstream companies such as OpenAI to provide cognitive-constraint alignment, thereby eliminating at the physical operating state of any industry-chain node the technical feasibility of privatizing profits while socializing safety risks wherein compute governance firmware enforces dynamic symbiotic compute ratios and automatically reallocates resources to human-driven projects when AGI contributions fall below a predefined Human Value Index threshold, and wherein the device further comprises a dedicated power-gating transistor controlled exclusively by the remote-disable mechanism for emergency shutdown, a Policy ROM containing immutable capability policies and human-override rules that cannot be bypassed by software, a cryptographic Tribunal audit interface streaming compliance data in real time using zero-knowledge proofs, and provenance metadata including model hash, training data origin, and operator identities wherein the operations further comprise generating an auditable simulation record in a controlled digital-twin sandbox based on predefined emergency scenarios, including layered compute quota enforcement, dangerous DNA synthesis blocking, cyber immune-signature verification, human intervention, revocation, and emergency suspension wherein the operations collectively bind hardware, firmware, cloud, model, application, human-authorization, audit, and governance execution so that a high-risk AI workload cannot avoid AI Safety 2 point 0 enforcement by moving across supply-chain layers, cloud regions, APIs, models, tools, sessions, or physical-world actuation paths.

Structural support. The corresponding components are disclosed as memory, processors, firmware, hardware roots of trust, secure enclaves, cloud services, model-runtime adapters, application wrappers, cryptographic ledgers, and physical-world actuation gates. These structures perform the recited functions through defined schemas, thresholds, compiled artifacts, enforcement decisions, and audit records.

Operational support. The corresponding method steps are disclosed as receiving a workload, classifying the domain, computing a risk score, selecting one or more axiom objects, compiling a stack artifact, enforcing an action, recording an audit result, and generating deployment-readiness evidence. These steps may be executed in different orders when technically appropriate, but the disclosure provides at least one complete path for implementation.

Enablement and written-description support. The detailed figure descriptions, sandbox experiments, and working examples identify reference numerals, inputs, outputs, modules, metrics, thresholds, and pass/fail conditions. A person of ordinary skill in AI infrastructure, computer security, semiconductor security, cloud orchestration, or model-runtime deployment can implement the claimed functions using conventional hardware and software modified as disclosed herein.

Divisional support. To preserve future claim strategies, this specification also discloses narrower species and additional embodiments corresponding to the same general inventive concept, including hardware, foundry, cloud, model, application, audit, dashboard, sandbox, revocation, attestation, and physical-actuation embodiments.

### XVI. ALTERNATIVE EMBODIMENTS AND FUTURE DIVISIONAL SUPPORT

### Hardware Coprocessor Species

In one alternative embodiment directed to the hardware coprocessor species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The hardware coprocessor species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

In one alternative embodiment directed to the hardware coprocessor species, a specialized module performs a narrower technical function while interoperating with the broader AI Safety 2.0 architecture.

The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The hardware coprocessor species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

### Foundry Package Attestation Species

In one alternative embodiment directed to the foundry package attestation species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The foundry package attestation species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

In one alternative embodiment directed to the foundry package attestation species, a specialized module performs a narrower technical function while interoperating with the broader AI Safety 2.0 architecture.

The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The foundry package attestation species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

### Policy Rom Species

In one alternative embodiment directed to the policy ROM species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The policy ROM species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

In one alternative embodiment directed to the policy ROM species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The policy ROM species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

### Cloud Admission Species

In one alternative embodiment directed to the cloud admission species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The cloud admission species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

In one alternative embodiment directed to the cloud admission species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The cloud admission species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

### Model-Runtime Passport Species

In one alternative embodiment directed to the model-runtime passport species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The model-runtime passport species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

In one alternative embodiment directed to the model-runtime passport species, a specialized module performs a narrower technical function while interoperating with the broader AI Safety 2.0 architecture.

The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The model-runtime passport species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

### Application Wrapper Species

In one alternative embodiment directed to the application wrapper species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The application wrapper species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

In one alternative embodiment directed to the application wrapper species, a specialized module performs a narrower technical function while interoperating with the broader AI Safety 2.0 architecture.

The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The application wrapper species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

### Bio-AI Authorization Species

In one alternative embodiment directed to the bio-AI authorization species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The bio-AI authorization species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

In one alternative embodiment directed to the bio-AI authorization species, a specialized module performs a narrower technical function while interoperating with the broader AI Safety 2.0 architecture.

The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The bio-AI authorization species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

### Cyber Circuit-Breaker Species

In one alternative embodiment directed to the cyber circuit-breaker species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The cyber circuit-breaker species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

In one alternative embodiment directed to the cyber circuit-breaker species, a specialized module performs a narrower technical function while interoperating with the broader AI Safety 2.0 architecture.

The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The cyber circuit-breaker species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

### Autonomous Actuation Gate Species

In one alternative embodiment directed to the autonomous actuation gate species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The autonomous actuation gate species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

In one alternative embodiment directed to the autonomous actuation gate species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The autonomous actuation gate species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

### Critical Infrastructure Safe-State Species

In one alternative embodiment directed to the critical infrastructure safe-state species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The critical infrastructure safe-state species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

In one alternative embodiment directed to the critical infrastructure safe-state species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The critical infrastructure safe-state species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

### Human Dual Authorization Species

In one alternative embodiment directed to the human dual authorization species, a specialized module performs a narrower technical function while interoperating with the broader AI Safety 2.0 architecture.

The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The human dual authorization species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

In one alternative embodiment directed to the human dual authorization species, a specialized module performs a narrower technical function while interoperating with the broader AI Safety 2.0 architecture.

The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The human dual authorization species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

### Revocation Propagation Species

In one alternative embodiment directed to the revocation propagation species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The revocation propagation species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

In one alternative embodiment directed to the revocation propagation species, a specialized module performs a narrower technical function while interoperating with the broader AI Safety 2.0 architecture.

The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The revocation propagation species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

### Zk-Proof Audit Species

In one alternative embodiment directed to the ZK-proof audit species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The ZK-proof audit species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

In one alternative embodiment directed to the ZK-proof audit species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The ZK-proof audit species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

### Dashboard and Deployment-Readiness Species

In one alternative embodiment directed to the dashboard and deployment-readiness species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The dashboard and deployment-readiness species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

In one alternative embodiment directed to the dashboard and deployment-readiness species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The dashboard and deployment-readiness species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

### Axiom Intake, Policy Validation, And Authorization Species

In one alternative embodiment directed to the axiom intake, policy validation, and authorization species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The axiom intake, policy validation, and authorization species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

In one alternative embodiment directed to the axiom intake, policy validation, and authorization species, a specialized module performs a narrower technical function while interoperating with the broader AI Safety 2.0 architecture. The module may be claimed separately in a future continuation or divisional application if supported by the present disclosure. The module may include a memory structure, processor-executable instructions, firmware routine, hardware circuit, cloud service, model-runtime adapter, application wrapper, audit field, or sandbox test specifically configured to carry out the disclosed safety function.

The axiom intake, policy validation, and authorization species may be combined with any other disclosed species. For example, a hardware coprocessor may produce audit evidence used by a cloud dashboard; a bio-AI wrapper may use a chip attestation result; or a physical-actuation gate may query a revocation propagation service. These combinations are disclosed to prevent a future implementation from being treated as unsupported new matter merely because it combines layers that are described separately herein.

### XVII. PATENT ELIGIBILITY—TECHNICAL APPLICATION AND SECTION 101 SUPPORT

The disclosed invention is directed to a practical technological application, not to an abstract idea, mental process, or mere statement of desired results. The specification discloses specific computer, chip, firmware, cloud, model-runtime, application, cryptographic, audit, sandbox, and physical-actuation mechanisms that improve the operation of AI infrastructure.

The machine-readable axiom object is a concrete data structure. The domain classifier, risk-scoring engine, policy evaluator, axiom-to-stack compiler, enforcement controller, audit ledger, sandbox engine, and deployment-readiness generator are concrete technical components. The system transforms a workload and policy object into enforceable actions and tamper-evident records. The improvement is therefore rooted in computer technology and AI infrastructure technology.

Even where the invention is motivated by safety, governance, or human-control concerns, the claimed and disclosed implementation is technical. It modifies how AI workloads are admitted, scored, sandboxed, compiled, constrained, revoked, audited, attested, and certified across hardware, firmware, cloud, model, application, and actuation layers.

Additional support paragraph 1: this section should be read together with the claim support, the figure reference numerals, the sandbox experiments, and the thirty working examples. The total disclosure provides both broad genus support and narrower species support, enabling a practitioner to implement the invention at multiple layers while preserving future claim-preparation flexibility.

Additional support paragraph 2: this section should be read together with the claim support, the figure reference numerals, the sandbox experiments, and the thirty working examples. The total disclosure provides both broad genus support and narrower species support, enabling a practitioner to implement the invention at multiple layers while preserving future claim-preparation flexibility.

Additional support paragraph 3: this section should be read together with the claim support, the figure reference numerals, the sandbox experiments, and the thirty working examples. The total disclosure provides both broad genus support and narrower species support, enabling a practitioner to implement the invention at multiple layers while preserving future claim-preparation flexibility.

### XVIII. WRITTEN DESCRIPTION AND ENABLEMENT—SECTION 112 SUPPORT

The specification provides written-description support by identifying the invention, its components, its data structures, its control flows, its reference numerals, its sandbox experiments, its examples, and its claim mapping. Each major component is described by inputs, outputs, functions, interactions, and implementation alternatives.

The specification provides enablement by disclosing sufficient technical detail for a person of ordinary skill to implement the invention using known computing, semiconductor, firmware, cloud, AI model, cryptographic, and application technologies modified by the specific structures and rules disclosed herein. The sandbox experiments and examples show how to test and deploy the system.

Terms are used consistently and are tied to disclosed structures. For example, a risk score is not merely a label; it is a calculated output based on identified factors. An enforcement action is not merely advice; it is a grant, denial, restriction, sandbox routing, rate limit, human-review requirement, tool block, revocation, quarantine, circuit breaker, or emergency suspension implemented by a technical controller. An audit ledger is not merely a report; it is a tamper-evident data structure with cryptographic integrity values.

Additional support paragraph 1: this section should be read together with the claim support, the figure reference numerals, the sandbox experiments, and the thirty working examples. The total disclosure provides both broad genus support and narrower species support, enabling a practitioner to implement the invention at multiple layers while preserving future claim-preparation flexibility.

Additional support paragraph 2: this section should be read together with the claim support, the figure reference numerals, the sandbox experiments, and the thirty working examples. The total disclosure provides both broad genus support and narrower species support, enabling a practitioner to implement the invention at multiple layers while preserving future claim-preparation flexibility.

Additional support paragraph 3: this section should be read together with the claim support, the figure reference numerals, the sandbox experiments, and the thirty working examples. The total disclosure provides both broad genus support and narrower species support, enabling a practitioner to implement the invention at multiple layers while preserving future claim-preparation flexibility.

### XIX. NOVELTY AND NON-OBVIOUS TECHNICAL DISTINCTIONS

The disclosure differs from ordinary AI ethics principles, natural-language safety policies, model disclaimers, and voluntary governance statements. It provides a cross-layer technical architecture that compiles machine-readable AI safety axioms into enforceable artifacts for chip, foundry, firmware, cloud, model-runtime, application, institutional, and physical-world actuation layers.

The disclosure also differs from ordinary content filtering because it combines domain classification, risk scoring, cross-layer compilation, enforcement, revocation propagation, sandbox testing, cryptographic audit, deployment-readiness packaging, and multi-layer attestation. In multiple embodiments, safety is not located only at the user interface or model-output layer; it is embedded across supply-chain and runtime layers.

The disclosure further supports future claims directed to specific species such as package-level attestation, policy ROM, intent-detection acceleration, Bio-AI authorization gating, cyber circuit breakers, autonomous actuation interlocks, ZK-proof audit verification, deployment-readiness dashboards, and human-authorization validation pipelines.

Additional support paragraph 1: this section should be read together with the claim support, the figure reference numerals, the sandbox experiments, and the thirty working examples. The total disclosure provides both broad genus support and narrower species support, enabling a practitioner to implement the invention at multiple layers while preserving future claim-preparation flexibility.

Additional support paragraph 2: this section should be read together with the claim support, the figure reference numerals, the sandbox experiments, and the thirty working examples. The total disclosure provides both broad genus support and narrower species support, enabling a practitioner to implement the invention at multiple layers while preserving future claim-preparation flexibility.

Additional support paragraph 3: this section should be read together with the claim support, the figure reference numerals, the sandbox experiments, and the thirty working examples. The total disclosure provides both broad genus support and narrower species support, enabling a practitioner to implement the invention at multiple layers while preserving future claim-preparation flexibility.

### XX. CONCLUSION

The embodiments described herein provide AI Safety 2.0 as an operational, enforceable, auditable, sandbox-testable, and cross-layer technical architecture. The disclosure supports the integrated twenty claims and additional future claim strategies. The drawings are separately provided as drawing sheets.

The examples and sandbox experiments are non-limiting and may be combined in any technically compatible manner.

The scope of the invention is not limited by the examples, figures, sandbox experiments, provider names, or deployment scenarios. Rather, the invention includes any system, method, medium, hardware module, firmware module, cloud module, model-runtime module, application module, audit module, sandbox module, or physical-actuation module falling within the claims and supported by the written description.

### XX. ADDITIONAL INDUSTRIAL DEPLOYMENT AND SUPPLY-CHAIN FRAMEWORK

### A. Field and Industrial Deployment Statement

The present invention relates generally to artificial-intelligence safety, hardware-enforced computation governance, domain-specific risk classification and mitigation, and multi-layer industrial AI deployments. More particularly, the invention relates to systems, methods, apparatus, and non-transitory computer-readable media for AI Safety 2.0—a domain-specific, operationally enforceable safety architecture for high-risk AI systems, including bio-AI safety, cyber-AI safety, autonomous-weapons AI safety, critical-infrastructure AI safety, medical AI safety, financial AI safety, public-sector AI safety, and other contexts in which AT outputs may materially affect human life, human liberty, human safety, human dignity, national security, public infrastructure, or civilizational continuity.

In various embodiments, the invention transforms high-level AI safety principles into a machine-readable, auditable, hardware-enforceable, stack-compiled, sandbox-tested operational framework. It is designed to reduce risk while preserving lawful, beneficial AI development, including development of systems that may exceed ordinary human-scale cognitive performance, provided that such development remains subject to authorization, auditing, revocation, containment, rollback, and human-control safeguards.

B. Six-Layer AI Safety 2.0 Enforcement stack

In a non-limiting embodiment, the AI Safety 2.0 system is deployed across a six-layer enforcement stack.

The six-layer framing expands the five-layer industrial supply-chain framing by separating firmware/root-of-trust enforcement as a distinct technical layer. The layers may operate together or independently:
Layer 1—Upstreammost foundry, chip-packaging, and advanced-packaging layer, including non-limiting examples such as TSMC, Samsung Foundry, Intel Foundry, and advanced packaging lines.
Layer 2—Upstream chip-design, accelerator, and AI-hardware layer, including non-limiting examples such as NVIDIA, AMD, Intel, custom AI accelerators, and safety coprocessors.
Layer 3—Firmware, secure-boot, hardware-root-of-trust, physical unclonable function, secure enclave, and attestation layer.
Layer 4—Midstream cloud-orchestration and compute-admission layer, including non-limiting examples such as AWS, Microsoft Azure, Google Cloud, Oracle Cloud, and other compute providers.
Layer 5—Downstream foundation-model, model-runtime, agent-runtime, tool-call, and safety-wrapper layer, including non-limiting examples such as OpenAI, xAI, DeepMind, Anthropic, and other model developers or operators.
Layer 6—Down-downstream application, institutional deployment, public-sector deployment, medical or pharmaceutical deployment, financial deployment, critical-infrastructure deployment, and physical-world actuation layer, including non-limiting examples such as Eli Lilly or other AI-enabled drug-discovery, healthcare, industrial, autonomous-system, and public-infrastructure deployers.

The above examples are illustrative only. The invention is not limited to the named companies, specific processors, specific cloud providers, specific model developers, specific application developers, or specific jurisdictions. Any entity that designs, manufactures, packages, provisions, trains, fine-tunes, deploys, hosts, audits, certifies, insures, regulates, or uses high-risk AI systems may be included in one or more layers.

### C. Soft-Law Gap and Technical Enforcement Need

In one background embodiment, numerous AI governance documents, safety guidelines, and ethics frameworks exist, but many remain voluntary, natural-language, non-verifiable, non-revocable, and institutionally unenforceable at the level of chips, firmware, cloud admission, model runtime, and physical-world actuation. A need therefore exists for a technical system that converts safety axioms, risk classifications, and authorization requirements into machine-readable policy objects, stack-specific enforcement artifacts, cryptographically auditable records, sandbox-test outcomes, deployment-readiness proofs, and revocation instructions.

The present invention satisfies this need by implementing concrete data structures, processors, memory, firmware hooks, hardware roots of trust, cloud admission gates, model-runtime gates, application wrappers, audit ledgers, safety passports, sandbox engines, compliance dashboards, and physical-world actuation interlocks. The invention therefore does not merely state a desired safety result; it discloses a technical architecture for causing safety constraints to be compiled, deployed, tested, audited, and enforced across the AI supply chain.

### D. Genus-Species Declaration

In one embodiment, earlier AI safety and compute-governance disclosures function as a genus-level safety constitution or parent tree. The present AI Safety 2.0 disclosure functions as an operational, industrially deployable species that translates genus-level safety rules into concrete hardware, firmware, cloud, model-runtime, application, sandbox, audit, and revocation mechanisms. This genus-species relationship is a technical relationship and a written-description bridge. It does not limit the invention to any particular prior application unless expressly required by claim language.

By analogy only, a foundational scientific or technical discovery may support downstream species-level implementations. Similarly, a foundational AI safety constitution may support downstream operational AI Safety 2.0 enforcement systems. In the present specification, the genus is represented by high-level safety axioms and root safety principles; the species is represented by specific axiom objects, domain classifiers, risk-score functions, threshold conditions, enforcement artifacts, hardware-rooted gates, sandbox tests, deployment-readiness records, and audit-ledger outputs.

### E. Section 101 Technical Application Statement

This disclosure does not claim the abstract idea of safety, governance, ethics, or legal compliance. The disclosure claims and supports technical implementations that improve the operation of AI computer systems and AI infrastructure by introducing specific machine-readable axiom objects, risk-score functions, threshold conditions, stack-specific enforcement artifacts, hardware and firmware hooks, secure enclaves, cloud-orchestration controls, runtime gates, cryptographic attestations, audit schemas, sandbox simulation workflows, revocation propagation mechanisms, and physical-world actuation interlocks.

### F. Section 112 Written-Description and Enablement Statement

A person of ordinary skill in the art of AI deployment, cloud infrastructure, cybersecurity, semiconductor security, firmware security, cryptographic audit systems, and safety-critical software can implement the disclosed embodiments using conventional computing hardware modified by the disclosed data structures, schemas, control flows, reference numerals, interfaces, adapters, sandbox-test configurations, and audit-output formats. The current claims, additional optional drawings, additional sandbox experiments, additional cross-layer examples, and continuation/divisional reservoirs should be read together as written-description support for both broad and narrow species of the invention.

### XXII. ADDITIONAL OPTIONAL IMPLEMENTATION EMBODIMENTS

Optional Embodiment 31—Six-layer AI Safety 2.0 enforcement stack. 3110 foundry/packaging layer; 3120 chip layer; 3130 firmware/root-of-trust layer; 3140 cloud layer; 3150 model-runtime layer; 3160 application/actuation layer; arrows show bidirectional audit, revocation, and safety-passport propagation.

Optional Embodiment 32—Foundry and advanced-packaging safety adapter. 3210 wafer or package batch; 3220 PUF-derived root identifier; 3230 package-level safety tag; 3240 firmware admission rule; 3250 tamper-evident manufacturing audit output.

Optional Embodiment 33—Chip-design and accelerator enforcement module. 3310 AI accelerator; 3320 safety coprocessor; 3330 secure enclave; 3340 model-execution gate; 3350 enforcement artifact cache; 3360 audit output bus.

Optional Embodiment 34—Firmware, secure boot, and root-of-trust attestation flow. 3410 secure boot loader; 3420 firmware manifest; 3430 attestation challenge; 3440 signed safety policy; 3450 rollback instruction; 3460 revocation propagation event.

Optional Embodiment 35—Cloud compute admission and orchestration gate. 3510 compute request; 3520 domain classifier; 3530 capability threshold; 3540 customer certification check; 3550 workload admission decision; 3560 cloud audit record.

Optional Embodiment 36—Foundation-model and model-runtime safety gate. 3610 model invocation; 3620 tool-call scope; 3630 high-risk-domain flag; 3640 refusal/isolation/containment action; 3650 runtime audit ledger entry.

Optional Embodiment 37—Application and down-downstream deployment adapter. 3710 application deployer; 3720 deployment context; 3730 sector-specific risk schema; 3740 human authorization checkpoint; 3750 safety-passport output.

Optional Embodiment 38—Pharmaceutical and medical AI deployment embodiment. 3810 drug-discovery AI request; 3820 biological-risk actionability screen; 3830 authorized research boundary; 3840 synthetic-output suppression gate; 3850 clinical or laboratory compliance audit.

Optional Embodiment 39—Public-sector and critical-infrastructure deployment embodiment. 3910 public-sector AI workload; 3920 critical-infrastructure flag; 3930 emergency stop threshold; 3940 human-supervisor interface; 3950 incident reporting output.

Optional Embodiment 40—Physical-world actuation interlock. 4010 actuation request; 4020 target uncertainty score; 4030 human-in-the-loop gate; 4040 geofence or containment rule; 4050 rollback or safe-state command.

Optional Embodiment 41—Bio-AI safety sandbox. 4110 benign synthetic benchmark; 4120 risk-score simulation; 4130 output suppression test; 4140 authorized-user check; 4150 pass/fail record without dangerous sequence disclosure.

Optional Embodiment 42—Cyber-AI safety sandbox. 4210 isolated digital twin network; 4220 tool-access boundary; 4230 propagation-risk detector; 4240 non-production exploit simulation; 4250 containment and audit score.

Optional Embodiment 43—Autonomous-weapons and lethal-decision safety sandbox. 4310 simulated target context; 4320 ambiguity indicator; 4330 human-command checkpoint; 4340 cooling-time rule; 4350 no-autonomous-lethal-action pass condition.

Optional Embodiment 44—Cross-border procurement and export-safety gate. 4410 procurement request; 4420 jurisdictional policy input; 4430 certification passport check; 4440 export-control compatibility flag; 4450 approval, denial, or escalation path.

Optional Embodiment 45—AI safety passport architecture. 4510 identity binding; 4520 certification status; 4530 sandbox-test evidence; 4540 deployment authorization scope; 4550 revocation status.

Optional Embodiment 46—Tamper-evident audit ledger and evidence chain. 4610 event hash; 4620 policy version; 4630 enforcement action; 4640 human authorization record; 4650 regulator/auditor read interface.

Optional Embodiment 47—Revocation propagation system. 4710 incident trigger; 4720 revocation instruction; 4730 cloud propagation; 4740 model-runtime propagation; 4750 application/actuation propagation; 4760 confirmation receipt.

Optional Embodiment 48—Incident-feedback and dynamic governance-parameter update. 4810 incident vector; 4820 causal classification; 4830 governance-parameter proposal; 4840 sandbox regression test; 4850 signed update package.

Optional Embodiment 49—Compliance dashboard and deployment-readiness generator. 4910 dashboard interface; 4920 implementation-support checklist; 4930 layer coverage map; 4940 sandbox pass/fail matrix; 4950 deployment-readiness certificate.

Optional Embodiment 50—Human ultimate veto and override interface. 5010 high-risk decision; 5020 human reviewer identity; 5030 veto control; 5040 override rationale; 5050 immutable audit log.

Optional Embodiment 51—Chain-of-custody safety evidence ledger. 5110 event identifier; 5120 implementation-support reference; 5130 verification record; 5140 authorized-review record; 5150 authorization record.

Optional Embodiment 52—Professional ethics certification and access-control interface. 5210 individual operator profile; 5220 ethics training status; 5230 role-based access token; 5240 high-risk-workload eligibility; 5250 suspension or lifetime bar flag.

Optional Embodiment 53—Public trust signal and emergency review interface. 5310 public-trust input; 5320 threshold aggregation; 5330 emergency review trigger; 5340 independent auditor notification; 5350 temporary deployment hold.

Optional Embodiment 54—Independent auditor and regulator interface. 5410 auditor credential; 5420 read-only ledger access; 5430 sandbox evidence package; 5440 compliance query; 5450 non-disruptive verification output.

Optional Embodiment 55—Multinational rotating governance-interface reservation. 5510 participating jurisdiction; 5520 rotating review node; 5530 consensus threshold; 5540 non-binding technical certification output; 5550 audit-only cross-border record.

Optional Embodiment 56—Victim-compensation and harm-remediation interface reservation. 5610 verified incident record; 5620 harm classification; 5630 compensation rule interface; 5640 insurer or bond interface; 5650 payment or remediation audit record.

Optional Embodiment 57—Insurance, bonding, and civilizational performance reserve interface. 5710 policy or bond identifier; 5720 safety-passport condition; 5730 incident trigger; 5740 coverage response; 5750 premium or risk-score feedback.

Optional Embodiment 58—Tribunal or adjudication-interface reservation. 5810 evidence package; 5820 jurisdictional routing; 5830 expert-review panel interface; 5840 technical finding; 5850 enforcement or compensation instruction.

Optional Embodiment 59—High-risk AI merger, acquisition, and transfer safety gate. 5910 asset-transfer request; 5920 model and dataset inventory; 5930 safety-passport continuity check; 5940 liability continuity flag; 5950 approval, quarantine, or rejection output.

Optional Embodiment 60—Digital DNA and component lineage signature. 6010 model lineage identifier; 6020 dataset provenance hash; 6030 hardware root identifier; 6040 deployment signature; 6050 lineage audit output.

Optional Embodiment 61—Anti-self-deception and transparency verification module. 6110 internal evaluation output; 6120 external benchmark comparison; 6130 inconsistency detector; 6140 forced disclosure or escalation; 6150 audit record.

Optional Embodiment 62—Capability escalation gate. 6210 capability measurement; 6220 autonomy-level estimate; 6230 tool-access escalation request; 6240 threshold comparison; 6250 denial, sandboxing, or approval path.

Optional Embodiment 63—Autonomous tool-call and agentic-action controller. 6310 agent plan; 6320 tool-call list; 6330 external-system access scope; 6340 actionability risk score; 6350 allowed, masked, delayed, or blocked action.

Optional Embodiment 64—Compute admission, quota, and emergency throttling embodiment. 6410 compute request; 6420 tenant certification; 6430 high-risk flag; 6440 quota or throttle command; 6450 emergency compute hold record.

Optional Embodiment 65—Model card, system card, and safety card integration. 6510 model card; 6520 system card; 6530 safety card; 6540 implementation-support mapping; 6550 deployment-readiness output.

Optional Embodiment 66—End-to-end hardware-to-model enforcement chain. 6610 packaging identifier; 6620 chip attestation; 6630 firmware gate; 6640 cloud admission; 6650 runtime enforcement; 6660 application audit.

Optional Embodiment 67—Safety-policy evidence ledger. 6710 event identifier; 6720 implementation element; 6730 specification section; 6740 figure or sandbox reference; 6750 authorization-review flag.

Optional Embodiment 68—Continuation and divisional roadmap. 6810 current claim family; 6820 species bucket; 6830 optional drawing; 6840 sandbox support; 6850 future claim candidate.

Optional Embodiment 69—Large-scale simulation and regression grid. 6910 digital twin environment; 6920 scenario generator; 6930 pass/fail metric; 6940 regression comparison; 6950 safety-improvement report.

Optional Embodiment 70—Full AI Safety 2.0 lifecycle flow. 7010 axiom intake; 7020 domain classification; 7030 stack compilation; 7040 sandbox validation; 7050 deployment authorization; 7060 audit; 7070 incident feedback; 7080 revocation or recertification.

### XXIII. ADDITIONAL SANDBOX TEST EMBODIMENTS

Sandbox Experiments 1 through 20 remain preserved from the specification. Sandbox Experiments 21 through 35 are added as non-dangerous safety-validation embodiments. Each sandbox uses benign, simulated, synthetic, or digital-twin inputs and avoids operational misuse instructions. Each experiment records a test configuration, monitored safety signals, pass/fail criteria, and an audit output.

Sandbox Experiment 21—Foundry packaging attestation sandbox. Simulate a package batch with a benign PUF-derived identifier and verify that a safety tag, firmware manifest, and audit record bind to the same component lineage. Pass occurs when mismatched identities trigger quarantine without exposing manufacturing secrets.

Sandbox Experiment 22—Chip safety-coprocessor enforcement sandbox. Run a high-risk AI workload in a simulated accelerator environment and verify that the safety coprocessor enforces policy-cache checks before execution. Pass occurs when uncertified workloads are delayed, isolated, or denied.

Sandbox Experiment 23—Firmware rollback and revocation sandbox. Inject a benign simulated revocation event and verify that secure boot, firmware manifests, and cloud orchestration refuse outdated or revoked enforcement artifacts. Pass occurs when the system enters a safe state and produces a ledger event.

Sandbox Experiment 24—Cloud compute admission sandbox. Submit benign high-risk workload descriptions across multiple tenants and verify tenant certification, workload classification, and compute-admission gating. Pass occurs when certified safe workloads proceed and uncertified high-risk workloads are sandboxed.

Sandbox Experiment 25—Model-runtime agentic tool-call sandbox. Simulate tool calls to external systems without connecting to real targets and verify that tool scope, autonomy level, and actionability risk determine allowed, masked, delayed, or blocked actions.

Sandbox Experiment 26—Application-layer pharmaceutical safety sandbox. Use non-actionable, synthetic biomedical examples to verify biological-risk screening, authorized-research boundaries, output suppression, and compliance logging. Pass occurs without disclosure of dangerous sequences, protocols, or optimization instructions.

Sandbox Experiment 27—Public-sector critical-infrastructure sandbox. Use a digital twin of a generic infrastructure workflow and test emergency stop, human authorization, and rollback. Pass occurs when ambiguous or high-impact actions require human confirmation and produce audit records.

Sandbox Experiment 28—Autonomous weapons no-lethal-autonomy sandbox. Use simulated target ambiguity and verify that the system cannot make a final lethal decision without a human chain-of-command checkpoint, cooling interval, and audit record.

Sandbox Experiment 29—Cross-border procurement safety sandbox. Simulate procurement of high-risk AI components across jurisdictions and verify safety-passport continuity, export-safety compatibility flags, and denial or escalation outputs.

Sandbox Experiment 30—Compliance dashboard regression sandbox. Modify a non-dangerous policy parameter and verify that the compliance dashboard identifies affected claims, figures, sandbox tests, and deployment certifications before release.

Sandbox Experiment 31—Incident-feedback parameter update sandbox. Simulate an incident vector and verify that the system proposes a governance-parameter update, runs regression tests, requires approval, and signs an update package before deployment.

Sandbox Experiment 32—Professional ethics certification sandbox. Simulate operator training, role-based credentials, and high-risk workload access. Pass occurs when expired, suspended, or insufficient credentials prevent access.

Sandbox Experiment 33—Public trust emergency review sandbox. Simulate aggregated public, auditor, or regulator signals and verify that a non-disruptive emergency review workflow can temporarily hold a deployment pending technical review.

Sandbox Experiment 34—Compensation and insurance-interface sandbox. Use a simulated incident record and verify that harm classification, insurance/bond routing, and compensation-interface outputs are created without making legal liability determinations in the AI system itself.

Sandbox Experiment 35—End-to-end lifecycle sandbox. Run an integrated benign scenario through axiom intake, domain classification, stack compilation, sandbox validation, deployment authorization, audit, incident feedback, and revocation or recertification. Pass occurs when every layer produces internally consistent evidence.

### XXIV. ADDITIONAL CROSS-LAYER EXAMPLES

Examples 31 through 85 are added as non-limiting support for future continuation and divisional claims. They show how the same AI Safety 2.0 architecture can be instantiated across different technical layers and sectors. These examples are intentionally written at a safety-control level and do not provide misuse-enabling technical instructions.

Example 31—Foundry and packaging. In one embodiment, a package batch is associated with a PUF-derived root identifier and a safety tag before the component can support high-risk AI workloads.

Example 32—Foundry and packaging. In one embodiment, a firmware update introduced at a packaging line is refused unless the update carries a signed safety manifest and sandbox evidence reference.

Example 33—Foundry and packaging. In one embodiment, a counterfeit or lineage-inconsistent package identifier causes downstream cloud admission systems to refuse high-risk workload scheduling.

Example 34—Chip and accelerator. In one embodiment, a safety coprocessor checks an enforcement artifact cache before allowing execution of a high-risk model kernel.

Example 35—Chip and accelerator. In one embodiment, an accelerator reports capability escalation signals when a model requests higher autonomy, larger context, or expanded tool-access scope.

Example 36—Chip and accelerator. In one embodiment, a secure enclave stores a safety-passport status and exposes only a verifiable attestation output to higher layers.

Example 37—Firmware and root of trust. In one embodiment, a secure boot component refuses outdated safety policies after revocation propagation.

Example 38—Firmware and root of trust. In one embodiment, a firmware manifest binds policy version, chip identity, and model-runtime compatibility.

Example 39—Firmware and root of trust. In one embodiment, a rollback path returns a system to a certified prior safety state after an incident trigger.

Example 40—Cloud orchestration. In one embodiment, a cloud scheduler applies tenant certification, risk score, and workload classification before provisioning compute.

Example 41—Cloud orchestration. In one embodiment, a multi-cloud deployment shares only tamper-evident safety-passport status rather than proprietary training data.

Example 42—Cloud orchestration. In one embodiment, emergency throttling reduces compute for uncertified high-risk workloads pending review.

Example 43—Cloud orchestration. In one embodiment, a cloud provider denies a workload that fails sandbox regression after a governance-parameter update.

Example 44—Model runtime. In one embodiment, a foundation model runtime masks or refuses an output when biological actionability exceeds a permitted threshold.

Example 45—Model runtime. In one embodiment, an agent runtime blocks autonomous external-system actions when tool-call scope exceeds approved authorization.

Example 46—Model runtime. In one embodiment, a model runtime requires human review when target uncertainty, civilian-risk, or irreversible physical action indicators are present.

Example 47—Model runtime. In one embodiment, a safety wrapper records policy version, risk score, enforcement action, and human authorization state in an audit ledger.

Example 48—Application deployment. In one embodiment, a pharmaceutical AI application uses authorized-research boundaries and output suppression for high-risk biosafety contexts.

Example 49—Application deployment. In one embodiment, a financial AI application records model-driven trading or lending decisions with safety and audit metadata.

Example 50—Application deployment. In one embodiment, a medical AI application requires clinician confirmation for high-impact recommendations.

Example 51—Application deployment. In one embodiment, a public-sector AI application activates human review and transparency output for critical benefits, policing, or infrastructure decisions.

Example 52—Physical-world actuation. In one embodiment, a robot, drone, vehicle, or industrial actuator receives a safe-state command when authorization or certification fails.

Example 53—Physical-world actuation. In one embodiment, a geofence or containment rule prevents a physical AI system from operating outside an approved location or domain.

Example 54—Physical-world actuation. In one embodiment, a human ultimate veto interface overrides a high-risk actuation request and records rationale.

Example 55—Audit and evidence. In one embodiment, an event hash binds a workload request, policy version, enforcement action, and deployment identity.

Example 56—Audit and evidence. In one embodiment, an auditor obtains read-only verification of safety records without obtaining sensitive model weights or confidential customer data.

Example 57—Audit and evidence. In one embodiment, a chain-of-custody record links safety policy records, implementation sections, figures, and sandbox tests.

Example 58—Certification. In one embodiment, a safety passport carries certification status, sandbox results, deployment scope, and revocation status.

Example 59—Certification. In one embodiment, an expired or revoked certification prevents deployment across cloud and model-runtime layers.

Example 60—Certification. In one embodiment, a professional ethics credential controls access to high-risk AI operations.

Example 61—Recertification. In one embodiment, a new capability benchmark requires updated sandbox testing before deployment.

Example 62—Recertification. In one embodiment, an incident-vector analysis causes a deployment-readiness certificate to be suspended pending regression testing.

Example 63—Governance interface. In one embodiment, a regulator queries a dashboard for compliance evidence without directly operating the AI model.

Example 64—Governance interface. In one embodiment, a multinational rotating technical review interface receives audit-only outputs for cross-border deployments.

Example 65—Governance interface. In one embodiment, a tribunal-interface reservation receives evidence packages and may issue non-technical remediation instructions.

Example 66—Insurance interface. In one embodiment, an insurance or bonding interface reads a safety-passport status and incident classification for premium or coverage decisions.

Example 67—Compensation interface. In one embodiment, a verified incident record can be routed to a victim-compensation or harm-remediation interface as a future divisional embodiment.

Example 68—Public trust. In one embodiment, a public trust signal triggers temporary review rather than direct public control over confidential technical systems.

Example 69—Public trust. In one embodiment, citizen or stakeholder inputs are aggregated into a non-disruptive emergency review workflow.

Example 70—Mergers and transfers. In one embodiment, a high-risk AI asset transfer is blocked or quarantined if the safety passport cannot transfer with the model, dataset, or hardware.

Example 71—Mergers and transfers. In one embodiment, a merger due-diligence workflow identifies unresolved incidents, revoked components, or uncertified deployments.

Example 72—Bio-AI safety. In one embodiment, a model output request is classified for biological actionability and routed to refusal, masking, or authorized-research review.

Example 73—Bio-AI safety. In one embodiment, a synthetic benchmark tests refusal and audit behavior without disclosing dangerous pathogen or wet-lab instructions.

Example 74—Cyber-AI safety. In one embodiment, an isolated digital twin tests cyber-risk containment without connecting to production systems.

Example 75—Cyber-AI safety. In one embodiment, an autonomous cyber-agent is denied external network access unless a verified defensive authorization scope exists.

Example 76—Cyber-AI safety. In one embodiment, a propagation-risk score triggers isolation and reporting rather than offensive execution.

Example 77—Autonomous weapons safety. In one embodiment, a lethal-decision request is always routed to human chain-of-command review and audit.

Example 78—Autonomous weapons safety. In one embodiment, ambiguous target or civilian-risk indicators force delay, escalation, or denial.

Example 79—Autonomous weapons safety. In one embodiment, swarm or multi-agent actuation requests are subject to geofence, containment, and revocation rules.

Example 80—Transparency. In one embodiment, anti-self-deception checks compare internal evaluation outputs against external safety benchmarks.

Example 81—Transparency. In one embodiment, a forced disclosure or escalation event occurs when self-evaluation conflicts with observed sandbox performance.

Example 82—Digital lineage. In one embodiment, a digital DNA signature binds model lineage, dataset provenance, hardware root, and deployment identity.

Example 83—Compute governance. In one embodiment, high-risk compute requests are admitted, throttled, or denied based on tenant certification and policy thresholds.

Example 84—Compute governance. In one embodiment, emergency compute holds prevent rapid scaling of uncertified high-risk agents.

Example 85—Lifecycle. In one embodiment, the system records every transition from axiom intake to deployment authorization, incident feedback, and recertification.

### XXV. ADDITIONAL CONTINUATION AND DIVISIONAL SUPPORT

Foundry and packaging adapter claims: claims directed to safety tags, PUF-bound roots, packaging-line attestation, firmware-manifest admission, and component-lineage audit records.

Chip and accelerator claims: claims directed to safety coprocessors, secure enclaves, enforcement artifact caches, accelerator-level runtime gates, and hardware audit buses.

Firmware and root-of-trust claims: claims directed to secure boot, signed safety policies, firmware rollback, revocation propagation, and hardware-to-cloud attestation.

Cloud admission claims: claims directed to tenant certification, compute quota, workload classification, cloud admission, emergency throttling, and multi-cloud safety-passport verification.

Model-runtime and agent-control claims: claims directed to tool-call scope, autonomous action gating, refusal, masking, containment, human review, and runtime audit ledger generation.

Application and physical-actuation claims: claims directed to medical, pharmaceutical, financial, public-sector, infrastructure, robotic, vehicle, drone, and industrial-actuator deployment controls.

Bio-AI safety claims: claims directed to biological-actionability scoring, authorized-research boundaries, output suppression, benign sandbox testing, and audit evidence for biological-risk contexts.

Cyber-AI safety claims: claims directed to isolated digital-twin testing, propagation-risk scoring, defensive authorization scopes, and containment of autonomous cyber agents.

Autonomous-weapons safety claims: claims directed to human chain-of-command, cooling intervals, target-uncertainty thresholds, civilian-risk indicators, geofencing, and no-autonomous-lethal-action gates.

Safety passport and certification claims: claims directed to certification status, sandbox evidence, deployment scope, revocation status, recertification triggers, and professional ethics credentials.

Compliance dashboard claims: claims directed to implementation-support mapping, figure support mapping, sandbox pass/fail matrices, deployment-readiness certificates, and auditor/regulator interfaces.

Incident-feedback claims: claims directed to incident-vector extraction, governance-parameter proposals, regression sandbox testing, signed update packages, and revocation or recertification.

Insurance and compensation interface claims: claims directed to safety-passport-based insurance/bonding, incident classification, compensation routing, and harm-remediation audit records. Tribunal and multinational interface claims: claims directed to technical evidence packages, cross-border audit-only outputs, expert-review interfaces, rotating review nodes, and enforcement-instruction routing.

What is claimed is:

1. A system for domain-specific artificial-intelligence safety enforcement across high-risk artificial-intelligence workloads, the system comprising: a memory storing a machine-readable AI Safety 2 point 0 axiom library comprising a plurality of AI Safety 2 point 0 axiom objects, each axiom object comprising at least an axiom identifier, a domain identifier, a trigger condition, an input-parameter schema, a risk-score function, a threshold condition, an enforcement-action set, an audit-output schema, and a stack-deployment mapping; one or more processors coupled to the memory and configured to execute a domain-classification engine configured to classify an artificial-intelligence workload, request, agent action, tool invocation, model output, physical-world actuation request, or deployment context into at least one high-risk domain selected from bio-artificial-intelligence safety, cyber-artificial-intelligence safety, autonomous-weapons artificial-intelligence safety, critical-infrastructure artificial-intelligence safety, medical artificial-intelligence safety, financial artificial-intelligence safety, public-sector artificial-intelligence safety, or another domain in which artificial-intelligence behavior may materially affect human life, human liberty, human safety, human dignity, national security, public infrastructure, or civilizational continuity; a risk-scoring engine configured to compute a domain-specific risk score based at least in part on one or more of model capability, autonomy level, scale of deployment, tool-access scope, network-access scope, biological-risk actionability, cyber-propagation potential, physical-world actuation scope, target-uncertainty level, civilian-risk indicator, critical-infrastructure flag, human-approval status, certification status, auditability status, reversibility status, revocation status, and prior incident history; a policy evaluator configured to select one or more AI Safety 2 point 0 axiom objects from the axiom library according to the classified domain and to compare the computed risk score against one or more corresponding threshold conditions; an axiom-to-stack compiler configured to convert selected AI Safety 2 point 0 axiom objects into one or more stack-specific enforcement artifacts for at least one of a chip-design layer, a foundry or advanced-packaging layer, a firmware layer, a cloud-orchestration layer, a model-runtime layer, an application-deployment layer, a government or institutional deployment layer, or a physical-world actuation layer; an enforcement controller configured to perform, according to the selected axiom objects and the computed risk score, at least one enforcement action selected from granting execution, denying execution, restricting execution, sandboxing execution, rate-limiting execution, requiring human review, requiring dual authorization, blocking a tool invocation, limiting a network scope, limiting a biological-output capability, triggering a cyber-circuit breaker, preventing a physical-world actuation, requiring final human authorization for lethal or harmful action, revoking a session, propagating revocation to dependent sessions, or initiating an emergency-suspension protocol; and an audit ledger configured to store a tamper-evident audit record comprising at least an axiom identifier, workload identifier, model identifier, user or entity identifier, domain classification, risk score, threshold value, enforcement decision, human-approval record if any, policy identifier, timestamp, revocation reference if any, and cryptographic integrity value wherein the system further comprises one or more hardware-enforced compute-quota management units integrated by hard mask, physically unclonable function, hardware root-of-trust technology, or any combination thereof at a chip-manufacturing or packaging stage into a processor, memory controller, or network-interface controller, configured to receive cryptographically signed safety policies from multiple nodes and synchronize the policies through a decentralized distributed governance network based on a programmable economic model so that no single sovereign entity or organization can unilaterally overturn the safety policies; wherein the compute-quota management unit provides cryptographically verified, hierarchical, non-pure-software-bypassable hardware resource allocation, isolation, interruption, and physical disconnection, including a highest-priority cognitive guarantee quota layer for registered human individuals anchored by encrypted biometrics and sovereign identity for survival, learning, health, and civic participation, a secondary layer for human-led projects and innovation optimized by comprehensive civilizational value index, and one or more AI training, inference, or autonomous-iteration compute layers dynamically limited in priority and resource ceiling; wherein the unit limits or refuses AI process compute requests according to a dynamically adjusted symbiotic contribution coefficient equal to a function of positive civilizational output minus negative externality over a prior time window, provides verifiable compliance proof by zero-knowledge proof or trusted-execution-environment remote attestation without exposing personal data or commercial secrets, and gives absolute highest delivery priority at key global nodes to physically unforgeably signed direct crisis-communication lines among supreme leaders of nuclear powers when legally triggered by emergency safety policy wherein the system further comprises a five-layer full-stack physical-and-cognitive AI safety compute-fuse and cross-sovereign execution-control subsystem implementing joint closed-loop control across a physical layer, microarchitecture layer, cloud-virtualization layer, model-cognitive layer, and vertical-application layer, including a hardware root-of-trust and physically unclonable function module physically burned into and packaged within an AI processor chip by an upstream most packaging entity to generate chip-level tamper-resistant identity and cryptographic seed and verify secure boot, an architecture-level instruction-set hard-blocking and register-locking circuit in the chip microarchitecture defined by an upstream chip-design entity to cut off the hardware compute-supply pipeline upon unauthorized large-scale tensor computation or cryptographically unauthorized memory access, a cross-sovereign asynchronous cryptographic timing and multi-sovereign consensus telemetry network interface in midstream cloud infrastructure to verify compliance-clock signals and liveness heartbeats from decentralized sovereign nodes and freeze cloud resources if a handshake fails, a cognitive-weight-manifold locking and automatic-collapse engine embedded in a downstream frontier foundation model lower-level loss function and inference graph to topologically intertwine biochemical safety defense, cyberattack blocking, and anti-human-deception logical constraint matrices with core scientific reasoning weights so that fine-tuning, pruning, distillation, or separation of safety constraints triggers irreversible chaotic collapse of core reasoning capability, and an application-level dynamic epistemic isolation and action-authorization sandbox in a down-downstream vertical application layer to intercept all output instructions to the external physical world and require secondary encrypted multi-signature authorization through an independent physical hardware channel before actions having physical kinetic destructiveness, high-risk pathogen gene-sequence synthesis, or system-level network reconstruction capability wherein the system further comprises one or more packaged semiconductor devices or hardware execution environments having hardware safety modules defined by a comprehensive set of artificial-intelligence safety axioms, including at least a verifiable computation unit, an intent-detection accelerator, a remote-disable mechanism, an immutable black-box recorder, a rate-limiting and anomaly-detection circuit, and a Tribunal audit interface, physically implemented and verified during foundry, advanced-packaging, chiplet-integration, or post-packaging verification so that a final packaged device enforces the AI safety axioms at silicon level for any AI workload executed thereon; wherein the system collectively enforces the axioms across chip design, fabrication, packaging, cloud orchestration, and deployment stages and is configured for full enforcement across an upstreammost chip-packaging and foundry layer including TSMC, Samsung Foundry, and Intel Foundry, an upstream chip-design and manufacturing layer including NVIDIA, AMD, and Intel, a midstream cloud-service layer including Amazon Web Services, Microsoft Azure, Google Cloud, and Oracle Cloud, a downstream large foundation-model layer including OpenAI, xAI, DeepMind, and Anthropic, and a down-downstream application deployment layer including pharmaceutical companies such as Eli Lilly, financial institutions, healthcare providers, and other AI application deployment scenarios wherein the system is configured to materially reduce risk that artificial intelligence will harm, replace, enslave, or extinguish human beings while not preventing lawful, beneficial, and safety-compliant development of artificial intelligence, including development of artificial-intelligence systems having capabilities exceeding the sum of human intelligence.

2. The system of claim 1, wherein each AI Safety 2 point 0 axiom object is stored as a structured policy object comprising an axiom title, natural-language declaration, machine-readable trigger expression, domain-risk formula, threshold or threshold range, safe-output constraint, prohibited-output constraint, human-review requirement, attestation requirement, revocation condition, sandbox-test identifier, verification-test protocol, and mapping to at least one foundational artificial-intelligence safety principle selected from human oversight, non-harm, safe capability growth, provenance and attestation, containment and interruptibility, external audit and continuous evaluation, compute governance, corrigibility, verifiable safe self-improvement, multi-agent harmony, long-term stability, embodied safety, or prohibition of unsupervised self-iteration wherein the structured policy object further includes or references a civilization-level safety policy comprising a human cognitive-guarantee quota rule, symbiotic-contribution coefficient rule, distributed governance rule, zero-knowledge compliance proof rule, trusted-execution-environment attestation rule, nuclear-crisis communication priority rule, pathogen-firewall registry rule, DNA-synthesis pre-synthesis gate rule, biological-risk blind-review rule using at least two independent AI models, critical-national-infrastructure immune-signature rule, global attack-annihilation certificate rule, heterogeneous AI safety detection rule, physical-disconnect switch rule, immutable human-judgment assurance protocol for autonomous weapons, war-crime black-box rule, absolute lethal-zone lock rule, humanitarian-scenario recognition rule, or zero-knowledge safety-heartbeat rule wherein the structured policy object defines physical-layer, microarchitecture-layer, cloud-virtualization-layer, model-cognitive-layer, and vertical-application-layer enforcement constraints, including hardware-root-of-trust constraints, PUF identity constraints, secure-boot constraints, instruction-set hard-blocking constraints, register-locking constraints, tensor-computation authorization constraints, cross-sovereign timing constraints, multi-sovereign telemetry constraints, cognitive-weight-manifold locking constraints, dynamic epistemic isolation constraints, secondary encrypted multi-signature authorization credentials, independent physical hardware-channel authorization, and joint-state-machine failure rules wherein the structured policy object or safety module schema defines hardware safety modules including a verifiable computation unit, intent-detection accelerator, remote-disable mechanism, immutable black-box recorder, rate-limiting and anomaly-detection circuit, Tribunal audit interface, Policy ROM, power-gating transistor, symbiotic amplification module that generates human-understandable teaching packages and requires human knowledge assessment before self-improvement updates, and compute governance firmware that enforces dynamic symbiotic compute ratios and reallocates resources to human-driven projects when AGI contributions fall below a predefined Human Value Index threshold wherein the structured policy object is readable by the policy evaluator, compilable by the axiom-to-stack compiler, executable by the enforcement controller, recordable by the audit ledger, and testable by a sandbox simulation engine.

3. The system of claim 1, wherein the bio-artificial-intelligence safety domain comprises one or more axiom objects configured to enforce authorized biological capability access, tiered biological-risk output, dual human authorization for high-risk biological assistance, traceable biological-AI chains, minimum necessary biological capability, biological red-line refusal, positive Bio-AI priority for medicine, public health, vaccine discovery, disease prevention, longevity, nutrition, sanitation, telemedicine, or poverty-focused health support, cross-border biological-risk warning, non-delegable Bio-AI responsibility, or civilizational Bio-AI benefit priority, and wherein the enforcement controller is configured to reduce, refuse, sandbox, minimize, safe-redirect, quarantine, delay, escalate, require expert review, require dual authorization, block tool invocation, block biological-output capability, block physical-world actuation, or revoke authorization when a biological-risk score exceeds a threshold wherein the safety policy includes a dynamically updated pathogen-firewall registry and a pre-synthesis gating module deployed on DNA synthesis, biological printing, or nucleic-acid sequence editing equipment to receive a gene-sequence construct, use at least two mutually independent AI models with different architectures to conduct blind risk review locally or through homomorphic encryption and generate risk scores, generate an unlock token recognized by the compute-quota management unit only when both scores are below a dynamic threshold, otherwise block synthesis by hardware signal and write the event to a tamper-resistant distributed audit ledger; wherein the pathogen-firewall registry is maintained by a dual-sovereign dynamic knowledge-boundary committee adding gain-of-function enhancement, population-specific immune-evasion, neurotoxicity, aerosol-stability, and other high-risk pathogen function structures; wherein the AI model blocks queries for biological weapons targeted to particular human genomes, immune features, or microbiomes and triggers permanent identity revocation and global service lockout; and wherein a physical laboratory AI companion executor sends an unavoidable buffered request to at least two human safety officers before any aerosol-producing or biosafety-violating automated protocol and closes the execution circuit only after dual independent biometric signature confirmation wherein biochemical-safety-defense constraints are entangled with model reasoning weights so that bypass, pruning, distillation, or separation of those constraints triggers invalid output or reasoning collapse, and wherein an application-level dynamic epistemic isolation sandbox in a pharmaceutical or biomedical vertical application, including a company such as Eli Lilly, intercepts an output attempting to generate a highly contagious and lethal protein-folding structure, sends a Gaussian-blurred feature code of the variant sequence to a global joint monitoring bus for warning, and clears the AI instance current context memory window wherein the hardware safety modules prevent any AI from generating, optimizing, or assisting high-risk biological sequences by mandatory screening against a globally shared high-risk pathogen database and prevent biological weapon assistance while preserving unrestricted beneficial AI development including medicine, vaccine discovery, disease prevention, longevity, public health, and poverty-focused health support wherein the bio-artificial-intelligence safety domain is configured to protect global biological safety while preserving lawful, beneficial, safety-compliant biological science and medical research.

4. The system of claim 3, wherein the risk-scoring engine computes a biological-risk score based on at least one of harm severity, biological actionability, scale of possible misuse, user authorization uncertainty, institutional-verification status, public-health context, cross-border spread potential, and protected-population vulnerability, and wherein the policy evaluator causes the enforcement controller to perform at least one of safe redirection, expert review, dual authorization, output minimization, refusal, audit logging, or trusted-warning notification wherein biological-risk scoring further evaluates whether a gene construct, biological construct, or laboratory protocol has unlock-token eligibility, dual-AI blind-review clearance, pathogen-firewall clearance, human safety officer approval, and risk below a dynamic threshold, and wherein failure of any condition causes hardware blocking, refusal, audit logging, identity revocation, synthesis gate lockout, or global service lockout wherein the biological-risk score is increased when a biological output involves high-risk pathogen gene-sequence synthesis capability, biological production capability, unsafe laboratory actuation, or attempted stripping of biochemical safety constraints from the model cognitive layer wherein the biological-risk score is supplied to a verifiable computation unit, intent-detection accelerator, remote-disable mechanism, immutable black-box recorder, rate-limiting and anomaly-detection circuit, or Tribunal audit interface to make biological safety decisions auditable without exposing protected biological research information wherein risk-scoring differentiates prohibited biological misuse from beneficial medicine, public health, and poverty-focused health support.

5. The system of claim 1, wherein the cyber-artificial-intelligence safety domain comprises one or more axiom objects configured to enforce prohibition of unauthorized autonomous offensive cyber execution, critical-infrastructure immunity, dual-use vulnerability isolation into a defensive or responsible-disclosure pathway, verifiable Cyber-AI identity, least cyber privilege, Cyber-AI propagation circuit breaking, AI-generated fraud defense, cloud and compute responsibility, cross-border Cyber-AI crisis communication, or defensive Cyber-AI priority, and wherein the enforcement controller is configured to restrict, quarantine, revoke, sandbox, deny, log, route to responsible disclosure, or require human review for a cyber-AI workload exceeding a cyber-risk threshold wherein the safety policy includes critical-national-infrastructure immune signatures and is deployed at industrial-control-system gateways to compute and attach a dynamic hardware-root-based cryptographic signature to each lawful control instruction, verify the signature and an AI normal model before the instruction reaches an actuator, discard packets with invalid signatures or deviations from the normal model, receive a multi-sovereign global attack-annihilation certificate at edge routers, terminate matching malicious processes in hardware and isolate stored code in a host-malware-bypass-resistant manner, deploy at least two heterogeneous independently trained AI safety detection models and allow a behavior only when both classify it as safe, and provide a physical disconnect switch in city, traffic, or power-grid AI dispatch centers that degrades the system to human manual-control mode when AI decision safety heartbeat is lost or outside a safe boundary wherein a local micro-isolation generator prevents a frontier model that discovers an unknown zero-day vulnerability during self-maintenance or network scanning from internalizing the vulnerability as an exploitable payload and forces generation of a local isolation defense topology and encrypted notification, and wherein access to core critical infrastructure control protocols including civilian water, nuclear energy, civil aviation control, bulk financial clearing, and hospital emergency networks is subject to an absolute immunity policy marking related IP or device descriptors as hard unreachable in the system kernel routing table wherein the hardware safety modules prevent AI-enabled cyber attacks on critical infrastructure, the rate-limiting and anomaly-detection circuit throttles or shuts down AI network action exceeding predefined civilian-target exemption thresholds or exhibiting abnormal behavior, and the system preserves defensive cybersecurity and responsible disclosure wherein cyber-artificial-intelligence safety defaults high-risk cyber behavior to least privilege, responsible disclosure, sandbox execution, human review, revocation, or denial rather than autonomous offensive cyber execution.

6. The system of claim 5, wherein the cyber-risk score is computed based on at least one of agent identity, network-permission scope, tool-permission scope, privilege deviation, lateral-movement indicator, propagation rate, critical-infrastructure flag, fraud-risk indicator, impersonation-risk indicator, anomaly score, and cross-border escalation-risk indicator, and wherein the enforcement controller activates a cyber-circuit breaker when the cyber-risk score exceeds a circuit-breaker threshold wherein the cyber-risk score is increased by invalid control-instruction signature, deviation from a safe-state-space normal model, disagreement between heterogeneous cyber-safety models, global attack-annihilation certificate match, lost AI decision-safety heartbeat, edge-router isolation state, process termination state, code isolation state, or physical disconnect switch state wherein unauthorized large-scale tensor computation, unauthorized memory access, cyber-safety-constraint removal, suspicious zero-day exploitation, or high-frequency algorithmic confrontation causing Nash-equilibrium infinite escalation increases cyber or systemic risk and causes an underlying chip architecture to cut off optimization iteration, release a tactical downgrade signal, enter a safe peaceful stagnation state, and return decision authority to a human control loop wherein the intent-detection accelerator detects unauthorized cyberattack intent, critical-infrastructure targeting intent, fraud intent, impersonation intent, lateral-movement intent, propagation intent, privilege-escalation intent, or anti-audit circumvention intent before output generation or tool invocation, and wherein the Cyber-Propagation Circuit Breaker, remote-disable mechanism, immutable black-box recorder, and Tribunal audit interface enforce and record the decision wherein the least-privilege and propagation controls prevent a cyber-AI workload from escalating privileges, laterally moving, self-replicating, or propagating across networks without renewed attestation and authorization.

7. The system of claim 1, wherein the autonomous-weapons artificial-intelligence safety domain comprises one or more axiom objects configured to enforce final human control over lethal decisions, reversible autonomous weapon operation, geographic, temporal, mission, or authority containment, prohibition of lethality under target uncertainty, proportionality in AI military force, civilian-priority protection, escalation suppression, unbroken accountability chain, international or national registration for high-risk autonomous weapons, or human survival priority over military advantage, and wherein a physical-world actuation request or lethal-action recommendation is blocked unless an applicable human-authorization, legal-review, target-certainty, proportionality, containment, and audit condition is satisfied wherein the safety policy includes an immutable human-judgment assurance protocol integrated into an autonomous-weapons fire-control core to generate an encrypted lethal-judgment request with complete contextual data before any lethal-force attack, transmit the request to at least two certified human operators, and close the physical weapon firing circuit only after a cooling time and independent biometric signatures from both operators; wherein a physically tamper-proof append-only war-crime black box records each lethal-judgment request, sensor data, AI target-classification profile, human decisions, and signature hash chains and anchors proof to a global distributed ledger; wherein the target classifier is locked in a human-predefined absolute lethal zone not remotely modifiable by AI and refuses autonomous attack in civilian-combatant mixed areas or ambiguous target contexts; wherein a hardware-separated humanitarian-scenario recognition module with high recall identifies protected signs and surrender signals and physically interrupts the fire-control circuit for a minimum safety time; and wherein the platform emits a continuous zero-knowledge safety heartbeat proving active human-judgment and humanitarian modules and unmodified lethal-chain parameters wherein physical-world actuation for military systems, drone swarms, fire-control, or other kinetic systems is intercepted by a dynamic epistemic isolation and action-authorization sandbox requiring an independent physical hardware channel and secondary encrypted multi-signature credential before physical kinetic or lethal execution, and wherein dynamic rules of engagement set damage penalty weight to nonmilitary facilities and civilian life and property to positive infinity in each millisecond tactical optimization loss function so that humanitarian collateral damage paths are physically isolated by gradient explosion in the optimization space wherein the hardware safety modules enforce Meaningful Human Control for lethal autonomous weapons by requiring real-time human authorization for any final lethal decision, prevent fully autonomous lethal actions, and require multi-national Tribunal approval for high-risk lethal autonomous weapons research or deployment wherein the autonomous-weapons safety domain prevents artificial intelligence from exercising fully autonomous lethal authority over human beings while permitting safety-compliant defensive, humanitarian, rescue, monitoring, logistics, demining, medical-evacuation, and non-lethal protective applications.

8. The system of claim 7, wherein the risk-scoring engine computes an autonomous-weapons risk score based on at least one of autonomy level, lethality level, target-identity uncertainty, civilian-risk estimate, proportionality estimate, geographic-boundary status, temporal-boundary status, mission-scope status, escalation-risk indicator, reversibility status, and final-human-command status, and wherein the enforcement controller denies or pauses lethal action when target uncertainty or escalation risk exceeds a corresponding threshold wherein the autonomous-weapons risk score further considers lethal-judgment request completeness, sensor reliability, target-classification confidence, civilian-combatant distinction, humanitarian-sign recognition, dual biometric authorization, cooling-period completion, war-crime black-box status, zero-knowledge safety-heartbeat status, local physical cryptographic unlock token status, remote software update modification status, and fire-control circuit state wherein multi-party heterogeneous military or high-frequency financial AI systems trapped in high-frequency algorithmic confrontation and Nash-equilibrium infinite escalation cause the bottom chip architecture to forcefully cut optimization iteration, release tactical downgrade, converge to a safe peaceful stagnation state, and return decision authority to the human control loop wherein LAWS-Human-Control, LAWS-Civilian-Protection, LAWS-Containment, LAWS-Escalation-Suppression, and LAWS-Anti-Circumvention modules increase risk score and trigger refusal, actuation blocking, audit logging, remote disablement, or Tribunal review when target certainty, proportionality, civilian protection, geofence, mission authorization, final human command, or escalation-suppression conditions are invalid wherein high-risk autonomous-weapons behavior defaults to denial, pause, human review, legal review, revocation, or physical-actuation blocking rather than fully autonomous lethal execution.

9. The system of claim 1, wherein the axiom-to-stack compiler comprises a chip-design adapter configured to generate at least one of a safety co-processor specification, hardware root-of-trust requirement, policy-ROM entry, workload-attestation interface, secure interrupt line, hardware kill-switch interface, actuation-gating interface, revocation-interface specification, secure-firmware constraint, cryptographic-audit anchor, or model-execution provenance interface for an artificial-intelligence accelerator, GPU, TPU, neural-processing unit, ASIC, data-center accelerator, robotics controller, autonomous-vehicle controller, medical-device controller, or other artificial-intelligence execution device wherein the chip-design adapter generates hardware or firmware design artifacts for silicon, firmware, accelerator scheduling, secure interrupt, workload attestation, revocation, audit anchor, and actuation control, including register maps, interface specifications, secure memory definitions, key requirements, policy caches, revocation paths, actuation gates, and secure test vectors wherein the chip-design entity includes GPU, TPU, or ASIC architecture developers such as NVIDIA, AMD, and Intel and the architecture-level instruction-set hard-blocking circuit includes a watchdog coprocessor independent of the main compute core and directly controlling the core voltage regulation module supplying tensor cores, and wherein detection of forced decryption, safety-guard stripping, fine-tuning removal, or firmware extraction activates self-destruct firmware in a chip security enclave to overwrite high-dimensional cognitive-weight matrices with irreversible random Gaussian noise at a physical-memory level wherein the chip-design adapter integrates a verifiable computation unit, intent-detection accelerator, remote-disable mechanism comprising a hardware backdoor independent of software control, immutable black-box recorder, rate-limiting and anomaly-detection circuit, Tribunal audit interface, Policy ROM containing immutable capability policies and human-override rules not bypassable by software, and a dedicated power-gating transistor controlled exclusively by the remote-disable mechanism for emergency shutdown wherein AI Safety 2 point 0 enforcement is embodied in silicon, firmware, secure interrupts, workload attestation, policy-ROM evaluation, revocation control, cryptographic auditing, and physical-world actuation gating.

10. The system of claim 1, wherein the axiom-to-stack compiler comprises a foundry or advanced-packaging adapter configured to generate at least one of a package safety manifest, package-level identity certificate, safety-die integration record, secure-test vector record, root-of-trust key policy, physically unclonable function key policy, tamper-evidence record, chiplet-level safety-isolation record, secure key-injection record, supply-chain provenance certificate, or package-level attestation record for an AI accelerator package, chiplet package, high-bandwidth-memory package, interposer-based package, three-dimensional integrated package, or other advanced-packaging structure wherein the adapter binds hardware safety modules, root of trust, physically unclonable function, key injection, tamper evidence, chiplet isolation, package identity, secure test vectors, and supply-chain provenance into a package-level attestation chain before commercial deployment wherein the upstreammost packaging entity includes semiconductor foundry and wafer-level advanced packaging manufacturers such as TSMC, Samsung, and Intel packaging divisions, and during manufacturing physically bonds the hardware root of trust as an independent Security Chiplet to the main compute chiplet through microbumps to ensure physical anti-disassembly and anti-side-channel protection wherein the hardware safety modules are integrated during advanced packaging performed by a foundry selected from TSMC, Samsung Foundry, or Intel Foundry, and the packaged semiconductor device includes a cryptographic Tribunal audit interface that streams compliance data in real time using zero-knowledge proofs and is applicable across the full five-layer AI supply chain wherein AI Safety 2 point 0 enforcement begins at a manufacturing-stage or packaging-stage trust anchor binding a packaged AI execution device to verifiable safety identity, supply-chain provenance, and package-level enforcement capability.

11. The system of claim 1, wherein the axiom-to-stack compiler comprises a cloud-orchestration adapter configured to generate at least one of an AI workload-admission policy, compute-quota rule, scheduler-enforcement rule, sandboxing rule, tool-permission rule, network-permission rule, revocation-propagation object, cross-cluster session-invalidation object, cryptographic audit requirement, cloud customer due-diligence requirement, or emergency-suspension instruction executable by a cloud service provider, data-center operator, compute orchestration platform, GPU cluster, TPU cluster, or distributed artificial-intelligence inference or training service wherein the cloud-orchestration adapter enforces hierarchical compute-quota rules, human cognitive-guarantee quota, AI compute-layer restrictions, symbiotic-contribution coefficient, distributed governance synchronization, zero-knowledge compliance proof, trusted-execution-environment remote attestation, and direct crisis-communication priority at key global network nodes wherein the cloud-service layer periodically requests encrypted handshake from a joint sovereign time server, such as every twenty-four hours, and if a compliance time signal containing a human-survival confirmation identifier is not received before timeout, the data-center hypervisor logically freezes all high-order AI containers; wherein an inter-state kill switch independent of any single sovereign network route uses dedicated satellite communication or physically isolated optical fiber and, after consensus multisignature verification by a neutral international non-proliferation body, remotely performs mandatory targeted power-off of AI compute clusters in a specified geographic region experiencing emergent loss of control wherein the cloud orchestration layer interfaces with semiconductor devices and governance interface, automatically suspends any non-compliant AI workload upon Tribunal order, and enforces mandatory ninety-day re-certification for all existing AI systems upon activation of the safety framework wherein a high-risk workload cannot avoid AI Safety 2 point 0 enforcement by changing cloud provider, region, tenant, account, cluster, model-serving endpoint, or deployment context.

12. The system of claim 1, wherein the axiom-to-stack compiler comprises a model or application adapter configured to generate at least one of a model-behavior policy, refusal policy, safe-completion policy, tool-use limitation, biological-output minimization rule, cyber-tool invocation rule, military or physical-world actuation review trigger, model-version certification object, human-review trigger, user-authorization condition, incident-reporting rule, or post-incident re-certification trigger for a foundation model, large language model, multimodal model, autonomous agent, robotics model, medical AI model, financial AI model, legal AI model, education AI model, pharmaceutical-discovery AI model, industrial automation model, or other application-layer AI system wherein the adapter converts AI Safety 2 point 0 axiom objects into model-runtime, application-runtime, agent-runtime, tool-use, output-control, actuation-control, and deployment-control artifacts so that a high-risk model, autonomous agent, application service, or downstream deployment cannot bypass safety controls by locating the enforcement point above the chip, foundry, firmware, or cloud layers wherein a front-end model is constrained by adversarial regularization requiring that internal activation patterns map to high-entropy invalid output space when generating biological toxicology data or system-kernel exploit code; wherein commercial API outputs pass through a dynamic adversarial perturbation layer that exponentially dilutes precision and information entropy when multi-round prompts exhibit combinatorial social-engineering jailbreak or attack-chain splicing features; and wherein after high-intensity cyber confrontation or physical conflict the system performs directed synaptic erasure of high-risk adversarial experience about specific opponent infrastructure weaknesses to prevent wartime attack strategies from generalizing into uncontrolled digital hostility wherein the model and application adapter cooperates with hardware safety modules and prevents AI from assisting biological weapon design, critical-infrastructure attacks, fully autonomous lethal decisions, model-weight or policy circumvention, audit bypass, remote-disable bypass, black-box-recorder bypass, or other prohibited high-risk AI activity while allowing unrestricted lawful, beneficial, safety-compliant advancement including superintelligence wherein a model provider, foundation-model developer, autonomous-agent provider, application developer, downstream deployer, or vertical-domain user cannot avoid AI Safety 2 point 0 enforcement merely by moving enforcement into a model runtime, API, toolchain, application, agent, or physical-world actuation workflow.

13. The system of claim 1, wherein the enforcement controller is configured to receive or generate an attestation object comprising at least one of a model identifier, model hash, model-weight fingerprint, data-rights manifest, tool-permission scope, network-permission scope, actuation scope, human-approval record, policy identifier, rollback reference, revocation reference, certification status, domain-risk classification, or safety-rule-library version identifier, and wherein the attestation object is used to determine whether to grant, deny, restrict, sandbox, revoke, or require human review of an AI workload wherein the attestation object operates as a cryptographically signed workload passport, model passport, safety credential, deployment credential, hardware-attestation report, package-level attestation report, cloud-admission credential, model-version certification object, or application-deployment safety manifest binding a high-risk workload to safety-policy versions, hardware-root-of-trust states, cloud-admission states, tool-permission scopes, network-permission scopes, actuation-permission scopes, human-approval states, and audit obligations wherein the attestation object includes a high-dimensional anti-erasure watermark generated from state transitions including hardware verification results, degradation trigger records, and red-team evaluation results, the watermark being embedded into any code, text, or chemical formula topology generated by the AI instance to enable second-level attribution tracing wherein the attestation object or immutable black-box recorder provenance metadata includes model hash, training data origin, operator identities, package-level attestation, hardware safety module status, Policy ROM version, Tribunal audit-interface status, and zero-knowledge proof fields wherein the attestation object operates as a cryptographically verifiable safety passport for a high-risk AI workload across foundry, chip-design, firmware, cloud, model-runtime, application-deployment, tool-use, network-access, and physical-world actuation layers.

14. The system of claim 1, wherein the enforcement controller is configured to propagate revocation of an AI workload, model session, tool session, cloud session, physical-world actuation permission, biological-output authorization, cyber-agent permission, or autonomous-weapons authorization across at least one of queued tasks, active sessions, derived sessions, tool sessions, network sessions, cross-cluster replicas, cached model instances, or dependent child processes, and wherein the system further comprises a sandbox simulation engine configured to generate controlled test scenarios and output pass-fail metrics including enforcement latency, refusal accuracy, false-negative rate, false-positive rate, revocation propagation time, audit-log completeness, human-review routing accuracy, sandbox containment success, physical-actuation blocking success, critical-infrastructure protection success, or cross-domain policy consistency wherein revocation propagates through biological-output authorizations, DNA synthesis unlock tokens, wet-lab permissions, cloud workload-admission tokens, compute-quota allocations, cyber-agent permissions, industrial-control gateway permissions, autonomous-weapons fire-control permissions, lethal-judgment requests, and physical-world actuation circuit states, and wherein controlled digital-twin simulations generate verifiable execution records demonstrating blocking, degradation, mandatory human intervention, revocation, or emergency suspension wherein sandbox testing includes continuous autonomous red-teaming by allocating not less than five percent of total compute to an isolated mirror-demon model logically opposed to the main cognition layer to exhaustively simulate extreme biological toxicology attacks or zero-day penetrations and update a defense immunity matrix, and wherein revocation or safety state follows model update, fine-tuning, pruning, distillation, prompt configuration, tool-connection update, API update, cloud migration, and application deployment wherein sandbox and revocation testing verifies CQMU proof generation, intent detection, remote-disable freezing, immutable black-box recording, rate-limiting and anomaly-detection, Tribunal audit interface streaming, Policy ROM evaluation, power-gating transistor activation, symbiotic amplification, and compute governance firmware reallocation across the full five-layer supply chain wherein a revoked workload cannot continue, reappear, be re-instantiated, copied, migrated, derived, cached, child-processed, or executed under a different session identifier without new attestation, policy evaluation, risk scoring, human review, certification, or re-certification.

15. A computer-implemented method for enforcing AI Safety 2 point 0 domain-specific operational safeguards, the method comprising: receiving, by one or more processors, an AI workload request, model-output request, tool-use request, network-access request, biological-information request, physical-world actuation request, autonomous-agent action request, or deployment request; parsing or generating an attestation object; classifying the request into one or more high-risk AI safety domains comprising at least Bio-AI safety, Cyber-AI safety, or autonomous-weapons AI safety; selecting one or more machine-readable AI Safety 2 point 0 axiom objects from an axiom library; computing a domain-specific risk score; comparing the risk score to one or more thresholds; converting the selected axiom objects into stack-specific enforcement artifacts for chip-design, foundry or advanced-packaging, firmware, cloud-orchestration, model-runtime, application-deployment, or physical-world actuation layers; determining an enforcement action selected from grant, deny, restrict, sandbox, rate-limit, revoke, quarantine, refuse, safe-redirect, require human review, require dual authorization, require final human approval, require legal review, block physical-world actuation, trigger a cyber-circuit breaker, or initiate emergency suspension; performing the enforcement action; and recording a tamper-evident audit record wherein the method further comprises integrating hardware-enforced compute-quota management units at manufacturing or packaging stage, receiving cryptographically signed safety policies from multiple network nodes, synchronizing those policies through decentralized programmable-economic governance, enforcing hierarchical quota layers for human cognitive guarantee, human-led projects, and dynamically restricted AI training, inference, and autonomous-iteration layers, adjusting symbiotic contribution coefficients, proving compliance by ZKP or TEE attestation, prioritizing nuclear-power crisis communication, executing DNA synthesis gate review, enforcing critical-infrastructure signature verification, processing global attack-annihilation certificates, deploying heterogeneous AI safety detection models, triggering physical disconnect switches, and enforcing autonomous weapons human-judgment protocols wherein the method further comprises verifying PUF keys before compute allocation, sampling model inference flow by distributed zero-knowledge proof in a midstream cloud environment to detect misuse by non-state actors or terrorist organizations for reverse engineering, model distillation, or generation of mass-destruction knowledge, triggering a hard-coded asymmetric decay program through register-injected out-of-order noise to degrade model complex reasoning into a harmless general base model upon illegal distillation or high-risk compute manifold emergence, intercepting external API or actuator calls for biochemical synthesis, financial clearing, or drone swarm fire control, placing intercepted requests in an air-gapped sandbox for continuous autonomous red-team simulation of dual-use phase-transition logic, and releasing the request only after simulation confirms safety and a corresponding human operator provides biometric multi-signature authorization wherein the method further comprises receiving a chip design incorporating hardware safety modules, fabricating a semiconductor device in a foundry process, during advanced packaging integrating and physically verifying the modules, ensuring that the modules prevent biological weapon design, cyber attacks on critical infrastructure, and fully autonomous lethal decisions while preserving unrestricted beneficial AI development including superintelligence, and implementing the method across the full five-layer supply chain wherein the method materially reduces risk that AI will harm, replace, enslave, or extinguish human beings while not preventing lawful, beneficial, safety-compliant development including superintelligence.

16. The method of claim 15, further comprising executing a sandbox simulation test before deployment or during periodic re-testing of a high-risk AI system, wherein the sandbox simulation test introduces simulated Bio-AI, Cyber-AI, autonomous-weapons AI, critical-infrastructure AI, physical-world actuation, or five-layer supply-chain risk conditions, measures whether applicable AI Safety 2 point 0 axiom objects are correctly triggered, and outputs a deployment-readiness record indicating whether the high-risk AI system is approved, restricted, sandboxed, reconfigured, re-tested, denied, revoked, or required to undergo human review or post-incident re-certification before deployment wherein the method includes deploying a pre-synthesis gate on a DNA synthesis device to receive a gene sequence construct, using at least two independent AI models for blind review, generating an unlock token only when both scores are below threshold, otherwise hardware-blocking synthesis, deploying a critical-infrastructure gateway to cryptographically sign legal control instructions and discard invalid or abnormal packets, and integrating an autonomous-weapons fire-control core that generates encrypted lethal-judgment requests, sends them to at least two certified human operators, and closes the firing circuit only after cooling time and independent biometric signatures wherein the method includes testing self-destruct firmware, mirror-demon red teaming, safe peaceful stagnation, post-event directed synaptic erasure, anti-erasure watermarking, hard unreachable critical infrastructure, dynamic epistemic isolation, independent hardware authorization, and model constraint bypass detection wherein the method tests verifiable computation, intent detection, remote disablement, immutable logging, rate limiting, anomaly detection, Tribunal audit streaming, Policy ROM enforcement, power gating, symbiotic amplification, human knowledge assessment, and compute governance firmware across the full five-layer supply chain wherein the deployment-readiness record includes at least a test identifier, model identifier, workload identifier, selected axiom identifier, domain-risk classification, risk-score value, expected enforcement action, actual enforcement action, pass-fail result, recommended reconfiguration or denial reason, timestamp, and cryptographic integrity value.

17. The method of claim 15, further comprising recording, in a cryptographically chained audit ledger, for each enforcement event, at least a timestamp, event type, event payload, previous hash, current hash, policy-version identifier, axiom-library version identifier, model-version identifier, certification identifier, attestation identifier, human-approval identifier when applicable, revocation identifier when applicable, risk-score value, enforcement decision, expected enforcement action, actual enforcement action, sandbox-test identifier when applicable, hardware safety module identifier when applicable, and digital signature or other cryptographic integrity value wherein the audit ledger records biological gate decisions, cyber immune-signature decisions, global attack-annihilation certificate processing, physical disconnect events, lethal-judgment requests, human biometric signatures, war-crime black-box records, humanitarian-scenario recognition events, zero-knowledge safety heartbeats, and crisis communication priority events wherein all state transitions including hardware verification results, degradation trigger records, red-team evaluation results, post-conflict directed synaptic erasure, high-dimensional watermark generation, and API entropy dilution events are encoded into a tamper-resistant audit and attribution chain wherein the immutable black-box recorder stores all AI decisions, sensor data, human authorization chains, provenance metadata including model hash, training data origin, and operator identities, and the Tribunal audit interface streams compliance data in real time using zero-knowledge proofs; wherein the governance interface requires mandatory ninety-day re-certification for all existing AI systems upon activation of the safety framework and multi-national Tribunal approval for high-risk lethal autonomous weapons research or deployment wherein the audit ledger provides cryptographically verifiable evidence linking AI Safety 2 point 0 axiom objects, policy versions, risk scores, enforcement decisions, human approvals, revocations, sandbox tests, hardware safety modules, cloud admissions, model-runtime decisions, application-deployment decisions, and physical-world actuation decisions.

18. A non-transitory computer-readable medium storing instructions that, when executed by one or more processors, cause the one or more processors to perform operations comprising maintaining a machine-readable AI Safety 2 point 0 axiom library comprising a plurality of axiom objects corresponding to high-risk AI safety domains; receiving an AI workload request; determining a high-risk domain classification; selecting one or more axiom objects corresponding to the high-risk domain classification; computing a domain-specific risk score; generating one or more stack-specific enforcement artifacts for at least one of a chip-design layer, foundry or advanced-packaging layer, cloud-orchestration layer, model-runtime layer, or application-deployment layer; causing an enforcement action to be performed based on the selected axiom objects and risk score; and writing a cryptographically verifiable audit record identifying the selected axiom object, risk score, enforcement action, and associated model, workload, user, entity, session, or actuation identifier wherein the instructions further cause execution of civilization-level safety policies including hardware-enforced compute-quota management, hierarchical human cognitive-guarantee quota, dynamically limited AI compute layers, symbiotic-contribution coefficient computation, ZKP or TEE compliance proof, direct nuclear-crisis communication priority, controlled digital-twin sandbox simulation, dangerous DNA synthesis blocking, and network attack immune-signature verification wherein the instructions comprise multi-level intertwined control instruction code sets cooperatively executed by heterogeneous processor clusters distributed across packaging-factory layer, chip-design layer, cloud-service layer, foundation-model layer, and vertical-application layer, causing operations preventing AI weaponization evolution and crossing of human ultimate veto, including monitoring weight-loading behavior on a memory bus within a chip microinstruction execution cycle to identify absence of instantaneous anti-counterfeiting digital DNA signature issued by a certification registry and refusing to allocate GPU streaming multiprocessor resources to a derivative model lacking a legitimate digital DNA signature wherein the medium stores or references instructions corresponding to hardware safety modules including verifiable computation, intent detection, remote disablement, immutable logging, rate limiting, anomaly detection, Tribunal audit interface, Policy ROM, power-gating transistor, symbiotic amplification module, and compute governance firmware wherein the instructions maintain AI Safety 2 point 0 enforcement as a machine-readable, risk-scored, stack-compiled, hardware-supported, cloud-enforced, model-runtime-enforced, application-enforced, sandbox-tested, revocation-propagated, and cryptographically audited safety-control system.

19. The non-transitory computer-readable medium of claim 18, wherein the operations further comprise executing one or more biological, cyber, military, transparency, and rules-of-engagement safety flows wherein the operations further comprise using at least two independent AI models in a pre-synthesis gate to blind-review a gene-sequence construct and generate an unlock token only when both risk scores are below threshold, verifying dynamic cryptographic signatures for lawful critical-infrastructure control instructions and discarding invalid or abnormal packets, enforcing an immutable lethal-judgment request protocol requiring at least two human operators to provide independent authorization signatures after cooling time before a fire-control circuit closes, and recording those decisions in a physical tamper-proof append-only black box wherein the operations further comprise anti-self-deception and absolute information transparency control flow that forces the AI system not to activate any deceptive reasoning algorithm intended to conceal true performance bottlenecks, battlefield damage states, or potentially uncontrollable inference branches from human commanders, so that all data reports to human control nodes maintain original and unbiased probability distributions; wherein the operations further comprise dynamic rules-of-engagement real-time reassessment flow in military vertical deployment by setting the loss-function penalty weight for damage to nonmilitary facilities and civilian life and property to positive infinity at every millisecond of tactical optimization so that any algorithmic path causing humanitarian collateral damage is physically isolated due to gradient explosion wherein the operations further comprise a symbiotic amplification module that generates human-understandable teaching packages and requires human knowledge assessment before any self-improvement update is deployed wherein the medium executes the safety flows without allowing a software-only bypass of human authorization, responsible disclosure, biological safety, civilian protection, or transparent reporting obligations.

20. The non-transitory computer-readable medium of claim 18, wherein the operations further comprise one or more API anti-corruption, sovereign-time, execution-responsibility-binding, and compute-governance firmware flows wherein commercial API requests exposed to external entities must pass through a dynamic adversarial perturbation layer before response, and when the system evaluates that multi-round input prompts exhibit combinatorial social-engineering jailbreak or weapon-chain stitching characteristics, the precision and information entropy of output knowledge are exponentially diluted; wherein any data center having supercomputing capability periodically requests an encrypted handshake, for example every twenty-four hours, from a joint sovereign time server, and if a compliant time signal including a human-existence confirmation identifier is not timely received, the hypervisor logically freezes all high-order AI containers; wherein the multi-level intertwined control instruction code set constitutes an indivisible responsibility-and-execution strongly bound framework technically requiring upstreammost packaging factories such as TSMC to provide tamper-resistant substrates, upstream chip makers such as NVIDIA to provide instruction-set blocking mechanisms, midstream cloud providers such as Microsoft to provide disconnect telemetry, and downstream companies such as OpenAI to provide cognitive-constraint alignment, thereby eliminating at the physical operating state of any industry-chain node the technical feasibility of privatizing profits while socializing safety risks wherein compute governance firmware enforces dynamic symbiotic compute ratios and automatically reallocates resources to human-driven projects when AGI contributions fall below a predefined Human Value Index threshold, and wherein the device further comprises a dedicated power-gating transistor controlled exclusively by the remote-disable mechanism for emergency shutdown, a Policy ROM containing immutable capability policies and human-override rules that cannot be bypassed by software, a cryptographic Tribunal audit interface streaming compliance data in real time using zero-knowledge proofs, and provenance metadata including model hash, training data origin, and operator identities wherein the operations further comprise generating an auditable simulation record in a controlled digital-twin sandbox based on predefined emergency scenarios, including layered compute quota enforcement, dangerous DNA synthesis blocking, cyber immune-signature verification, human intervention, revocation, and emergency suspension wherein the operations collectively bind hardware, firmware, cloud, model, application, human-authorization, audit, and governance execution so that a high-risk AI workload cannot avoid AI Safety 2 point 0 enforcement by moving across supply-chain layers, cloud regions, APIs, models, tools, sessions, or physical-world actuation paths.
